(19) United States
(12) Patent Application Publication
(10) Pub. No.: US 2026/0019128 A1
(43) Pub. Date: Jan. 15, 2026

(54) EARLY TRIGGERING OF CSI MEASUREMENT AND REPORTING

(71) Applicant: Samsung Electronics Co., Ltd., Suwon-si (KR)

(72) Inventors: Dalin Zhu, Allen, TX (US); Emad Nader Farag, Flanders, NJ (US); Eko Onggosanusi, Coppell, TX (US)

(21) Appl. No.: 19/249,971

(22) Filed: Jun. 25, 2025

Related U.S. Application Data
(60) Provisional application No. 63/669,953, filed on Jul. 11, 2024.
(60) Provisional application No. 63/745,170, filed on Jan. 14, 2025.

(51) Int. Cl. H04B 7/06; H04L 5/00; H04W 74/0833

(52) U.S. Cl. CPC H04B 7/0626; H04L 5/0044; H04W 74/0833

(57) ABSTRACT

Methods and apparatuses for early triggering of channel state information (CSI) measurement and reporting. A method performed by a user equipment (UE) includes receiving, in a first signaling, one or more CSI report configurations for early CSI acquisition and receiving, in a second signaling, an indicator to trigger the early CSI acquisition. The method further includes determining, based on the one or more CSI report configurations and the indicator, one or more CSI reference signal (CSI-RS) resources and one or more uplink (UL) resources. The method further includes determining, based on measurements of the one or more CSI-RS resources, a CSI report and transmitting, via the one or more UL resources, the CSI report.

### CROSS-REFERENCE TO RELATED AND CLAIM OF PRIORITY

The present application claims priority under 35 U.S.C. § 119(e) to U.S. Provisional Patent Application No. 63/669,953 filed on Jul. 11, 2024 and U.S. Provisional Patent Application No. 63/745,170 filed on Jan. 14, 2025, which are hereby incorporated by reference in their entirety.

### TECHNICAL FIELD

The present disclosure relates generally to wireless communication systems and, more specifically, the present disclosure relates to methods and apparatuses for early triggering of channel state information (CSI) measurement and reporting.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to early triggering of CSI measurement and reporting.

In one embodiment, a user equipment (UE) is provided. The UE includes a transceiver configured to receive, in a first signaling, one or more CSI report configurations for early CSI acquisition and receive, in a second signaling, an indicator to trigger the early CSI acquisition. The UE further includes a processor operably coupled with the transceiver. The processor is configured to determine, based on the one or more CSI report configurations and the indicator, (i) one or more CSI reference signal (CSI-RS) resources and (ii) one or more uplink (UL) resources; and determine, based on measurements of the one or more CSI-RS resources, a CSI report. The transceiver is further configured to transmit, via the one or more UL resources, the CSI report.

In another embodiment, a base station (BS) is provided. The BS includes a processor and a transceiver operably coupled with the processor. The transceiver is configured to transmit, in a first signaling, one or more CSI report configurations for early CSI acquisition, transmit, in a second signaling, an indicator to trigger the early CSI acquisition, wherein the one or more CSI report configurations and the indicator indicate one or more CSI-RS resources and one or more UL resources, and receive, via the one or more UL resources, a CSI report that is based on measurements of the one or more CSI-RS resources.

In yet another embodiment, a method performed by a UE is provided. The method includes receiving, in a first signaling, one or more CSI report configurations for early CSI acquisition and receiving, in a second signaling, an indicator to trigger the early CSI acquisition. The method further includes determining, based on the one or more CSI report configurations and the indicator, one or more CSI-RS resources and one or more UL resources. The method further includes determining, based on measurements of the one or more CSI-RS resources, a CSI report and transmitting, via the one or more UL resources, the CSI report.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4A and 4B illustrate an example of a wireless transmit and receive paths according to embodiments of the present disclosure;

FIG. 5A illustrates an example of a wireless system according to embodiments of the present disclosure;

FIG. 5B illustrates an example of a multi-beam operation according to embodiments of the present disclosure;

FIG. 6 illustrates an example of a transmitter structure for beamforming according to embodiments of the present disclosure;

FIG. 7 illustrates a diagram of an example synchronization signal/physical broadcast channel (SS/PBCH) block according to embodiments of the present disclosure;

FIG. 8A illustrates a flowchart of an example contention based random access (CBRA) procedure according to embodiments of the present disclosure;

FIG. 8B illustrates a flowchart of an example contention free random access (CFRA) procedure according to embodiments of the present disclosure;

FIG. 9A illustrates a flowchart of an example CBRA procedure according to embodiments of the present disclosure;

FIG. 9B illustrates a flowchart of an example CFRA procedure according to embodiments of the present disclosure;

FIG. 10 illustrates a signal flow of an example procedure for early triggering of CSI measurement/reporting according to embodiments of the present disclosure;

FIG. 11 illustrates a signal flow of an example procedure for early triggering of sounding reference signal (SRS) transmission(s) for CSI acquisition according to embodiments of the present disclosure;

FIG. 12 illustrates a flowchart of an example procedure for early triggering of SRS transmission(s) for CSI acquisition and/or CSI measurement/reporting according to embodiments of the present disclosure; and

FIG. 13 illustrates an example method performed by a UE in a wireless communication system according to embodiments of the present disclosure

### DETAILED DESCRIPTION

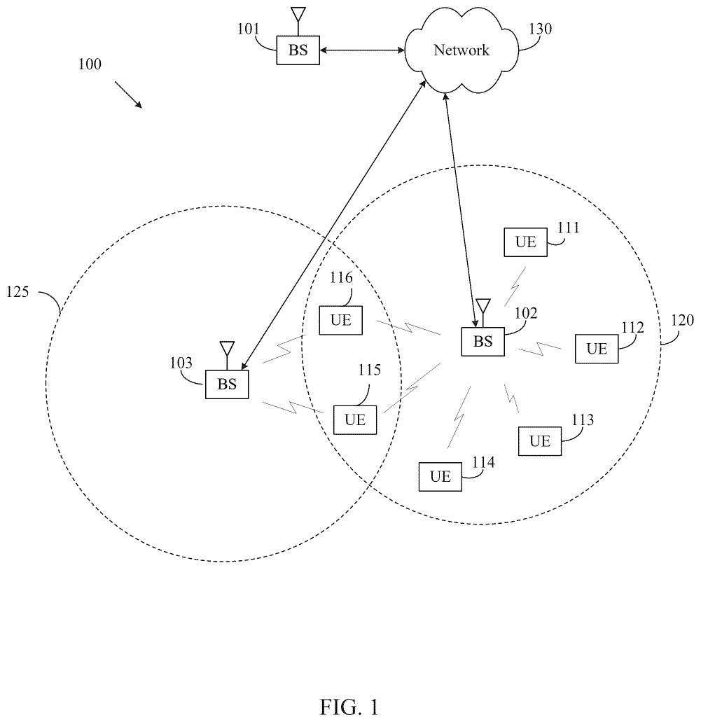

FIGS. 1-13, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [REF 1] 3GPP TS 38.211 v16.1.0, “NR; Physical channels and modulation;” [REF 2] 3GPP TS 38.212 v16.1.0, “NR; Multiplexing and Channel coding;” [REF 3] 3GPP TS 38.213 v16.1.0, “NR; Physical Layer Procedures for Control;” [REF 4] 3GPP TS 38.214 v16.1.0, “NR; Physical Layer Procedures for Data;” [REF 5] 3GPP TS 38.321 v16.1.0, “NR; Medium Access Control (MAC) protocol specification;” and [REF 6] 3GPP TS 38.331 v16.1.0, “NR; Radio Resource Control (RRC) Protocol Specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103 (collectively forming a BS system). The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for early triggering of CSI measurement and reporting. In certain embodiments, one or more of the gNBs 101-103 include circuitry, programing, or a combination thereof to support early triggering of CSI measurement and reporting.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

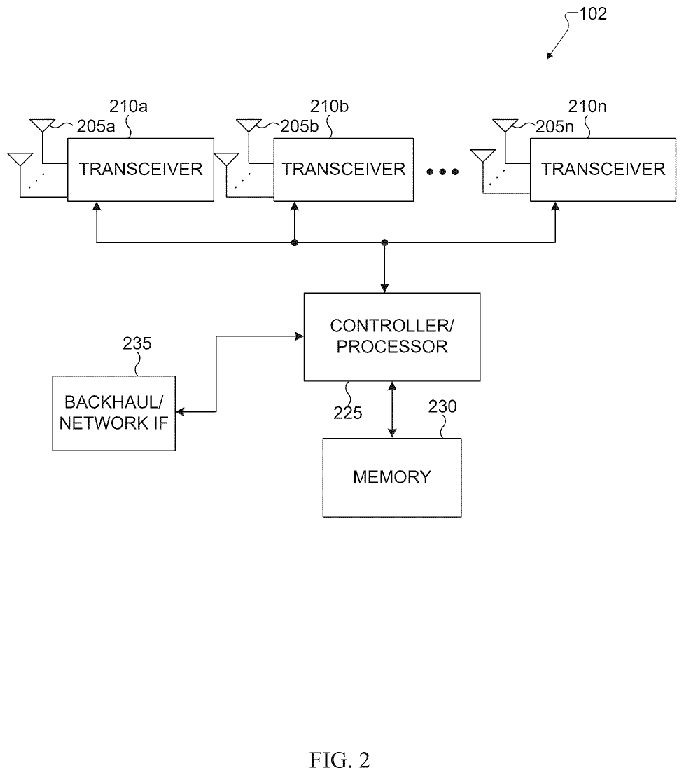

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-convert the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channels or signals and the transmission of downlink (DL) channels or signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as supporting early triggering of CSI measurement and reporting. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The backhaul or network interface 235 could support communications over any suitable wired or wireless connection(s). For example, when the gNB 102 is implemented as part of a cellular communication system (such as one supporting 5G/NR, LTE, or LTE-A), the backhaul or network interface 235 could allow the gNB 102 to communicate with other gNBs over a wired or wireless backhaul connection. When the gNB 102 is implemented as an access point, the backhaul or network interface 235 could allow the gNB 102 to communicate over a wired or wireless local area network or over a wired or wireless connection to a larger network (such as the Internet). The backhaul or network interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

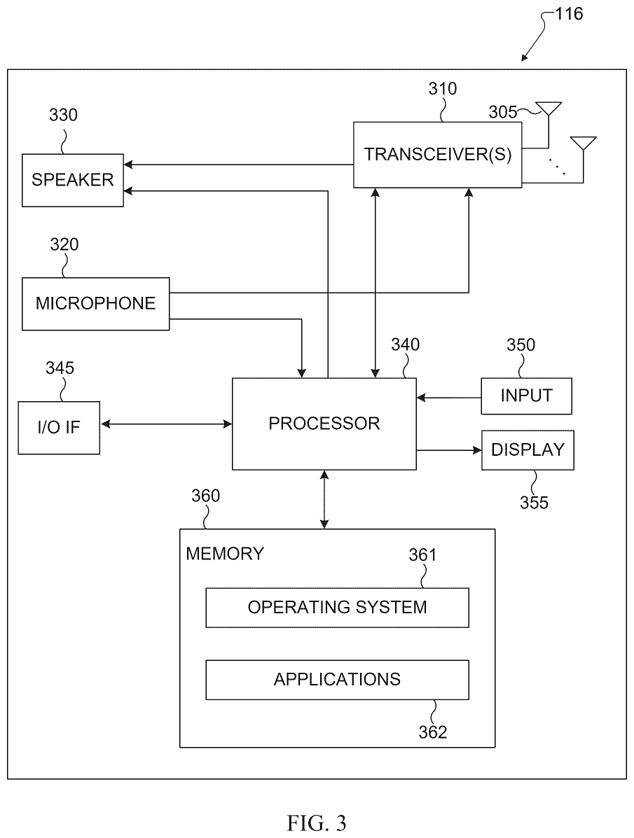

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes to utilize and/or identify early triggering of CSI measurement and reporting as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

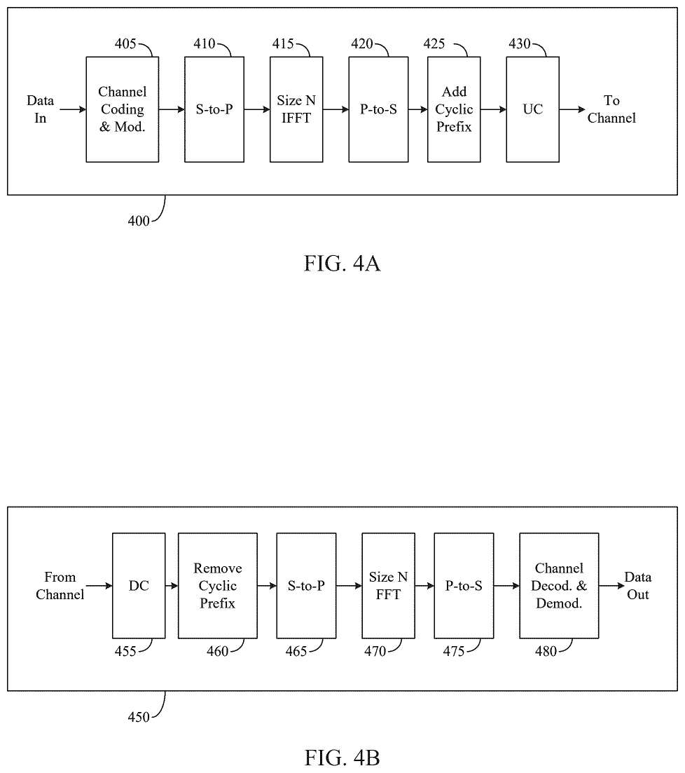

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 and/or the receive path 450 performs actions for early triggering of CSI measurement and reporting as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network. In this disclosure, a beam is determined by either of:
A transmission configuration indication (TCI) state, that establishes a quasi-colocation (QCL) relationship between a source reference signal (e.g. synchronization signal block (SSB) and/or CSI-RS) and a target reference signal
A spatial relation information that establishes an association to a source reference signal, such as SSB or CSI-RS or SRS.

In either case, the ID of the source reference signal identifies the beam.

The TCI state and/or the spatial relation reference RS can determine a spatial Rx filter for reception of downlink channels at the UE, or a spatial TX filter for transmission of uplink channels from the UE.

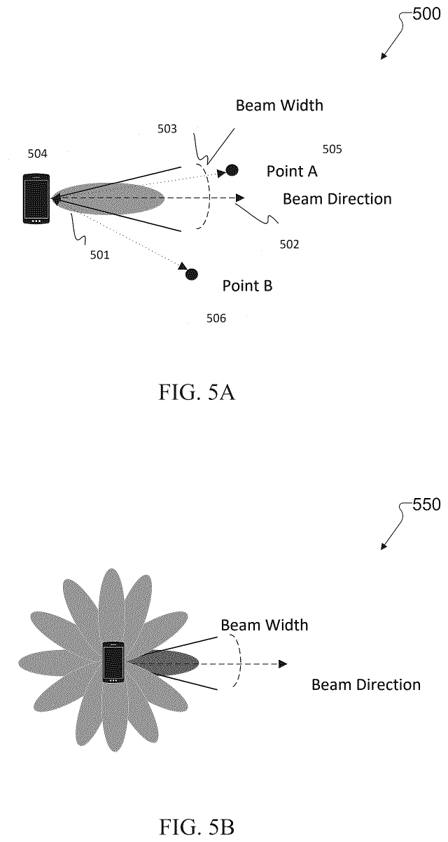

As illustrated in FIG. 5A, in a wireless system 500, a beam 501 for a device 504 can be characterized by a beam direction 502 and a beam width 503. For example, the device 504 (or UE 116) transmits RF energy in a beam direction 502 and within a beam width 503. The device 504 receives RF energy in a beam direction 502 and within a beam width 503. As illustrated in FIG. 5A, a device at point A 505 can receive from and transmit to device 504 as Point A is within a beam width and direction of a beam from device 504. As illustrated in FIG. 5A, a device at point B 506 cannot receive from and transmit to device 504 as Point B 506 is outside a beam width and direction of a beam from device 504. While FIG. 5A, for illustrative purposes, shows a beam in 2-dimensions (2D), it should be apparent to those skilled in the art, that a beam can be in 3-dimensions (3D), where the beam direction and beam width are defined in space.

FIG. 5B illustrates an example of a multi-beam operation 550 according to embodiments of the present disclosure. For example, the multi-beam operation 550 can be utilized by UE 116 of FIG. 3. This example is for illustration only and other embodiments can be used without departing from the scope of the present disclosure.

In a wireless system, a device can transmit and/or receive on multiple beams. This is known as “multi-beam operation”. While in FIG. 5B, for illustrative purposes, a beam is in 2D, it should be apparent to those skilled in the art, that a beam can be 3D, where a beam can be transmitted to or received from any direction in space.

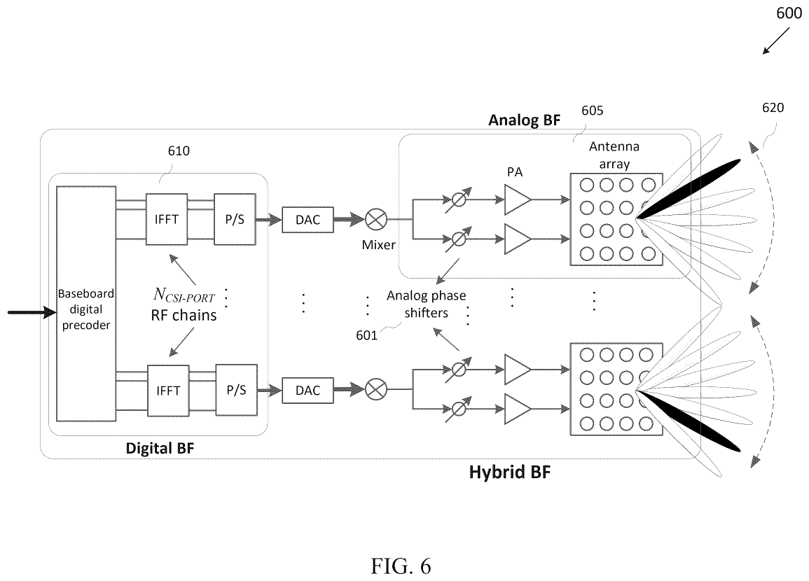

FIG. 6 illustrates an example of a transmitter structure 600 for beamforming according to embodiments of the present disclosure. In certain embodiments, one or more of gNB 102 or UE 116 includes the transmitter structure 600. For example, one or more of antenna 205 and its associated systems or antenna 305 and its associated systems can be included in transmitter structure 600. This example is for illustration only, and other embodiments can be used without departing from the scope of the present disclosure.

Accordingly, embodiments of the present disclosure recognize that Rel-14 LTE and Rel-15 NR support up to 32 channel state information reference signal (CSI-RS) antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 6. Then, one CSI-RS port can be mapped onto a large number of antenna elements that can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or slots/subframes. The number of sub-arrays (equal to the number of RF chains) is the same as the number of CSI-RS ports NCSI-PORT. A digital beamforming unit 610 performs a linear combination across NCSI-PORT analog beams to further increase a precoding gain. While analog beams are wideband (hence not frequency-selective), digital precoding can be varied across frequency sub-bands or resource blocks. Receiver operation can be conceived analogously.

Since the transmitter structure 600 of FIG. 6 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for purposes of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 6 is also applicable to higher frequency bands such as >52.6 GHz. In this case, the system can employ only analog beams. Due to the O₂ absorption loss around 60 GHz frequency (˜10 dB additional loss per 100 m distance), a larger number and narrower analog beams (hence a larger number of radiators in the array) are needed to compensate for the additional path loss.

The text and figures are provided solely as examples to aid the reader in understanding the present disclosure. They are not intended and are not to be construed as limiting the scope of the present disclosure in any manner. Although certain embodiments and examples have been provided, it will be apparent to those skilled in the art based on the disclosures herein that changes in the embodiments and examples shown may be made without departing from the scope of the present disclosure. The transmitter structure 600 for beamforming is for illustration only and other embodiments can be used without departing from the scope of the present disclosure.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while the figures illustrate operational environments in which various user equipment features disclosed in this patent document can be used, these features can be used in any other suitable system.

Any of the above variation embodiments can be utilized independently or in combination with at least one other variation embodiment.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of subject matter is defined by the claims.

Rel-17 introduced the unified TCI framework, where a unified, master, main, or indicated TCI state is signaled to the UE. The unified, master, main, or indicated TCI state can be one of:
1. In case of joint TCI state indication, wherein a same beam is used for DL and UL channels, a joint TCI state that can be used at least for UE-dedicated DL channels and UE-dedicated UL channels.
2. In case of separate TCI state indication, wherein different beams are used for DL and UL channels, a DL TCI state that can be used at least for UE-dedicated DL channels.
3. In case of separate TCI state indication, wherein different beams are used for DL and UL channels, a UL TCI state that can be used at least for UE-dedicated UL channels.

The unified (master or main or indicated) TCI state is TCI state of UE-dedicated reception on physical downlink shared channel (PDSCH)/physical downlink control channel (PDCCH) or dynamic-grant/configured-grant based physical uplink shared channel (PUSCH) and dedicated physical uplink control channel (PUCCH) resources.

The unified TCI framework applies to intra-cell beam management, wherein, the TCI states have a source RS that is directly or indirectly associated, through a quasi-co-location relation, e.g., spatial relation, with an SSB of a serving cell (e.g., the TCI state is associated with a TRP of a serving cell). The unified TCI state framework also applies to inter-cell beam management, wherein a TCI state can have a source RS that is directly or indirectly associated, through a quasi-co-location relation, e.g., spatial relation, with an SSB of cell that has a physical cell identity (PCI) different from the PCI of the serving cell (e.g., the TCI state is associated with a TRP of a cell having a PCI different from the PCI of the serving cell).

Quasi-co-location (QCL) relation, can be quasi-location with respect to one or more of the following relations [[REF 4]—section 5.1.5]:

Type A, {Doppler shift, Doppler spread, average delay, delay spread}
Type B, {Doppler shift, Doppler spread}
Type C, {Doppler shift, average delay}
Type D, {Spatial Rx parameter}

In addition, quasi-co-location relation and source reference signal can also provide a spatial relation for UL channels, e.g., a DL source reference signal provides information on the spatial domain filter to be used for UL transmissions, or the UL source reference signal provides the spatial domain filter to be used for UL transmissions, e.g., same spatial domain filter for UL source reference signal and UL transmissions.

The unified (master or main or indicated) TCI state applies at least to UE dedicated DL and UL channels. The unified (master or main or indicated) TCI can also apply to other DL and/or UL channels and/or signals e.g. non-UE dedicated channel and sounding reference signal (SRS).

A UE (e.g., the UE 116) is indicated a TCI state by MAC CE when the CE activates one TCI state code point. The UE applies the TCI state code point after a beam application time from the corresponding hybrid automatic repeat request acknowledgement (HARQ-ACK) feedback. A UE is indicated a TCI state by a DL related downlink control information (DCI) format (e.g., DCI Format 1_1, or DCI format 1_2), wherein the DCI format includes a “transmission configuration indication” field that includes a TCI state code point out of the TCI state code points activated by a MAC CE. A DL related DCI format can be used to indicate a TCI state when the UE is activated with more than one TCI state code points. The DL related DCI format can be with a DL assignment for PDSCH reception or without a DL assignment. A TCI state (TCI state code point) indicated in a DL related DCI format is applied after a beam application time from the corresponding HARQ-ACK feedback.

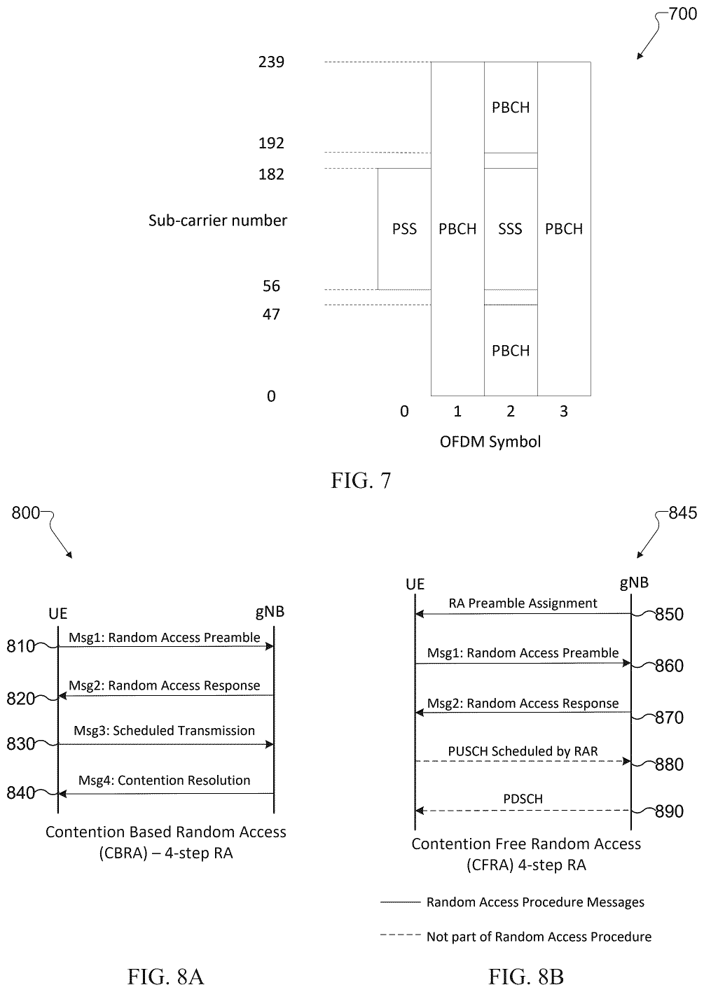

FIG. 7 illustrates a diagram of an example SS/PBCH block 700 according to embodiments of the present disclosure. For example, SS/PBCH block 700 can be utilized by any of the UEs 111-116 of FIG. 1. This example is for illustration only and other embodiments can be used without departing from the scope of the present disclosure.

In 5G/NR, a UE performs the cell search procedure to acquire time and frequency synchronization with a cell and to detect the physical layer Cell ID of the cell. To perform cell search, the UE receives the following signals and channel: (1) the primary synchronization signal (PSS), (2) the secondary synchronization signal (SSS) and (3) the physical broadcast channel (PBCH). With reference to FIG. 7, a primary synchronization signal (PSS)/secondary synchronization signal (SSS)/PBCH block (SS/PBCH block) is referred to as SSB and includes 4 consecutive symbols, and 20 physical resource blocks (240 subcarriers), as illustrated in FIG. 7.

SSBs are organized in groups (or bursts) of up to N SSBs, transmitted within half a frame (5 ms), each SSB within the group has an index i, where i=0, 1, . . . , N−1, within each group of SSBs, the SSBs are time-division multiplexed and arranged in increasing order of i, with increasing time. For carrier frequencies less than or equal to 3 GHZ, N=4. For carrier frequencies in FR1 that are larger than 3 GHz, N=8. For carrier frequencies in FR2, N=64. The SSB indices transmitted are provided by ssb-PositionsInBurst in system information block one (SIB1) or in ServingCellConfigCommon.

SSBs are transmitted periodically, where the allowed periodicities are {5, 10, 20, 40, 80, 160} ms. In addition to cell search, SSBs can also be used for beam management related procedures, such as new beam acquisition, beam measurements, and beam failure detection and recovery. Each SSB with index i can be associated with a spatial domain filter (or beam).

NR introduced a physical random access channel (PRACH) to be used, among other cases, when the UE wants to communicate with the network (e.g., the network 130) and doesn't have uplink resources. For example, the physical random access channel can be used during initial access. The PRACH includes a preamble format comprising one or more preamble sequences transmitted in a PRACH Occasion (RO).

NR supports four different preamble sequence lengths:
Sequence length 839 used with sub-carrier spacings 1.25 kHz and 5 kHz with unrestricted or restricted sets.
Sequence length 139 used with sub-carrier spacings 15 kHz, 30 kHz, 60 kHz, and 120 kHz with unrestricted sets.
Sequence length 571 used with sub-carrier spacing 30 kHz with unrestricted sets.
Sequence length 1151 used with sub-carrier spacing 15 kHz with unrestricted sets.

Random access channel (RACH) preambles are transmitted in time-frequency resources PRACH Occasions (ROs). Each RO determines the time and frequency resources in which a preamble is transmitted, the resources allocated to an RO in the frequency domain (e.g., number of physical resource blocks (PRBs)) and the resource allocated to an RO in the time domain (e.g., number of OFDMA symbols or number of slots), depend on the preamble sequence length, sub-carrier spacing of the preamble, sub-carrier spacing of the PUSCH in the UL bandwidth part (BWP), and the preamble format. Multiple PRACH Occasions can be FDMed in one time instance. This is indicated by higher layer parameter msg1-FDM. The time instances of the PRACH Occasions are determined by the higher layer parameter prach-ConfigurationIndex, and Tables 6.3.3.2-2, 6.3.3.2-3, and 6.3.3.2-4 of [REF 1] v18.1.0.

SSBs are associated with ROs. The number of SSBs associated with one RO can be indicated by higher layer parameters such as ssb-perRACH-OccasionAndCB-PreamblesPerSSB and ssb-perRACH-Occasion. The number of SSBs per RO can be {1/8,1/4,1/2,1,2,4,8,16}. When the number of SSBs per RO is less than 1, multiple ROs are associated with the same SSB index. SS/PBCH block indexes provided by ssb-PositionsInBurst in SIB1 or in ServingCellConfigCommon are mapped to valid PRACH occasions in the following order [[REF 3] v18.1.0]:
First, in increasing order of preamble indexes within a single PRACH occasion.
Second, in increasing order of frequency resource indexes for frequency multiplexed PRACH occasions.
Third, in increasing order of time resource indexes for time multiplexed PRACH occasions within a PRACH slot.
Fourth, in increasing order of indexes for PRACH slots.

The association period starts from frame 0 for mapping SS/PBCH block indexes to PRACH Occasions.

FIG. 8A illustrates a flowchart of an example contention-based random access (CBRA) procedure 800 according to embodiments of the present disclosure. For example, CBRA procedure 800 can be performed by the UE 116 and the gNB 102 and/or network 130 in the wireless network 100 of FIG. 1. This example is for illustration only and other embodiments can be used without departing from the scope of the present disclosure.

The procedure begins in 810, a UE transmits a Msg1: random access preamble to a gNB. In 820, the gNB transmits a Msg2: random access response to the UE. In 830, the UE transmits a Msg3: scheduled transmission to the gNB. In 840, the gNB transmits Msg4: content resolution to the UE.

FIG. 8B illustrates a flowchart of an example contention-free random access (CFRA) procedure 845 according to embodiments of the present disclosure. For example, CFRA procedure 845 can be performed by the UE 116 and the gNB 103 and/or network 130 in the wireless network 100 of FIG. 1. This example is for illustration only and other embodiments can be used without departing from the scope of the present disclosure.

The procedure begins in 850, a gNB transmits a RA preamble assignment to a UE. In 860, the UE transmits a Msg1: random access preamble to the gNB. In 870, the gNB transmits a Msg2: random access response to the UE. In 880, the UE may transmit a PUSCH scheduled by random access response (RAR) to the gNB. In 890, gNB may transmit PDSCH to the UE.

A random access procedure can be initiated by a PDCCH order, by the MAC entity, or by RRC.

There are two types of random access procedures, type-1 random access procedure and type-2 random access procedure.

With reference to FIG. 8, Type-1 random access procedure also known as four-step random access procedure (4-step RACH) is shown;
In step 1, the UE transmits a random access preamble, also known as Msg1, to the gNB. The gNB attempts to receive and detect the preamble.
In step 2, the gNB upon receiving the preamble transmits a random access response (RAR), also known as Msg2, to the UE including, among other fields, a time adjustment (TA) command and an uplink grant for a subsequent PUSCH transmission.
In step 3, the UE after receiving the RAR, transmits a PUSCH transmission scheduled by the grant of the RAR and time adjusted according to the TA received in the RAR. Msg3 or the PUSCH scheduled by the RAR UL grant can include the RRC reconfiguration complete message.
In step 4, the gNB upon receiving the RRC reconfiguration complete message, allocates downlink and uplink resources that are transmitted in a downlink PDSCH transmission to the UE.

After the last step, the UE can proceed with reception and transmission of data traffic.

Type-1 random access procedure (4-step RACH) can be contention based random access (CBRA) or contention free random access (CFRA). The CFRA procedure ends after the random access response, the following messages are not part of the random access procedure. For CFRA, in step 0, the gNB indicates to the UE the preamble to use.

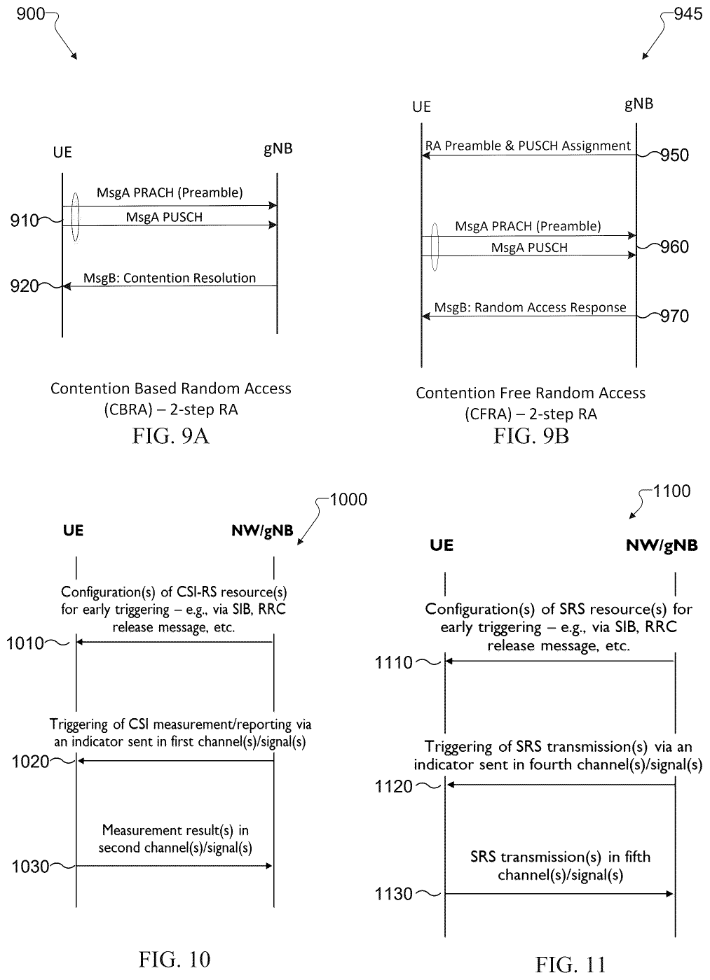

FIG. 9A illustrates a flowchart of an example CBRA procedure 900 according to embodiments of the present disclosure. For example, CBRA procedure 900 can be performed by the UE 115 and the gNB 102 and/or network 130 in the wireless network 100 of FIG. 1. This example is for illustration only and other embodiments can be used without departing from the scope of the present disclosure.

The procedure begins in 910, a UE transmits MsgA PRACH (preamble) and MsgA PUSCH to a gNB. In 920, the gNB transmits MsgB: contention resolution to the UE.

FIG. 9B illustrates a flowchart of an example CFRA procedure 945 according to embodiments of the present disclosure. For example, CFRA procedure 945 can be performed by the UE 115 and the gNB 103 and/or network 130 in the wireless network 100 of FIG. 1. This example is for illustration only and other embodiments can be used without departing from the scope of the present disclosure.

The procedure begins in 950, a gNB transmits a RA preamble and PUSCH assignment to a UE. In 960, the UE transmits MsgA PRACH (preamble) and MsgA PUSCH to the gNB. In 970, the gNB transmits MsgB: random access response to the UE.

Rel-16 introduced a new random access procedure; Type-2 random access procedure, also known as 2-step random access procedure (2-step RACH), with reference to FIG. 9, that combines the preamble and PUSCH transmission into a single transmission from the UE to the gNB, which is known as MsgA. Similarly, the RAR and the PDSCH transmission (e.g., Msg4) are combined into a single downlink transmission from the gNB to the UE, which is known as MsgB.

A random access procedure can be triggered for initial access from the RRC_IDLE state. During this procedure, a UE (e.g., the UE 116) identifies an SS/PBCH block with index i and with an reference signal received power (RSRP) that exceeds a threshold. The RSRP threshold for SSB selection for RACH resource association is indicated by the network. The UE selects a RO and a preamble within the RO associated with SS/PBCH block index i. The UE transmits a PRACH using the selected RO/preamble. The UE monitors and receives the random access response (RAR), by attempting to detect a DCI format 1_0 with cyclic redundancy check (CRC) scrambled by a corresponding random access radio network temporary identifier (RA-RNTI) during a window controlled by higher layers. If the UE does not detect the DCI format 1_0 with CRC scrambled by the corresponding RA-RNTI within the RAR window, the UE may retransmit PRACH. If the UE detects the DCI format 1_0 with CRC scrambled by the corresponding RA-RNTI, the UE receives a RAR UL grant for the scheduling of a PUSCH. The UE transmits the PUSCH according to the RAR UL grant. In response to the PUSCH transmission scheduled by a RAR UL grant, when a UE has not been provided a cell RNTI (C-RNTI), the UE attempts to detect a DCI format 1_0 with CRC scrambled by a corresponding temporary cell-radio network temporary identifier (TC-RNTI) scheduling a PDSCH that includes a UE contention resolution identity. The spatial domain filters (beams) identified during initial access, are used for subsequent transmissions and receptions to/from the UE until a single TCI state is configured or activated or indicated to the UE. For downlink receptions when a UE does not have the TCI state, the spatial domain filter is that associated with the SS/PBCH block index identified during initial access. For uplink transmissions when a UE does not have the TCI state, the spatial domain filter is that used for PUSCH scheduled by the RAR UL grant.

Channel state information reference signal is a downlink reference signal that is used for obtaining the downlink channel condition between the gNB (e.g., the BS 102) and the UE. CSI-RS can be transmitted independent of data transmissions on the downlink. The CSI-RS usage can be CSI-RS of beam management, CSI-RS for tracking, CSI-RS for CSI and etc.

In NR, CSI-RS resources including SSB(s) and/or nonzero power (NZP) CSI-RS resource(s) are configured by the network for example as part of RRC setup or RRC reconfiguration. CSI-RS resources are configured in a CSI resource set provided/configured in a CSI resource setting, which could also be linked/associated/specific to a CSI reporting setting. The configuration of the CSI-RS resource includes at least the following: (1) information related to the time-frequency resource mapping of the CSI-RS resource, (2) information related to resource type of the CSI-RS resource including ‘periodic’, ‘aperiodic’, and ‘semi-persistent’, (3) information related to usage of the CSI-RS resource (e.g., for beam management, tracking, CSI and etc.), (4) information related to transmit power control parameter(s)/setting(s), (5) scrambling ID, and (7) information related to the TCI state.

Sounding reference signal is an uplink reference signal that is used for sounding (i.e., channel quality estimation) the uplink channel between the UE and the gNB. In case of reciprocity between UL and DL, the channel sounding of the uplink channel can also be used for link adaptation and precoding on the downlink channel from the gNB to the UE. SRS is transmitted independent of data transmissions on the uplink. The SRS usage can be one of: beamManagement, codebook, nonCodebook, antennaSwitching, this is in addition to SRS for positioning.

In NR, SRS resources are configured by the network for example as part of RRC setup or RRC reconfiguration. SRS resources are configured in SRS resource set. An SRS resource set includes a set of SRS resource, and defines the following parameters: (1) resourceType, which determine the time domain behavior of SRS, SRS can be aperiodic, semi-persistent or periodic, (2) usage, which can be one of: beamManagement, codebook, nonCodebook or antennaSwitching, and (3) information related to power control and TCI state.

The configuration of the SRS resource includes the following: (1) information related to the transmission comb, including comb size, comb offset and cyclic shift, (2) information related to domain resource mapping including starting symbol within a slot, number of SRS symbols and repetition factor, (3) information related to frequency domain including freqDomainPosition N_RRC, freqDomainShift n_shift, and frequency hopping parameters c-SRS, b-SRS, and b-hop, (4) information related to group or sequence hopping, whether one of them or neither is enabled, (5) for periodic and semi-persistent SRS, the periodicity and offset of the SRS resource, (6) sequence ID, and (7) information related to the TCI state or spatial relation info.

In 5G NR, a UE can transmit a sounding reference signal (SRS). A SRS resource is configured by higher layer IE SRS-Resource.

The SRS sequence is a low peak-to-average power ratio (PAPR) sequence of length

$${N}_{ZC} = {M}_{sc , b}^{SRS}$$

given by:

$${r}^{( p )} ( n , {l}^{′} ) = {r}_{u , v}^{( α , δ )} ( n ) = {e}^{j α n} {r}_{u , v} ( n ) , 0 \leq n < {M}_{ZC}$$

where

$${M}_{ZC} = {mN}_{sc}^{RB} / {2}^{δ} , δ = log ( {K}_{TC} ) ,$$

with K_{TC} being the transmission comb number is provided in higher layer IE transmissionComb, K_{TC}∈{2,4,8}. l′ is the SRS symbol within a SRS resource of a slot

$${l}^{′} ∈ \{ 0 , 1 , … , {N}_{symb}^{SRS} - 1 \} , {N}_{symb}^{SRS}$$

is the number of SRS symbols in a slot. The cyclic shift αᵢ for antenna port pᵢ is given by

$${α}_{i} = 2 π \frac{{n}_{SRS}^{cs , i}}{{n}_{SRS}^{cs , max}} , and {n}_{SRS}^{cs , i} = ( {n}_{SRS}^{cs} + \frac{{n}_{SRS}^{cs , max} ( {p}_{i} - 1000 )}{{N}_{ap}^{SRS}} ) mod {n}_{SRS}^{cs , max}$$

with

$${n}_{SRS}^{cs}$$

being provided by higher layer in IE transmissionComb,

$${n}_{SRS}^{cs , max}$$

depends on K_{TC} as illustrated in Table 1.

TABLE 1

| K_{TC} | ${n}_{SRS}^{cs , max}$ |
|---|---|
| 2 | 8 |
| 4 | 12 |
| 8 | 6 |

u is the group number u∈{0, 1, . . . , 29}, v is the base sequence number, with v∈{0}, if 6≤N_{zc}≤60 and ∈{0}, if 60<N_{zc}. The base sequence, r̅_{u,v}(n), is generated as follows:
1. For N_{ZC}∈{6,12,18,24}, r̅_{u,v}(n)=e^{jϕ(n)π/4}, with 0≤n<M_{ZC}−1. ϕ(n) is given by Tables 5.2.2.2-1 to 5.2.2.2-4 of [REF 1].

$$For {N}_{ZC} = 30 , {\overline{r}}_{u , v} ( n ) = {e}^{- j \frac{π ( u + 1 ) ( n + 1 ) ( n + 2 )}{31}} , \qquad 2.$$

with 0≤n<M_{ZC}−1.

$$For {N}_{ZC} \geq 30 , {\overline{r}}_{u , v} ( n ) = {x}_{q} ( n mod {N}_{ZC} ) , {x}_{q} ( n ) = {e}^{- j \frac{π qm ( m + 1 )}{{N}_{ZC}}} . \qquad 3.$$

N_{ZC} is the largest prime number less than

$${M}_{ZC} \cdot q = ⌊ \overline{q} + 1 / 2 ⌋ + v \cdot {( - 1 )}^{⌊ 2 \overline{q} ⌋} \cdot \overline{q} = {N}_{ZC} \frac{u + 1}{31} .$$

The sequence group u is given by:

$$u = ( {f}_{gh} ( {n}_{s , f}^{μ} , {l}^{′} ) + {n}_{ID}^{SRS} ) .$$

### Where

$${n}_{ID}^{SRS}$$

is provided by higher layer parameter sequenceID, with

$${n}_{ID}^{SRS} ∈ \{ 0 , 1 , … , 65535 \} .$$

Higher layer parameter groupOrSequenceHopping determines the values of u and v:
if groupOrSequenceHopping equals ‘neither’, neither group, nor sequence hopping shall be used and

$${f}_{gh} ( {n}_{s , f}^{μ} , {l}^{′} ) = 0 ,$$

and v=0.
if groupOrSequenceHopping equals ‘groupHopping’, group hopping but not sequence hopping is used and v=0, and

$${f}_{gh} ( {n}_{s , f}^{μ} , {l}^{′} ) = ( {\sum }_{m = 0}^{7} c ( 8 ( {n}_{s , f}^{μ} {N}_{symb}^{slot} + {l}_{0} + {l}^{′} ) + m ) \cdot {2}^{m} ) mod 30 ,$$

$${N}_{symb}^{slot}$$

is the number of symbols in a slots, l₀ is the first SRS symbols in the slot, and c(n) a length-31 Gold sequence defined asc(n)=(x₁(n+N_{c})+x₂(n+N_{c}))mod 2, with N_{c}=1600, x₁(n+31)=(x₁(n+3)+x₁(n)) mod 2, x₁(n+31)=(x₂(n+3)+x₂(n+2)+x₂(n+1)+x₂(n)) mod 2, the first m-sequence is initialized with x₁(0)=1, and x₂(n)=0, for n=1 . . . 30. The second m-sequence is initialized with cᵢₙᵢₜ, where

$${c}_{init} = {n}_{ID}^{SRS}$$

if groupOrSequenceHopping equals ‘sequenceHopping’, sequence hopping but not group hopping is used and

$${f}_{gh} ( {n}_{s , f}^{μ} , {l}^{′} ) = 0$$

and

$$v = \{ \begin{matrix}c ( {n}_{s , f}^{μ} {N}_{symb}^{slot} + {l}_{0} + {l}^{′} ) & {M}_{sc , b}^{SRS} \geq 6 {N}_{sc}^{R B} \\ 0 & otherwise\end{matrix}$$

$${N}_{symb}^{slot}$$

is the number of symbols in a slots, l₀ is the first SRS symbols in the slot, and c(n) a length-31 Gold sequence as previously defined.

The SRS sequence, r^{(p)}(n, l′), is mapped to resource elements

$${a}_{k , l}^{( p )}$$

within a slot, where K is the sub-carrier frequency, l is the symbol number within the slot and p is the antenna port, where for SRS there is one antenna port, by

$${a}_{k , l}^{( p )} = {β}_{SRS} {r}^{( p )} ( {k}^{′} , {l}^{′} )$$

$$l = {l}^{′} + {l}_{0}$$

Where,
β_{SRS} is a scaling factor,

$${k}^{′} = 0 , 1 , … , {M}_{sc , b}^{SRS} - 1 , {M}_{sc , b}^{SRS} = {m}_{SRS , b} {N}_{sc}^{RB} / {K}_{TC} , {m}_{SRS , b}$$

is provided by Table 6.4.14.3-1 of [REF 1], and

$${l}^{′} = 0 , 1 , … , {N}_{symb}^{SRS} - 1.$$

l=l′+l₀, with l₀ the first SRS symbols in the slot, where l₀∈{0,1, . . . , 13}.

$$k = {K}_{TC} {k}^{′} + {k}_{0}^{( pi )} ,$$

K_{TC} is the transmission comb number as previously described,

$${k}_{0}^{( p )} = {\overline{k}}_{0}^{( p )} + {\sum }_{b = 0}^{{B}_{SRS}} {K}_{TC} {M}_{sc , b}^{SRS} {n}_{b} , {\overline{k}}_{0}^{( pi )} = {n}_{shift} {N}_{sc}^{RB} + ( {k}_{TC}^{( pi )} + {k}_{offset}^{{l}^{′}} ) mod {K}_{TC} , \\ {k}_{TC}^{( pi )} = \{ \begin{matrix}( {\overline{k}}_{TC} + {K}_{TC} / 2 ) mod {K}_{TC} & \begin{matrix}if {n}_{SRS}^{cs} ∈ \{ \frac{{n}_{SRS}^{cs , max}}{2} , … , {n}_{SRS}^{cs , max} - 1 \} and {N}_{ap}^{SRS} = \\ 4 and {p}_{i} ∈ \{ 1001 , 1003 \}\end{matrix} \\ {\overline{k}}_{TC} & otherwise\end{matrix}$$

k̅_{TC} is the transmission comb offset included within higher layer IE transmissionComb, with k̅_{TC}∈{0, 1, . . . , K_{TC}−1},

$${k}_{offset}^{{l}^{′}}$$

is a symbol dependent sub-carrier offset given by Table 3, n_{shift} is given by higher layer parameter freqDomainShift and it adjust the frequency allocation with respect to a reference point. If

$${N}_{BWP}^{start} \leq {n}_{shift}$$

the reference point for

$${k}_{0}^{( p )}$$

is sub-carrier 0 in common resource block 0, otherwise the reference point is the lowest subcarrier of the BWP. n_{b} is a frequency positioning index. n_{b} is given by:

$${n}_{b} = ⌊ \frac{4 {n}_{RRC}}{{m}_{SRS , b}} ⌋ mod {N}_{b}$$

n_{RRC} is given by higher layer parameter freqDomainPosition, and m_{SRS,b} and N_{b} are determined by Table 6.4.14.3-1 of [REF 1] with b=B_{SRS} and the configured value of C_{SRS}.

TABLE 2

| | ${k}_{offset}^{0} , {k}_{offset}^{1} , … , {k}_{offset}^{{N}_{symb}^{SRS} - 1}$ | | | | |
|---|---|---|---|---|---|
| K_{TC} | ${N}_{symb}^{SRS} = 1$ | ${N}_{symb}^{SRS} = 2$ | ${N}_{symb}^{SRS} = 4$ | ${N}_{symb}^{SRS} = 8$ | ${N}_{symb}^{SRS} = 12$ |
| 2 | 0 | 0, 1 | 0, 1, 0, 1 | — | — |
| 4 | — | 0, 2 | 0, 2, 1, 3 | 0, 2, 1, 3, 0, 2, | 0, 2, 1, 3, 0, 2, 1, |
| | | | | 1, 3 | 3, 0, 2, 1, 3 |
| 8 | — | — | 0, 4, 2, 6 | 0, 4, 2, 6, 1, 5, | 0, 4, 2, 6, 1, 5, 3, |
| | | | | 3, 7 | 7, 0, 4, 2, 6 |

In NR paging is used to alert idle and inactive UEs of incoming calls, messages and data. Paging is used to trigger RRC setup (e.g., RRC setup request or RRC connection resumption).

Paging is transmitted over the paging channel (PCH). The paging message includes a paging record list, which is a list of UEs being paged, each identified by a temporary mobile subscriber identity (TMSI) or an information RNTI (I-RNTI). The 5G S-Temporary Mobile Subscription Identifier (5G-S-TMSI), a temporary UE identity provided by the 5GC which uniquely identifies the UE within the tracking area. The I-RNTI is used to identify the suspended UE context of a UE in RRC_INACTIVE.

The following messages describe the contents of a paging message:

| | |
|---|---|
| PCCH-Message ::= | SEQUENCE { |
| message | PCCH-MessageType |

}

| | |
|---|---|
| PCCH-MessageType ::= | CHOICE { |
| c1 | CHOICE { |
| paging | Paging, |

```
    spare1 NULL
  },
```

| | |
|---|---|
| messageClassExtension | SEQUENCE { } |

}

| Paging ::= | SEQUENCE { | |
|---|---|---|
| pagingRecordList | PagingRecordList | OPTIONAL, -- |

Need N

| | | |
|---|---|---|
| lateNonCriticalExtension | OCTET STRING | OPTIONAL, |
| nonCriticalExtension | Paging-v1700-IEs | OPTIONAL |

}

| PagingRecordList ::= | SEQUENCE (SIZE(1..maxNrofPageRec)) OF PagingRecord | |
|---|---|---|
| PagingRecord ::= | SEQUENCE { | |
| ue-Identity | PagingUE-Identity, | |
| accessType | ENUMERATED {non3GPP} | OPTIONAL, -- Need N |

...
}

| | |
|---|---|
| PagingUE-Identity ::= | CHOICE { |
| ng-5G-S-TMSI | NG-5G-S-TMSI, |
| fullI-RNTI | I-RNTI-Value, |

...
}

| | |
|---|---|
| NG-5G-S-TMSI ::= | BIT STRING (SIZE (48)) |
| I-RNTI-Value ::= | BIT STRING (SIZE(40)) |

A UE may use Discontinuous Reception (DRX) in RRC_IDLE and RRC_INACTIVE state in order to reduce power consumption. The UE monitors one paging occasion (PO) per DRX cycle, T. Where, a PO is a set of PDCCH monitoring occasions and can include multiple time slots where paging DCI can be sent. A Paging Frame (PF) is one Radio Frame and may contain one or multiple PO(s) or starting point of a PO.

The PF and PO for paging are determined by the following equations:
single frequency network (SFN) of the PF is determined by: (SFN+PF_offset) mod T=(T div N)*(UE_ID mod N)
The index i_s of the PO is determined by: i_s=floor (UE_ID/N) mod Ns

### Where,

T is the DRX cycle of the UE, determined by the shortest of the UE specific DRX value(s) and a default DRX value included in SIB1. (1) For core network (CN)-initiated paging, a default cycle is broadcast in system information. (2) For CN-initiated paging, a UE specific cycle can be configured via non access stratum (NAS) signaling. (3) For RAN-initiated paging, a UE-specific cycle is configured via RRC signaling. A UE in RRC_IDLE uses the shortest of (1) and (2). A UE in RRC_INACTIVE uses the shortest of (1), (2) and (3).
N is a number of total paging frames in T, provided by nAndPagingFrameOffset in SIB1.
Ns is a number of paging occasions for a PF, provided by ns in SIB1.
PF_offset is an offset used for PF determination, provided by nAndPagingFrameOffset in SIB1.
UE_ID: 5G-S-TMSI mod 1024

To minimize the probability of paging false alarms, which occur when a UE decodes the PCH due to another UE assigned to the same PO being paged, UEs assigned to the same PO are divided in into sub-groups, a DCI carrying a paging early indication (PEI) is transmitted before the corresponding PO to indicate the sub-groups with paging messages in the PO. A UE that is not in the indicated sub-groups indicated by the PEI doesn't decode the corresponding PO. There can be up to 8 sub-groups. The subgroups can be CN controlled sub-groups (determined by the access and mobility function (AMF)), and/or UE-ID based sub-groups.

DCI format 2_7 is used for notifying the paging early indication and tracking reference signal (TRS) availability indication for one or more UEs. DCI Format 2_7 has a CRC scrambled by PEI RNTI. DCI Format 2_7 includes: (1) a paging indication field of size

$${N}_{PO}^{PEI} \cdot {N}_{SG}^{PO} ,$$

where,

$${N}_{PO}^{PEI}$$

is the number of paging occasions configured by higher layer parameter po-NumPerPEI, and

$${N}_{S G}^{P O}$$

is the number of sub-groups of a paging occasion configured by higher layer parameter subgroupsNumPerPO. Each bit in the field indicates one UE subgroup of a paging occasion. (2) TRS availability indication, which can be of size 1-6 bits, where the number of bits is equal to one plus the highest value of the indBitID(s) provided by the trs-ResourceSetConfig if configured; 0 bits otherwise. Each TRS resource set is configured with an ID i for the association with (i+1)-th indication bit.

This disclosure provides early triggering of CSI measurement/reporting and/or SRS for UEs in RRC_IDLE or RRC_INACTIVE states when the network (e.g., the network 130) has data to send to the UE or the UE has data send to network. Early CSI measurement/reporting and/or early SRS transmission can assist in determining the channel conditions and better link adaptation and better precoding for downlink and uplink transmissions. This disclosure provides means of providing configuration(s) of CSI-RS resource(s) for early triggering of CSI measurement/reporting, means of providing configuration(s) of SRS resource(s) for early triggering of SRS transmission, signaling medium(s)/container(s) to carry the configuration(s) and the corresponding UE's behaviors/assumptions.

When a UE is in RRC_IDLE state or RRC_INACTIVE state, and data arrives at the network for the UE, or data arrives at the UE for the network, the UE through RRC setup procedure or RRC reconfiguration procedure transitions to the RRC_CONNECTED state. After transition to the RRC_CONNECTED state the network can trigger CSI measurement/reporting and/or trigger SRS transmission from the UE for channel quality estimation and the UE can start transmitting and receiving data. For instance, in terms of uplink channel estimation/acquisition, the SRS triggered can be wideband SRS or sub-band SRS, which would require several SRS transmission instances to provide an estimate of the channel quality of the full bandwidth. This process, i.e., the estimation of the channel quality, can take tens of milliseconds, and even longer with sub-band SRS. Data transmission/reception can be delayed until the channel quality has been estimated using CSI-RS and/or SRS, hence increasing latency. Alternatively, data transmission/reception can proceed in parallel with the CSI measurement/reporting and/or SRS transmission, and by the time the channel quality is estimated, the data (depending on the amount of data) has already or mostly been transmitted or received, hence rendering the channel quality estimation less useful while preceding transmissions/receptions from/to the UE are with reduced spectral efficiency due to the absence of a channel estimate at the gNB for the UE.

To mitigate this issue, it is beneficial to have the channel quality estimated in parallel with the RRC setup procedure, or RRC reconfiguration procedure such that when the UE is ready to transmit or receive data at the completion of the setup or reconfiguration procedures, the channel quality has already been estimated and link adaptation and precoding for uplink or downlink data is based on the estimated channel quality. Hence, there is a benefit for performing CSI measurement/reporting and/or transmitting SRS in parallel with RRC setup procedure, or RRC reconfiguration procedure to reduce latency.

When the network initiates a communication session, the UE is first paged, and this is then followed by a random access (RA), or also referred to as RACH, procedure. When the UE initiates a communication session, a RACH procedure is used. The early triggered CSI measurement/reporting and/or early SRS triggering and/or transmission mentioned herein can occur during paging, and/or can be associated with the paging procedure. Alternatively, the early triggered CSI measurement/reporting and/or early SRS triggering and/or transmission mentioned herein can occur during a RACH procedure or can be associated with a RACH procedure. Embodiments of the present disclosure recognize that means of providing configuration(s) of CSI-RS resource(s) for early triggering of CSI measurement/reporting, means of providing configuration(s) of SRS resource(s) for early triggering of SRS transmission, and signaling medium(s)/container(s) to carry the configuration(s) and the corresponding UE's behaviors/assumptions are needed.

This disclosure covers various design examples, aspects and means of providing configuration(s) of CSI-RS resource(s) for early triggering of CSI measurement/reporting, and/or configuration(s) of SRS resource(s) for early triggering of SRS transmission, including:
Signaling medium(s)/container(s) to carry the configuration(s), which includes SIB, RRC setup, RRC reconfiguration, RRC release message and/or etc.
Detailed configuration(s) and setting(s) for the CSI-RS resource(s) for early CSI measurement/reporting triggering and/or the SRS resource(s) for early SRS transmission triggering.
Selection and indication of CSI-RS resource configuration(s) by the UE for the early triggering of CSI measurement/reporting, and/or selection and indication of SRS resource configuration(s) by the UE for the early triggering of SRS transmission
Selection and indication of CSI-RS and/or SRS resource configuration(s) by the network for the early triggering of CSI measurement/reporting and/or SRS transmission(s)

The corresponding/related design procedure(s), signaling flow(s)/method(s), UE's assumption(s)/behavior(s) and/or etc. are also presented in this disclosure.

Throughout the present disclosure, aspects, features, and advantages of the disclosure are readily apparent from the following detailed description, simply by illustrating a number of particular embodiments and implementations, including the best mode contemplated for carrying out the disclosure. The disclosure is also capable of other and different embodiments, and its several details can be modified in various obvious respects, all without departing from the spirit and scope of the disclosure. Accordingly, the drawings and description are to be regarded as illustrative in nature, and not as restrictive. The disclosure is illustrated by way of example, and not by way of limitation, in the figures of the accompanying drawings. Furthermore, both frequency division duplexing (FDD) and time division duplexing (TDD) are regarded as a duplex method for DL and UL signaling. Although exemplary descriptions and embodiments to follow expect orthogonal frequency division multiplexing (OFDM) or orthogonal frequency division multiple access (OFDMA), this disclosure can be extended to other OFDM-based transmission waveforms or multiple access schemes such as filtered OFDM (F-OFDM). This disclosure provides several components that can be used in conjunction or in combination with one another, or can operate as standalone schemes.

In the present disclosure, RRC signaling (e.g., configuration by RRC signaling) includes (1) common signaling, e.g., this can be system information block (SIB)-based RRC signaling (e.g., SIB1 or other SIB) or (2) RRC dedicated signaling that is sent to a specific UE or (3) UE-group RRC signaling. In addition, MAC CE signaling can be UE-specific e.g., to one UE and can be UE common (e.g., to a group of UEs). MAC CE signaling can be DL MAC CE signaling or UL MAC CE signaling. Furthermore, L1 control signaling includes: (1) DL control information (e.g., DCI on PDCCH or DL control information on PDSCH) and/or (2) UL control information (e.g., uplink control information (UCI) on PUCCH or PUSCH). L1 control signaling be UE-specific e.g., to one UE and can be UE common (e.g., to a group of UEs).

In the present disclosure, the term “activation” describes an operation wherein a UE receives and decodes a signal from the network (or gNB) that signifies a starting point in time. The starting point can be a present or a future slot/subframe or symbol and the exact location is either implicitly or explicitly indicated, or is otherwise defined in the system operation or is configured by higher layers. Upon successfully decoding the signal, the UE responds according to an indication provided by the signal. The term “deactivation” describes an operation wherein a UE receives and decodes a signal from the network (or gNB) that signifies a stopping point in time. The stopping point can be a present or a future slot/subframe or symbol and the exact location is either implicitly or explicitly indicated, or is otherwise defined in the system operation or is configured by higher layers. Upon successfully decoding the signal, the UE responds according to an indication provided by the signal.

Terminology such as TCI, TCI states, SpatialRelationInfo, target RS, reference RS, and other terms is used for illustrative purposes and is therefore not normative. Other terms that refer to same functions can also be used. A “reference RS” (e.g., reference source RS) corresponds to a set of characteristics of a DL beam or an UL TX beam, such as a direction, a precoding/beamforming, a number of ports, and so on. For instance, the UE can receive a source RS index/ID in a TCI state assigned to (or associated with) a DL transmission (and/or UL transmission), the UE applies the known characteristics of the source RS to the assigned DL transmission (and/or UL transmission). The source RS can be received and measured by the UE (in this case, the source RS is a downlink measurement signal such as NZP CSI-RS and/or SSB) with the result of the measurement used for calculating a beam report (e.g., including at least one L1-RSRP/L1-signal-to-interference-plus-noise ratio (SINR) accompanied by at least one CSI-RS resource indicator (CRI) or SSB resource indicator (SSBRI)). As the NW/gNB (e.g., the BS 102) receives the beam report, the NW can be better equipped with information to assign a particular DL (and/or UL) TX beam to the UE. Optionally or alternatively, the source RS can be transmitted by the UE (in this case, the source RS is an uplink measurement signal such as SRS). As the NW/gNB receives the source RS, the NW/gNB can measure and calculate the needed information to assign a particular DL (or/and UL) TX beam to the UE, for example in case of channel reciprocity.

In the present disclosure, DCI Format is used for L1 control information in the DL direction from gNB to UE. DCI Format (i.e., L1 control information) can be signal stage/part control information or two stage/part control information. In one example, the DCI format can be carried on a physical downlink control channel (PDCCH). In one example, DCI format can be carried on a physical downlink shared channel (PDSCH). In one example, DCI can be split between PDCCH (e.g., for a first part) and PDSCH (e.g. for a second part). Furthermore, a higher layer message (e.g., SIB-based or RRC-based or MAC CE-based) can be carried by a physical downlink shared channel (PDSCH). In one example, the PDSCH can be scheduled by a DCI format.

In the present disclosure, the configuration(s) of CSI-RS resource(s) may include, contain or comprise at least one or more of the following parameters/settings/components:
CSI-RS resource (including SSB and NZP CSI-RS resource) ID/index, CSI resource set (including SSB resource set and NZP CSI-RS resource set) ID/index, CSI resource configuration/setting ID/index, CSI reporting configuration/setting ID/index.
Resource type and corresponding parameter(s) for the corresponding CSI-RS resource(s) including ‘aperiodic’, ‘periodic’, and/or ‘semi-persistent’; the parameter(s) corresponding to the resource type of ‘aperiodic’ could also comprise or include or contain an aperiodic CSI trigger state list provided by CSI-AperiodicTriggerStateList.
Repetition setting (e.g., repetition set to ‘on’ or ‘off’)
Usage of the CSI-RS resource(s): e.g., CSI-RS for beam management, CSI-RS for CSI, TRS (with trs-Info set to ‘true’), and etc.
Time and frequency resources (e.g., symbols within a slot for CSI-RS, starting symbol for CSI-RS, time slot for CSI-RS, periodicity and offset of CSI-RS (e.g., in case of periodic or semi-persistent CSI-RS), starting PRB for CSI-RS, number of PRBs for CSI-RS).
Resource mapping of CSI-RS resource(s): OFDM symbol location(s) in a slot and subcarrier occupancy in a PRB of the CSI-RS resource
Periodicity and slot offset for the CSI-RS resource(s)
Scrambling ID
Transmit power control parameter(s)/setting(s) for the corresponding reference signal.
TCI state(s) and/or reference signal(s) used for determining the spatial filter(s) for receiving the corresponding CSI-RS(s).

In particular, a UE (e.g., the UE 116) could be provided or indicated or configured by the network, e.g., via higher layer RRC signaling(s)/parameter(s) and/or MAC CE command(s) and/or dynamic DCI based L1 signaling(s) based on or according to a corresponding UE's capability or capability signaling, the configuration(s) of the CSI-RS resource(s) for the early triggering of the CSI measurement/reporting. For instance, the UE could be provided by the network via/in a higher layer parameter EarlyCSI-ResourceConfig providing or configuring or indicating:
At least one or more of the parameters/settings/components mentioned herein for the configuration(s) of the corresponding CSI-RS resource(s)
At least one or more of parameters/settings/components provided or configured by/in higher layer parameter(s) including at least CSI-ResourceConfig, CSI-ResourceSet including CSI-SSB-ResourceSet/NZP-CSI-RS-ResourceSet, NZP-CSI-RS-Resource/SSB-Index, and/or etc. for the corresponding CSI-RS resource(s) defined/specified in [REF 6] for 5G NR.

The UE could alternatively be provided by the network via/in a higher layer parameter EarlyCSI-ReportConfig associated/specific to one or more CSI resource settings/configurations—each provided by EarlyCSI-ResourceConfig—for the early triggering of the CSI measurement/reporting as mentioned herein, wherein the higher layer parameter EarlyCSI-ReportConfig could provide or configure or indicate at least one or more of parameters/settings/components provided or configured by/in higher layer parameter(s) including at least CSI-ReportConfig associated/specific/linked to the corresponding CSI-RS resource(s) defined/specified in [REF 6] for 5G NR.

In one example, the UE could be provided or configured by the network, in system information block including SIB1, SIB2 and/or other SIBs, the discussed/specified CSI-RS resource configuration(s) for early triggering of the CSI measurement/reporting herein (e.g., provided by EarlyCSI-ResourceConfig or EarlyCSI-ReportConfig). Examples of providing or configuring the EarlyCSI-ResourceConfig and/or EarlyCSI-ReportConfig as defined/specified herein in the higher layer parameters SIB1 and SIB2 are respectively presented herein.

SIB1 ::= SEQUENCE {
...,

| | |
|---|---|
| earlyCsi-ResourceConfig | SetupRelease {EarlyCSI-ResourceConfig} |

OPTIONAL, -- Need M

| | |
|---|---|
| earlyCsi-ReportConfig | SetupRelease {EarlyCSI-ReportConfig} |

```
OPTIONAL, -- Need M
  ...
}
SIB2 ::= SEQUENCE {
  ...,
```

| | |
|---|---|
| earlyCsi-ResourceConfig | SetupRelease {EarlyCSI-ResourceConfig} |

OPTIONAL, -- Need M

| | |
|---|---|
| earlyCsi-ReportConfig | SetupRelease {EarlyCSI-ReportConfig} |

OPTIONAL, -- Need M
...
}

In one example, the UE could be provided or configured by the network, in RRC release message, the discussed/specified CSI-RS resource configuration(s) for early triggering of the CSI measurement/reporting (e.g., provided by EarlyCSI-ResourceConfig or EarlyCSI-ReportConfig) herein. One example of providing or configuring the EarlyCSI-ResourceConfig and/or EarlyCSI-ReportConfig as defined/specified herein in the higher layer parameters RRCRelease-IEs is presented herein.

| RRCRelease-IEs ::= SEQUENCE { | | |
|---|---|---|
| redirectedCarrierInfo | RedirectedCarrierInfo | OPTIONAL, |
| -- Need N, | | |
| cellReselectionPriorities | CellReselectionPriorities | |
| OPTIONAL, -- Need R, | | |
| suspendConfig | SuspendConfig | OPTIONAL, -- |

| Need R, | |
|---|---|
| ..., | |
| earlyCsi-ResourceConfig | SetupRelease {EarlyCSI-ResourceConfig} |
| OPTIONAL, -- Need M | |
| earlyCsi-ReportConfig | SetupRelease {EarlyCSI-ReportConfig} |

OPTIONAL, -- Need M
...
}

According to those specified herein in the present disclosure, the UE could be provided or configured or indicated by the network, e.g., via higher layer RRC signaling(s)/parameter(s) and/or MAC CE command(s) and/or dynamic DCI based L1 signaling(s) based on or according to a corresponding UE's capability or capability signaling, which RRC signaling(s)/parameter(s)—e.g., RRCRelease-IEs and/or SIB1 and/or SIB2 as specified/defined herein—to use/apply for determine the CSI-RS resource configuration(s) for the early CSI measurement/reporting triggering(s). Furthermore, the CSI-RS resource configuration(s) for the early triggering of the CSI measurement/reporting, e.g., provided by EarlyCSI-ResourceConfig or linked/specific to EarlyCSI-ReportConfig, can be (configured to be) present or absent/not present in the corresponding RRC signaling(s)/parameter(s)—e.g., RRCRelease-IEs and/or SIB1 and/or SIB2 as specified/defined herein. When/if there are multiple or more than one RRC signalings/parameters, e.g., both SIB1 and RRCRelease-IEs, providing or configuring the CSI-RS resource configurations for the early triggering, the UE could determine or identify which of the CSI-RS resource configurations, provided/configured in the multiple RRC signalings/parameters as specified/defined herein in the present disclosure, to use/apply for the early CSI measurement/reporting triggering(s), according to or based on
Fixed rule(s) in system specification(s) and/or per RRC (re-)configuration/setup: for example, the UE could determine or identify the CSI-RS resource configuration(s), e.g., EarlyCSI-ResourceConfig/EarlyCSI-ReportConfig, provided/configured in SIB1 to use/apply for the early CSI measurement/reporting triggering(s); for another example, the UE could determine or identify the CSI-RS resource configuration(s), e.g., EarlyCSI-ResourceConfig/EarlyCSI-ReportConfig, provided/configured in SIB1 to use/apply for the early CSI measurement/reporting triggering(s); for another example, the UE could determine or identify the CSI-RS resource configuration(s), e.g., EarlyCSI-ResourceConfig and/or EarlyCSI-ReportConfig, provided/configured in the higher layer parameter(s)/signaling(s) that is provided/received the latest (or earlies) in time to use/apply for the early CSI measurement/reporting triggering(s); for another example, association(s)/mapping(s) between one or more of the higher layer signalings/parameters that provide or configure the CSI-RS resource configurations for early triggering of the CSI measurement/reporting and one or more of signaling mediums/containers that could carry or provide actual indicator(s) to trigger the early CSI measurement/reporting according to or following those specified/described herein in the present disclosure could be fixed in system specification(s) and/or per RRC (re-)configuration/setup; for this design example, when/if the UE has received an indicator to trigger the early CSI measurement/reporting as specified/defined herein in the present disclosure, the UE could then determine or identify the CSI-RS resource configuration for the early CSI measurement/reporting triggering based on or according to the association/mapping relationship between the higher layer parameter/signaling that provides/configures the CSI-RS resource configuration and the signaling medium/container that carries or provides or indicates the indicator; for another example, the UE could determine or identify the CSI-RS resource configuration(s) for the early triggering of the CSI measurement/reporting according to or based on priority orders of the higher layer parameters/signalings that provide or configure the CSI-RS resource configurations for early CSI measurement/reporting triggering(s) from high to low (or from low to high), wherein the priority orders could be fixed in system specification(s) and/or per RRC (re-)configuration/setup.
Network's configuration(s)/indication(s), e.g., via/by higher layer RRC signaling(s)/parameter(s) and/or MAC CE command(s) and/or dynamic DCI based L1 signaling(s) based on or according to a corresponding UE's capability or capability signaling: for example, the network's configuration(s)/indication(s) can be in form of a bitmap with each entry/bit position of the bitmap corresponding/specific to a higher layer parameter/signaling that provides the CSI-RS resource configuration(s)—e.g., provided by EarlyCSI-ResourceConfig or EarlyCSI-ReportConfig—for the early triggering; for this design example, when/if an entry/bit position of the bitmap is set to ‘1’ (or ‘0’), the higher layer parameter/signaling that is corresponding/specific to the entry/bit position is enabled for providing or configuring the CSI-RS resource configuration for the early triggering of the CSI measurement/reporting; for another example, the network's configuration(s)/indication(s) can be in form of one-bit flag indicator(s), provided/configured in or associated/specific to the higher layer parameter(s)/signaling(s) that provides the CSI-RS resource configuration(s) for the early triggering of the CSI measurement/reporting; for this design example, when/if an one-bit flag indicator, provided/configured in or associated/specific to a higher layer parameter/signaling that provides the CSI-RS resource configuration(s) for the early triggering, is set to ‘1’ (or ‘0’) or ‘enabled’, the higher layer parameter/signaling is enabled for providing or configuring the CSI-RS resource configuration for the early triggering of the CSI measurement/reporting; for another example, the UE could be indicated, configured or provided by the network, e.g., via/by higher layer RRC signaling(s)/parameter(s) and/or MAC CE command(s) and/or dynamic DCI based L1 signaling(s) based on or according to a corresponding UE's capability or capability signaling, association(s)/mapping(s) between one or more of the higher layer signalings/parameters that provide or configure the CSI-RS resource configurations for early triggering of the CSI measurement/reporting and one or more of signaling mediums/containers that could carry or provide actual indicator(s) to trigger the early CSI measurement/reporting according to or following those specified/described herein in the present disclosure; for this design example, when/if the UE has received an indicator to trigger the early CSI measurement/reporting as specified/defined herein in the present disclosure, the UE could then determine or identify the CSI-RS resource configuration for the early CSI measurement/reporting triggering based on or according to the association/mapping relationship between the higher layer parameter/signaling that provides/configures the CSI-RS resource configuration and the signaling medium/container that carries or provides or indicates the indicator; for another example, the UE could be indicated, configured or provided by the network, e.g., via/by higher layer RRC signaling(s)/parameter(s) and/or MAC CE command(s) and/or dynamic DCI based L1 signaling(s) based on or according to a corresponding UE's capability or capability signaling, priority order(s) for the higher layer signalings/parameters that provide or indicate the CSI-RS resource configurations for the early triggering of the CSI measurement/reporting; for this design example, the UE could determine or identify the CSI-RS resource configuration(s) for the early triggering of the CSI measurement/reporting according to or based on priority orders of the higher layer parameters/signalings that provide or configure the CSI-RS resource configurations for early CSI measurement/reporting triggering(s) from high to low (or from low to high).
   In some embodiments, early triggering of the CSI measurement and/or reporting can be initiated for a group of UEs, rather than a per-UE basis. This group-based triggering mechanism reduces control signaling overhead and is particularly advantageous in scenarios involving a high density of UEs, such as in urban deployments or massive machine-type communication environments. The gNB may group UEs based on a number of factors, such as similar QoS profiles, physical proximity, beam alignment, or mobility patterns, and may indicate a group-common control signal to trigger early CSI acquisition for the deployment scenarios specified in the present disclosure. For example, a group-common DCI, such as DCI format 2_0, 2_1, 2_2, 2_3, may be used to signal early triggering of CSI acquisition to multiple UEs, wherein the early triggering of CSI acquisition can be via a dedicated field in the group-common DCI or by repurposing an existing field (hence one or more codepoints of the existing field) in the group-common DCI. Alternatively, other forms of group-common signaling such as MAC-CEs addressed to a group RNTI may be employed. Upon receiving the group-common trigger, each UE in the group performs early CSI measurement and/or reporting based on the associated configurations.

FIG. 10 illustrates a signal flow of an example procedure 1000 for early triggering of CSI measurement/reporting according to embodiments of the present disclosure. For example, procedure 1000 can be performed by the UE 116 and the gNB 102 and/or network 130 in the wireless network 100 of FIG. 1. This example is for illustration only and other embodiments can be used without departing from the scope of the present disclosure.

The procedure begins in 1010, a NW/gNB transmits configuration(s) of CSI-RS resource(s) for early triggering to a UE, e.g., via SIB, RRC, release message, etc. In 1020, the NW/gNB transmits a triggering of CSI measurement/reporting to the UE via an indicator sent in first channel(s)/signal(s). In 1030, the UE transmits measurement results to the NW/gNB in second channel(s)/signal(s).

According to those specified herein in the present disclosure, a UE could be provided or configured or indicated by the network (e.g., the network 130), e.g., via higher layer RRC signaling(s)/parameter(s)—e.g., via/by/in SIB1, SIB2, RRCRelease-IEs, and/or etc.—and/or MAC CE command(s) and/or dynamic DCI based L1 signaling(s) based on or according to a corresponding UE's capability or capability signaling, one or more CSI-RS resource configurations (e.g., each provided by EarlyCSI-ResourceConfig or EarlyCSI-ReportConfig) for the early triggering of the CSI measurement/reporting. For instance, a UE could be provided or configured by the network, e.g., via/by/in a/the same RRC signaling/parameter (e.g., SIB1, SIB2 or RRCRelease-IEs as specified/described herein in the present disclosure) and/or different or separate RRC signalings/parameters (e.g., via/by/in both SIB1 and RRCRelease-IEs), multiple or more than one (denoted by K_early>1) CSI-RS resource configurations for the early triggering of the CSI measurement/reporting—each provided by EarlyCSI-ResourceConfig or EarlyCSI-ReportConfig as defined herein in the present disclosure.

An example signaling flow characterizing early CSI measurement/reporting triggering procedure(s) is provided in FIG. 10. As illustrated in FIG. 10, after the UE has received from the network the CSI-RS resource configuration(s) for the early triggering of the CSI measurement/reporting according to or following those specified herein in the present disclosure, the UE could expect to receive from the network, in/via/by one or more first triggering channels/signals, one or more first indicators to indicate and/or trigger and/or enable the (early) triggering of the CSI measurement/reporting. Upon detection and/or reception of the one or more first indicators, the UE could determine or identify, based on or according to the CSI-RS resource configuration(s), the CSI-RS(s) along with the corresponding parameter(s)/setting(s) to receive and measure. In this case, the UE could then transmit or send to the network, in/via/by one or more second channels/signals, measurement result(s) such as a beam/CSI report comprising one or more report quantities including SSBRI(s)/CRI(s), L1-RSRP(s)/L1-SINR(s), CQI(s), RI(s), PMI(s) and/or etc. The UE could determine or identify the second channel(s)/signal(s)—e.g., in form/terms of time and/or frequency resource(s)—to transmit the measurement result(s) according to or based on association(s)/mapping(s) between (resource(s) of) the second channel(s)/signal(s) and (resource(s) of) the first triggering channel(s)/signal(s), wherein the association(s)/mapping(s) could be in form/terms of timing relationship(s) or timeline(s), configuration(s), time-frequency resource allocation(s) and/or etc. according to or based on: (1) fixed rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). In the present disclosure, the UE could determine or identify the one or more first triggering channels/signals based on or according to:
In one example (Option-1), the first triggering channel(s)/signal(s) could correspond to or could be associated/specific to a DCI format (e.g., a DL DCI format of 1_0/1_1/1_2/1_3 or a UL DCI format of 0_0/0_1/0_2/0_3 or a DCI format of 2_3 or a new DL/UL DCI format, e.g., dedicated for the early triggering of the CSI measurement/reporting), wherein the one or more first indicators could correspond to or could be provided/indicated in/by one or more new DCI fields in the DCI format(s), or one or more existing DCI fields (e.g., CSI request field in DCI format 0_1/0_2) in the DCI format(s) repurposed for the early triggering of the CSI measurement/reporting. Furthermore, the CRC of the DCI format(s) could be scrambled with a RNTI, wherein the RNTI could be associated with the early triggered CSI-RS(s).
In another example (Option-2), the first triggering channel(s)/signal(s) could correspond to or could be associated/specific to a higher layer message carried by/in a PDSCH, wherein the higher layer message could be a SIB message (e.g., SIB1, SIB2 or other SIB message(s)), a RRC message (e.g., a RRC reconfiguration message, a RRC setup message, a RRC release message, and/or etc.), a MAC CE message/signaling, and/or etc.; furthermore, the PDSCH could be scheduled/activated by a corresponding DCI format. The CRC of the higher layer message and/or the corresponding DCI format could be scrambled with a RNTI, wherein the RNTI could be associated with the early triggered CSI-RS(s). In this case, the higher layer message could carry, convey, include or comprise the one or more first indicators as specified/defined herein in the present disclosure.
In another example (Option-3), the first triggering channel(s)/signal(s) could correspond to or could be associated/specific to one or more paging occasions (POs) or a paging early indication (PEI) associated with a PO, wherein the PEI could include an indication for each subgroup of a PO whether there is a corresponding paging message for the UEs of that subgroup. In this case, the PO(s)/PEI could comprise, contain, include, convey or carry the one or more first indicators as specified/defined herein in the present disclosure. In addition, the PEI could be carried or conveyed using a DCI format (e.g., DCI format 2_7).
In another example (Option-4), the first triggering channel(s)/signal(s) could correspond to or could be associated/specific to a random access response (RAR)—e.g., Msg2—to a preamble transmission for a contention based or a contention free random access procedure; in this case, the RAR (e.g., Msg2) could also include, comprise, carry or convey the one or more first indicators as specified/defined herein in the present disclosure. Optionally, the first triggering channel(s)/signal(s) could correspond to or could be associated/specific to a contention resolution message (e.g., a MAC CE) providing a C-RNTI for the UE, or in Msg4, of a contention based random access procedure; in this case, the contention resolution message (e.g., Msg4) could also include, comprise, carry or convey the one or more first indicators as specified/defined herein in the present disclosure. Alternatively, the first triggering channel(s)/signal(s) could correspond to or could be associated/specific to a MsgB of a Type-2 random access procedure, wherein the MsgB could be for success RAR (e.g., of a contention based random access procedure) or a fall back RAR (e.g., of a contention free random access procedure); in this case, the MsgB (or the success RAR or fall back RAR) could also include, comprise, carry or convey the one or more first indicators as specified/defined herein in the present disclosure.

The UE could determine or identify which one or more of the Option-1, Option-2, Option-3 and Option-4 to use or follow or apply to determine or identify the first triggering channel(s)/signal(s) according to: (1) fixed rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). The one or more first indicators could correspond to or comprise, or could be in form/terms of one or more of:
A one-bit flag indicator (e.g., a new one-bit DCI field in the DCI format(s) as specified/defined in Option-1) with ‘1’ (or ‘0’) indicating or enabling or triggering (early) CSI measurement/reporting
A (higher layer) parameter set to ‘enabled’ or ‘on’ indicating or enabling or triggering (early) CSI measurement/reporting

The one or more first indicators could be present or absent in their corresponding first triggering channel(s)/signal(s) according to network's configuration or indication (e.g., via RRC signaling(s)/configuration(s)). For instance, the UE could be provided or indicated or configured by the network a higher layer parameter/signaling denoted by earlyCSITrigger_PresentInDCI. In this case, when/if the higher layer parameter/signaling earlyCSITrigger_PresentInDCI is provided/configured and/or set to ‘enabled’ or ‘on’, the first indicator(s) as specified/defined herein in the present disclosure could be present in the corresponding DCI format(s) as specified/defined in Option-1 following those specified herein in the present disclosure; otherwise, i.e., when/if the higher layer parameter/signaling earlyCSITrigger_PresentInDCI is not provided/configured and/or set to ‘disabled’ or ‘off’, the first indicator(s) as specified/defined herein in the present disclosure may not be present or could be absent in the corresponding DCI format(s) as specified/defined in Option-1 according to those specified herein in the present disclosure.

The UE could additionally receive from the network, in/via/by the one or more first triggering channels/signals, one or more second indicators to indicate or provide resource allocation(s) for the (early) triggered CSI measurement/reporting.
For Option-1 specified/defined herein in the present disclosure, the one or more second indicators could correspond to or could be provided/indicated in/by one or more new DCI fields in the DCI format(s), or one or more existing DCI fields (e.g., CSI request field in DCI format 0_1/0_2) in the DCI format(s) repurposed for indicating or providing resource allocation(s) for the (early) triggered CSI measurement/reporting.
For Option-2 specified/defined herein in the present disclosure, the higher layer message could carry, convey, include or comprise the one or more second indicators as specified/defined herein in the present disclosure.
For Option-3 specified/defined herein in the present disclosure, the PO(s)/PEI could comprise, contain, include, convey or carry the one or more second indicators as specified/defined herein in the present disclosure.
For Option-4 specified/defined herein in the present disclosure, the RAR (e.g., Msg2) could also include, comprise, carry or convey the one or more second indicators as specified/defined herein in the present disclosure. Optionally, the contention resolution message (e.g., Msg4) could also include, comprise, carry or convey the one or more second indicators as specified/defined herein in the present disclosure. Alternatively, the MsgB (or the success RAR or fall back RAR) could include, comprise, carry or convey the one or more second indicators as specified/defined herein in the present disclosure.

The one or more second indicators could be present or absent in their corresponding first triggering channel(s)/signal(s) according to network's configuration or indication (e.g., via RRC signaling(s)/configuration(s)). For instance, the UE could be provided or indicated or configured by the network a higher layer parameter/signaling denoted by earlyCSIRa_PresentInDCI. In this case, when/if the higher layer parameter/signaling earlyCSIRa_PresentInDCI is provided/configured and/or set to ‘enabled’ or ‘on’, the second indicator(s) as specified/defined herein in the present disclosure could be present in the corresponding DCI format(s) as specified/defined in Option-1 following those specified herein in the present disclosure; otherwise, i.e., when/if the higher layer parameter/signaling earlyCSIRa_PresentInDCI is not provided/configured and/or set to ‘disabled’ or ‘off’, the second indicator(s) as specified/defined herein in the present disclosure may not be present or could be absent in the corresponding DCI format(s) as specified/defined in Option-1 according to those specified herein in the present disclosure.

In one example, the higher layer parameter(s)/signaling(s) including SIB1, SIB2, RRCRelease-IEs as specified/defined herein could provide or indicate or comprise multiple or more than one (K_early>1) CSI-RS resource configurations for the early triggering of the CSI measurement/reporting, wherein each of the CSI-RS resource configurations could be provided by EarlyCSI-ResourceConfig or EarlyCSI-ReportConfig, and could comprise or provide or include or configure, and/or could be linked/associated/specific to one or more CSI resource sets each provided by EarlyCSI-ResourceSet such as EarlyCSI-SSB-CSI-ResourceSet or EarlyNZP-CSI-RS-ResourceSet and comprising, providing or configuring one or more CSI-RS resources each provided by EarlySSB-Index or EarlyNZP-CSI-RS-Resource. For this design example, the one or more second indicators could correspond to or comprise, or could be in form/terms of one or more of:
A bitmap of length K_early with each entry/bit position of the bitmap associated/corresponding/specific to a CSI-RS resource configuration provided by EarlyCSI-ResourceConfig or EarlyCSI-ReportConfig for the early triggering of the CSI measurement/reporting. In this case, when/if an entry/bit position of the bitmap is set to ‘1’ (or ‘0’), the CSI-RS resource configuration associated/corresponding/specific to the entry/bit position could be used/applied (by the UE) for determining or identifying the CSI-RS resource(s) and the corresponding parameter(s)/setting(s) to receive and measure the (early) triggered CSI-RS(s). For Option-1, the bitmap could be provided or indicated by a new DCI field in the corresponding DCI format(s).
One or more one-bit flag indicators each associated/corresponding/specific to a CSI-RS resource configuration provided by EarlyCSI-ResourceConfig or EarlyCSI-ReportConfig for the early triggering of the CSI measurement/reporting. In this case, when/if a one-bit flag indicator is set to ‘1’ (or ‘0’), the CSI-RS resource configuration associated/corresponding/specific to the one-bit flag indicator could be used/applied (by the UE) for determining or identifying the CSI-RS resource(s) and the corresponding parameter(s)/setting(s) to receive and measure the (early) triggered CSI-RS(s). For Option-1, the one or more one-bit flag indicators could be provided or indicated by one or more new DCI fields in the corresponding DCI format(s).
A x0-bit indicator with x0=┌log₂(K_early)┐: each codepoint/state of the x0-bit indicator could be associated/corresponding/specific to a CSI-RS resource configuration provided by EarlyCSI-ResourceConfig or EarlyCSI-ReportConfig for the early triggering of the CSI measurement/reporting. In this case, when a codepoint/state of the x0-bit indicator is indicated, the CSI-RS resource configuration associated/corresponding/specific to the codepoint/state of the x0-bit indicator could be used/applied (by the UE) for determining or identifying the CSI-RS resource(s) and the corresponding parameter(s)/setting(s) to receive and measure the (early) triggered CSI-RS(s). For Option-1, the x0-bit indicator could be provided or indicated by a new DCI field in the corresponding DCI format(s). For instance, the higher layer parameter(s)/signaling(s) including SIB1, SIB2, RRCRelease-IEs as specified/defined herein could provide or indicate or comprise K_early=4 CSI-RS resource configurations for the early triggering of the CSI measurement/reporting, wherein each of the CSI-RS resource configurations could be provided by EarlyCSI-ResourceConfig or EarlyCSI-ReportConfig; for this design example, x0=2 with codepoint/state ‘00’ indicating the first CSI-RS resource configuration or the CSI-RS resource configuration with the lowest configuration ID/index value, codepoint/state ‘01’ indicating the second CSI-RS resource configuration or the CSI-RS resource configuration with the second lowest configuration ID/index value, codepoint/state ‘10’ indicating the third CSI-RS resource configuration or the CSI-RS resource configuration with the second highest configuration ID/index value, and codepoint/state ‘11’ indicating the fourth CSI-RS resource configuration or the CSI-RS resource configuration with the highest configuration ID/index value.
One or more CSI-RS resource configuration IDs/ID values. In this case, the CSI-RS resource configuration(s) with or having the one or more CSI-RS resource configuration IDs/ID values could be used/applied (by the UE) for determining or identifying the CSI-RS resource(s) and the corresponding parameter(s)/setting(s) to receive and measure the (early) triggered CSI-RS(s). For Option-1, the one or more CSI-RS resource configuration IDs/ID values could be provided or indicated by one or more new DCI fields in the corresponding DCI format(s).
One or more indexes or index values denoted by k_1, . . . , k_x with each index or index value belonging to {1, . . . , K_early} or {0, . . . , K_early−1}, i.e., k_1, . . . , k_x∈{1, . . . , K_early} or {0, . . . , K_early−1}. In this case, the k_1-th, . . . , k_x-th CSI-RS resource configuration(s) among the configured/provided K_early CSI-RS resource configurations (e.g., with their resource configuration IDs/ID values ordered from low to high or from high to low) could be used/applied (by the UE) for determining or identifying the CSI-RS resource(s) and the corresponding parameter(s)/setting(s) to receive and measure the (early) triggered CSI-RS(s). For Option-1, the one or more indexes or index values could be provided or indicated by one or more new DCI fields in the corresponding DCI format(s).
One or more trigger states each pointing/corresponding to an entry in a list of aperiodic CSI trigger states provided by CSI-AperiodicTriggerStateList. In this case, the CSI-RS resource configuration(s) corresponding/associated/specific to the one or more trigger states could be used/applied (by the UE) for determining or identifying the CSI-RS resource(s) and the corresponding parameter(s)/setting(s) to receive and measure the (early) triggered CSI-RS(s). For Option-1, the one or more trigger states could be provided or indicated by one or more CSI request fields in the corresponding DCI format(s); optionally, the one or more trigger states could be provided or indicated by one or more new DCI fields in the corresponding DCI format(s).
One or more PRACH preamble indexes. In this case, the higher layer parameter(s)/signaling(s) including SIB1, SIB2, RRCRelease-IEs as specified/defined herein could also provide or indicate or comprise K_early>1 groups of PRACH preambles with each group corresponding/specific to a CSI-RS resource configuration provided by EarlyCSI-ResourceConfig or EarlyCSI-ReportConfig according to or based on: (1) fixed rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). For instance, when/if the one or more PRACH preamble indexes indicate that the corresponding PRACH preambles are from the x-th group of PRACH preambles (x∈{1, . . . , K_early} or {0, . . . , K_early−1}), the x-th CSI-RS resource configuration among the configured/provided K_early CSI-RS resource configurations (e.g., with their resource configuration IDs/ID values ordered from low to high or from high to low) could be used/applied (by the UE) for determining or identifying the CSI-RS resource(s) and the corresponding parameter(s)/setting(s) to receive and measure the (early) triggered CSI-RS(s). For Option-1, the one or more PRACH preamble indexes could be provided or indicated by one or more new DCI fields in the corresponding DCI format(s).
One or more subgroup indexes of a PO. In this case, the higher layer parameter(s)/signaling(s) including SIB1, SIB2, RRCRelease-IEs as specified/defined herein could also provide or indicate or comprise the K_early>1 subgroups of a PO such that each subgroup of the PO could be associated/corresponding/specific to a CSI-RS resource configuration provided by EarlyCSI-ResourceConfig or EarlyCSI-ReportConfig according to or based on: (1) fixed rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). For instance, when/if the one or more subgroup indexes of the PO comprises the x-th subgroup of the PO (x∈{1, . . . , K_early} or {0, . . . , K_early−1}), the x-th CSI-RS resource configuration among the configured/provided K_early CSI-RS resource configurations (e.g., with their resource configuration IDs/ID values ordered from low to high or from high to low) could be used/applied (by the UE) for determining or identifying the CSI-RS resource(s) and the corresponding parameter(s)/setting(s) to receive and measure the (early) triggered CSI-RS(s). For Option-1, the one or more subgroup indexes of the PO could be provided or indicated by one or more new DCI fields in the corresponding DCI format(s).
Information related to one or more CSI-RS resource configurations. The UE could determine or identify the association(s)/mapping(s) between the information and the one or more CSI-RS resource configurations according to or based on: (1) fixed rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). In this case, the one or more CSI-RS resource configurations corresponding/associated/specific to the information could be used/applied (by the UE) for determining or identifying the CSI-RS resource(s) and the corresponding parameter(s)/setting(s) to receive and measure the (early) triggered CSI-RS(s). The information could comprise one or more of: one or more UE IDs, time (including number(s) of slot(s)/symbol(s)/etc., starting slot/symbol/etc., and/or ending slot/symbol/etc.) and/or frequency (including number(s) of PRB(s)/etc., starting PRB/etc., and/or ending PRB/etc.) domain resource(s), a mapping between the one or more UE IDs and the K_early CSI-RS resource configurations, a mapping between the resources used for the PDCCH providing the DCI format (e.g., time and/or frequency resources, e.g., (e.g., starting) channel control elements (CCEs) or (e.g., starting) resource element groups (REGs) or (e.g., starting) resource blocks (RBs) or (e.g., starting) symbols or slots or subframes or frames etc.) and the K_early CSI-RS resource configurations, a mapping between the one or more UE IDs and resources used for reception of the PDCCH providing the DCI format as mentioned herein, and the K_early CSI-RS resource configurations and/or etc. For Option-1, the information could be provided or indicated by one or more new DCI fields in the corresponding DCI format(s).

When/if the second indicator(s) is absent or not present in the corresponding first triggering channel(s)/signal(s) according to or following those specified herein in the present disclosure, the UE (e.g., the UE 116) could determine the CSI-RS resource configuration(s), and therefore the corresponding CSI-RS resource(s) along with its associated parameter(s)/setting(s), to use/apply for receiving and measuring the (early) triggered CSI-RS(s) according to or based on fixed rule(s) in system specification(s) and/or per RRC (re-)configuration/setup. In this case, for example, the K_early CSI-RS resource configurations provided/configured for the early triggering of the CSI measurement/reporting could be used/applied (by the UE) for determining or identifying the CSI-RS resource(s) and the corresponding parameter(s)/setting(s) to receive and measure the (early) triggered CSI-RS(s); for another example, the first (or last) CSI-RS resource configuration or the CSI-RS resource configuration with the lowest (or highest) configuration ID/index value, e.g., among the K_early CSI-RS resource configurations provided/configured for the early triggering of the CSI measurement/reporting, could be used/applied (by the UE) for determining or identifying the CSI-RS resource(s) and the corresponding parameter(s)/setting(s) to receive and measure the (early) triggered CSI-RS(s).

In one example, the higher layer parameter(s)/signaling(s) including SIB1, SIB2, RRCRelease-IEs as specified/defined herein could provide or indicate or comprise one (K_early=1) CSI-RS resource configuration for the early triggering of the CSI measurement/reporting, wherein the CSI-RS resource configuration could be provided by EarlyCSI-ResourceConfig or EarlyCSI-ReportConfig, and could comprise, provide or configure, and/or could be linked/associated/specific to multiple or more than one (L_early>1) CSI resource sets each provided by EarlyCSI-ResourceSet such as EarlyCSI-SSB-CSI-ResourceSet or EarlyNZP-CSI-RS-ResourceSet and comprising, providing or configuring one or more CSI-RS resources each provided by EarlySSB-Index or EarlyNZP-CSI-RS-Resource. For this design example, the one or more second indicators could correspond to or comprise, or could be in form/terms of one or more of:
A bitmap of length L_early with each entry/bit position of the bitmap associated/corresponding/specific to a CSI resource set provided by EarlyCSI-ResourceSet such as EarlyCSI-SSB-CSI-ResourceSet or EarlyNZP-CSI-RS-ResourceSet for the early triggering of the CSI measurement/reporting. In this case, when/if an entry/bit position of the bitmap is set to ‘1’ (or ‘0’), the CSI resource set associated/corresponding/specific to the entry/bit position could be used/applied (by the UE) for determining or identifying the CSI-RS resource(s) and the corresponding parameter(s)/setting(s) to receive and measure the (early) triggered CSI-RS(s). For Option-1, the bitmap could be provided or indicated by a new DCI field in the corresponding DCI format(s).
One or more one-bit flag indicators each associated/corresponding/specific to a CSI resource set provided by EarlyCSI-ResourceSet such as EarlyCSI-SSB-CSI-ResourceSet or EarlyNZP-CSI-RS-ResourceSet for the early triggering of the CSI measurement/reporting. In this case, when/if a one-bit flag indicator is set to ‘1’ (or ‘0’), the CSI resource set associated/corresponding/specific to the one-bit flag indicator could be used/applied (by the UE) for determining or identifying the CSI-RS resource(s) and the corresponding parameter(s)/setting(s) to receive and measure the (early) triggered CSI-RS(s). For Option-1, the one or more one-bit flag indicators could be provided or indicated by one or more new DCI fields in the corresponding DCI format(s).
A x1-bit indicator with x1=┌log₂(L_early)┐: each codepoint/state of the x1-bit indicator could be associated/corresponding/specific to a CSI resource set provided by EarlyCSI-ResourceSet such as EarlyCSI-SSB-CSI-ResourceSet or EarlyNZP-CSI-RS-ResourceSet for the early triggering of the CSI measurement/reporting. In this case, when a codepoint/state of the x1-bit indicator is indicated, the CSI resource set associated/corresponding/specific to the codepoint/state of the x1-bit indicator could be used/applied (by the UE) for determining or identifying the CSI-RS resource(s) and the corresponding parameter(s)/setting(s) to receive and measure the (early) triggered CSI-RS(s). For Option-1, the x1-bit indicator could be provided or indicated by a new DCI field in the corresponding DCI format(s). For instance, the higher layer parameter(s)/signaling(s) including SIB1, SIB2, RRCRelease-IEs as specified/defined herein could provide or indicate or comprise K_early=1 CSI-RS resource configuration comprising or providing or configuring or linked/associated/specific to L_early-4 CSI resource sets for the early triggering of the CSI measurement/reporting, wherein each of the CSI resource sets could be provided by EarlyCSI-ResourceSet such as EarlyCSI-SSB-CSI-ResourceSet or EarlyNZP-CSI-RS-ResourceSet; for this design example, x1=2 with codepoint/state ‘00’ indicating the first CSI resource set or the CSI resource set with the lowest set ID/index value, codepoint/state ‘01’ indicating the second CSI resource set or the CSI resource set with the second lowest set ID/index value, codepoint/state ‘10’ indicating the third CSI resource set or the CSI resource set with the second highest set ID/index value, and codepoint/state ‘11’ indicating the fourth CSI resource set or the CSI resource set with the highest set ID/index value.
One or more CSI resource set IDs/ID values. In this case, the CSI resource set(s) with or having the one or more CSI resource set IDs/ID values could be used/applied (by the UE) for determining or identifying the CSI-RS resource(s) and the corresponding parameter(s)/setting(s) to receive and measure the (early) triggered CSI-RS(s). For Option-1, the one or more CSI resource set IDs/ID values could be provided or indicated by one or more new DCI fields in the corresponding DCI format(s).
One or more indexes or index values denoted by l_1, . . . , l_x with each index or index value belonging to {1, . . . , L_early} or {0, . . . , L_early−1}, i.e., l_1, . . . , l_x∈{1, . . . , L_early} or {0, . . . , L_early−1}. In this case, the l_1-th, . . . , l_x-th CSI resource set(s) among the configured/provided L_early CSI resource sets (e.g., with their resource set IDs/ID values ordered from low to high or from high to low) in the CSI-RS resource configuration could be used/applied (by the UE) for determining or identifying the CSI-RS resource(s) and the corresponding parameter(s)/setting(s) to receive and measure the (early) triggered CSI-RS(s). For Option-1, the one or more indexes or index values could be provided or indicated by one or more new DCI fields in the corresponding DCI format(s).
One or more trigger states each pointing/corresponding to an entry in a list of aperiodic CSI trigger states provided by CSI-AperiodicTriggerStateList. In this case, the CSI resource set(s) corresponding/associated/specific to the one or more trigger states could be used/applied (by the UE) for determining or identifying the CSI-RS resource(s) and the corresponding parameter(s)/setting(s) to receive and measure the (early) triggered CSI-RS(s). For Option-1, the one or more trigger states could be provided or indicated by one or more CSI request fields in the corresponding DCI format(s); optionally, the one or more trigger states could be provided or indicated by one or more new DCI fields in the corresponding DCI format(s).
One or more PRACH preamble indexes. In this case, the higher layer parameter(s)/signaling(s) including SIB1, SIB2, RRCRelease-IEs as specified/defined herein could also provide or indicate or comprise L_early>1 groups of PRACH preambles with each group corresponding/specific to a CSI resource set provided by EarlyCSI-ResourceSet such as EarlyCSI-SSB-CSI-ResourceSet or EarlyNZP-CSI-RS-ResourceSet according to or based on: (1) fixed rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network (e.g., the network 130) via various UL channels/signals e.g. via/in part of beam/CSI report(s) and/or UE's capability signaling(s). For instance, when/if the one or more PRACH preamble indexes indicate that the corresponding PRACH preambles are from the x-th group of PRACH preambles (x∈{1, . . . , L_early} or {0, . . . , L_early−1}), the x-th CSI resource set among the configured/provided L_early CSI resource sets (e.g., with their resource set IDs/ID values ordered from low to high or from high to low) could be used/applied (by the UE) for determining or identifying the CSI-RS resource(s) and the corresponding parameter(s)/setting(s) to receive and measure the (early) triggered CSI-RS(s). For Option-1, the one or more PRACH preamble indexes could be provided or indicated by one or more new DCI fields in the corresponding DCI format(s).
One or more subgroup indexes of a PO. In this case, the higher layer parameter(s)/signaling(s) including SIB1, SIB2, RRCRelease-IEs as specified/defined herein could also provide or indicate or comprise the L_early>1 subgroups of a PO such that each subgroup of the PO could be associated/corresponding/specific to a CSI resource set provided by EarlyCSI-ResourceSet such as EarlyCSI-SSB-CSI-ResourceSet or EarlyNZP-CSI-RS-ResourceSet according to or based on: (1) fixed rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). For instance, when/if the one or more subgroup indexes of the PO comprises the x-th subgroup of the PO (x∈{1, . . . , L_early} or {0, . . . , L_early−1}), the x-th CSI resource set among the configured/provided L_early CSI resource sets (e.g., with their resource set IDs/ID values ordered from low to high or from high to low) could be used/applied (by the UE) for determining or identifying the CSI-RS resource(s) and the corresponding parameter(s)/setting(s) to receive and measure the (early) triggered CSI-RS(s). For Option-1, the one or more subgroup indexes of the PO could be provided or indicated by one or more new DCI fields in the corresponding DCI format(s).
Information related to one or more CSI resource sets. The UE could determine or identify the association(s)/mapping(s) between the information and the one or more CSI resource sets according to or based on: (1) fixed rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). In this case, the one or more CSI resource sets corresponding/associated/specific to the information could be used/applied (by the UE) for determining or identifying the CSI-RS resource(s) and the corresponding parameter(s)/setting(s) to receive and measure the (early) triggered CSI-RS(s). The information could comprise one or more of: one or more UE IDs, time (including number(s) of slot(s)/symbol(s)/etc., starting slot/symbol/etc., and/or ending slot/symbol/etc.) and/or frequency (including number(s) of PRB(s)/etc., starting PRB/etc., and/or ending PRB/etc.) domain resource(s), a mapping between the one or more UE IDs and the L_early CSI resource sets, a mapping between the resources used for the PDCCH providing the DCI format (e.g., time and/or frequency resources, e.g., (e.g., starting) channel control elements (CCEs) or (e.g., starting) resource element groups (REGs) or (e.g., starting) resource blocks (RBs) or (e.g., starting) symbols or slots or subframes or frames etc.) and the L_early CSI resource sets, a mapping between the one or more UE IDs and resources used for reception of the PDCCH providing the DCI format as mentioned herein, and the L_early CSI resource sets and/or etc. For Option-1, the information could be provided or indicated by one or more new DCI fields in the corresponding DCI format(s).

When/if the second indicator(s) is absent or not present in the corresponding first triggering channel(s)/signal(s) according to or following those specified herein in the present disclosure, the UE could determine the CSI resource set(s), and therefore the corresponding CSI-RS resource(s) along with its associated parameter(s)/setting(s), to use/apply for receiving and measuring the (early) triggered CSI-RS(s) according to or based on fixed rule(s) in system specification(s) and/or per RRC (re-)configuration/setup. In this case, for example, the L_early CSI resource sets provided/configured in the CSI-RS resource configuration for the early triggering of the CSI measurement/reporting could be used/applied (by the UE) for determining or identifying the CSI-RS resource(s) and the corresponding parameter(s)/setting(s) to receive and measure the (early) triggered CSI-RS(s); for another example, the first (or last) CSI resource set or the CSI resource set with the lowest (or highest) set ID/index value, e.g., among the L_early CSI resource sets provided/configured for the early triggering of the CSI measurement/reporting, could be used/applied (by the UE) for determining or identifying the CSI-RS resource(s) and the corresponding parameter(s)/setting(s) to receive and measure the (early) triggered CSI-RS(s).

In one example, the higher layer parameter(s)/signaling(s) including SIB1, SIB2, RRCRelease-IEs as specified/defined herein could provide or indicate or comprise one (K_early=1) CSI-RS resource configuration for the early triggering of the CSI measurement/reporting, wherein the CSI-RS resource configuration could be provided by EarlyCSI-ResourceConfig or EarlyCSI-ReportConfig, and could comprise, provide or configure, and/or could be linked/associated/specific to one (L_early=1) CSI resource set provided by EarlyCSI-ResourceSet such as EarlyCSI-SSB-CSI-ResourceSet or EarlyNZP-CSI-RS-ResourceSet and comprising, providing or configuring multiple or more than one (N_early>1) CSI-RS resources each provided by EarlySSB-Index or EarlyNZP-CSI-RS-Resource. For this design example, the one or more second indicators could correspond to or comprise, or could be in form/terms of one or more of:
A bitmap of length N_early with each entry/bit position of the bitmap associated/corresponding/specific to a CSI-RS resource provided by EarlySSB-Index or EarlyNZP-CSI-RS-Resource for the early triggering of the CSI measurement/reporting. In this case, when/if an entry/bit position of the bitmap is set to ‘1’ (or ‘0’), the CSI-RS resource associated/corresponding/specific to the entry/bit position could be used/applied (by the UE) for determining or identifying the CSI-RS resource(s) and the corresponding parameter(s)/setting(s) to receive and measure the (early) triggered CSI-RS(s). For Option-1, the bitmap could be provided or indicated by a new DCI field in the corresponding DCI format(s).
One or more one-bit flag indicators each associated/corresponding/specific to a CSI-RS resource provided by EarlySSB-Index or EarlyNZP-CSI-RS-Resource for the early triggering of the CSI measurement/reporting. In this case, when/if a one-bit flag indicator is set to ‘1’ (or ‘0’), the CSI-RS resource associated/corresponding/specific to the one-bit flag indicator could be used/applied (by the UE) for determining or identifying the CSI-RS resource(s) and the corresponding parameter(s)/setting(s) to receive and measure the (early) triggered CSI-RS(s). For Option-1, the one or more one-bit flag indicators could be provided or indicated by one or more new DCI fields in the corresponding DCI format(s).
A x2-bit indicator with x2=┌log₂(N_early)┐: each codepoint/state of the x2-bit indicator could be associated/corresponding/specific to a CSI-RS resource provided by EarlySSB-Index or EarlyNZP-CSI-RS-Resource for the early triggering of the CSI measurement/reporting. In this case, when a codepoint/state of the x2-bit indicator is indicated, the CSI-RS resource associated/corresponding/specific to the codepoint/state of the x2-bit indicator could be used/applied (by the UE) for determining or identifying the CSI-RS resource(s) and the corresponding parameter(s)/setting(s) to receive and measure the (early) triggered CSI-RS(s). For Option-1, the x2-bit indicator could be provided or indicated by a new DCI field in the corresponding DCI format(s). For instance, the higher layer parameter(s)/signaling(s) including SIB1, SIB2, RRCRelease-IEs as specified/defined herein could provide or indicate or comprise K_early=1 CSI-RS resource configuration comprising or providing or configuring or linked/associated/specific to L_early=1 CSI resource set comprising or providing or configuring N_early>1 CSI-RS resources for the early triggering of the CSI measurement/reporting, wherein each of the CSI-RS resources could be provided by EarlySSB-Index or EarlyNZP-CSI-RS-Resource; for this design example, x2=2 with codepoint/state ‘00’ indicating the first CSI-RS resource or the CSI-RS resource with the lowest resource ID/index value, codepoint/state ‘01’ indicating the second CSI-RS resource or the CSI-RS resource with the second lowest resource ID/index value, codepoint/state ‘10’ indicating the third CSI-RS resource or the CSI-RS resource with the second highest resource ID/index value, and codepoint/state ‘11’ indicating the fourth CSI-RS resource or the CSI-RS resource with the highest resource ID/index value.
One or more CSI-RS resource IDs/ID values. In this case, the CSI-RS resource(s) with or having the one or more CSI-RS resource IDs/ID values could be used/applied (by the UE) for determining or identifying the CSI-RS resource(s) and the corresponding parameter(s)/setting(s) to receive and measure the (early) triggered CSI-RS(s). For Option-1, the one or more CSI-RS resource IDs/ID values could be provided or indicated by one or more new DCI fields in the corresponding DCI format(s).
One or more indexes or index values denoted by n_1, . . . , n_x with each index or index value belonging to {1, . . . , N_early} or {0, . . . , N_early−1}, i.e., n_1, . . . , n_x∈{1, . . . , N_early} or {0, . . . , N_early−1}. In this case, the n_1-th, . . . , n_x-th CSI-RS resource(s) among the configured/provided N_early CSI-RS resources (e.g., with their resource IDs/ID values ordered from low to high or from high to low) in the CSI resource set/configuration could be used/applied (by the UE) for determining or identifying the CSI-RS resource(s) and the corresponding parameter(s)/setting(s) to receive and measure the (early) triggered CSI-RS(s). For Option-1, the one or more indexes or index values could be provided or indicated by one or more new DCI fields in the corresponding DCI format(s).
One or more trigger states each pointing/corresponding to an entry in a list of aperiodic CSI-RS resource trigger states provided by CSI-AperiodicTriggerStateList. In this case, the CSI-RS resource(s) corresponding/associated/specific to the one or more trigger states could be used/applied (by the UE) for determining or identifying the CSI-RS resource(s) and the corresponding parameter(s)/setting(s) to receive and measure the (early) triggered CSI-RS(s). For Option-1, the one or more trigger states could be provided or indicated by one or more CSI request fields in the corresponding DCI format(s); optionally, the one or more trigger states could be provided or indicated by one or more new DCI fields in the corresponding DCI format(s).
One or more PRACH preamble indexes. In this case, the higher layer parameter(s)/signaling(s) including SIB1, SIB2, RRCRelease-IEs as specified/defined herein could also provide or indicate or comprise N_early>1 groups of PRACH preambles with each group corresponding/specific to a CSI-RS resource provided by EarlySSB-Index or EarlyNZP-CSI-RS-Resource according to or based on: (1) fixed rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). For instance, when/if the one or more PRACH preamble indexes indicate that the corresponding PRACH preambles are from the x-th group of PRACH preambles (x∈{1, . . . , N_early} or {0, . . . , N_early−1}), the x-th CSI-RS resource among the configured/provided N_early CSI-RS resources (e.g., with their resource IDs/ID values ordered from low to high or from high to low) could be used/applied (by the UE) for determining or identifying the CSI-RS resource(s) and the corresponding parameter(s)/setting(s) to receive and measure the (early) triggered CSI-RS(s). For Option-1, the one or more PRACH preamble indexes could be provided or indicated by one or more new DCI fields in the corresponding DCI format(s).
One or more subgroup indexes of a PO. In this case, the higher layer parameter(s)/signaling(s) including SIB1, SIB2, RRCRelease-IEs as specified/defined herein could also provide or indicate or comprise the N_early>1 subgroups of a PO such that each subgroup of the PO could be associated/corresponding/specific to a CSI-RS resource provided by EarlySSB-Index or EarlyNZP-CSI-RS-Resource according to or based on: (1) fixed rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). For instance, when/if the one or more subgroup indexes of the PO comprises the x-th subgroup of the PO (x∈{1, . . . , N_early} or {0, . . . , N_early−1}), the x-th CSI-RS resource among the configured/provided N_early CSI-RS resources (e.g., with their resource IDs/ID values ordered from low to high or from high to low) could be used/applied (by the UE) for determining or identifying the CSI-RS resource(s) and the corresponding parameter(s)/setting(s) to receive and measure the (early) triggered CSI-RS(s). For Option-1, the one or more subgroup indexes of the PO could be provided or indicated by one or more new DCI fields in the corresponding DCI format(s).
Information related to one or more CSI-RS resources. The UE could determine or identify the association(s)/mapping(s) between the information and the one or more CSI-RS resources according to or based on: (1) fixed rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). In this case, the one or more CSI-RS resources corresponding/associated/specific to the information could be used/applied (by the UE) for determining or identifying the CSI-RS resource(s) and the corresponding parameter(s)/setting(s) to receive and measure the (early) triggered CSI-RS(s). The information could comprise one or more of: one or more UE IDs, time (including number(s) of slot(s)/symbol(s)/etc., starting slot/symbol/etc., and/or ending slot/symbol/etc.) and/or frequency (including number(s) of PRB(s)/etc., starting PRB/etc., and/or ending PRB/etc.) domain resource(s), a mapping between the one or more UE IDs and the N_early CSI-RS resources, a mapping between the resources used for the PDCCH providing the DCI format (e.g., time and/or frequency resources, e.g., (e.g., starting) channel control elements (CCEs) or (e.g., starting) resource element groups (REGs) or (e.g., starting) resource blocks (RBs) or (e.g., starting) symbols or slots or subframes or frames etc.) and the N_early CSI-RS resources, a mapping between the one or more UE IDs and resources used for reception of the PDCCH providing the DCI format as mentioned herein, and the N_early CSI-RS resources, and/or etc. For Option-1, the information could be provided or indicated by one or more new DCI fields in the corresponding DCI format(s).

When/if the second indicator(s) is absent or not present in the corresponding first triggering channel(s)/signal(s) according to or following those specified herein in the present disclosure, the UE could determine the CSI-RS resource(s), and therefore the corresponding parameter(s)/setting(s), to use/apply for receiving and measuring the (early) triggered CSI-RS(s) according to or based on fixed rule(s) in system specification(s) and/or per RRC (re-)configuration/setup. In this case, for example, the N_early CSI-RS resources provided/configured in the CSI resource set/configuration for the early triggering of the CSI measurement/reporting could be used/applied (by the UE) for determining or identifying the CSI-RS resource(s) and the corresponding parameter(s)/setting(s) to receive and measure the (early) triggered CSI-RS(s); for another example, the first (or last) CSI-RS resource or the CSI-RS resource with the lowest (or highest) resource ID/index value, e.g., among the N_early CSI-RS resources provided/configured for the early triggering of the CSI measurement/reporting, could be used/applied (by the UE) for determining or identifying the CSI-RS resource(s) and the corresponding parameter(s)/setting(s) to receive and measure the (early) triggered CSI-RS(s).

Optionally, the UE (e.g., the UE 116) could autonomously determine or identify or select which one or more of the configured/provided CSI-RS resource configurations (and therefore, the corresponding/linked/associated CSI resource set(s)/CSI-RS resource(s), e.g., provided/configured therein) for the early triggering of the CSI measurement/reporting as specified/defined herein in the present disclosure, which one or more of the configured/provided CSI resource sets (and therefore, the corresponding CSI-RS resource(s) provided/configured therein) for the early triggering of the CSI measurement/reporting as specified/defined herein in the present disclosure, and/or which one or more of the configured/provided CSI-RS resources for the early triggering of the CSI measurement/reporting as specified/defined herein in the present disclosure, to use/apply for determining or identifying the CSI-RS resource(s) and the corresponding parameter(s)/setting(s) to receive and measure the (early) triggered CSI-RS(s). The UE could be indicated or provided or configured by the network, e.g., via higher layer RRC signaling(s)/parameter(s) and/or MAC CE command(s) and/or dynamic DCI based L1 signaling(s) based on or according to a corresponding UE's capability or capability signaling, whether or not the UE could autonomously determine, identify or select the CSI-RS resource(s)—and therefore the corresponding parameter(s)/setting(s)—to receive and measure the (early) triggered CSI-RS(s); for instance, when/if the UE is provided or configured by the network a higher layer parameter ueSelectCSI-RS-Resource and/or set to ‘enabled’ based on or according to a corresponding UE's capability/capability signaling, the UE could autonomously determine or identify or select the CSI-RS resource(s) for the early triggering of the CSI measurement/reporting as specified/defined herein in the present disclosure. Optionally, when/if the second indicator(s) as specified/defined herein in the present disclosure is absent or not present in the corresponding first triggering channel(s)/signal(s) according to or following those specified herein in the present disclosure, the UE could autonomously determine or identify or select the CSI-RS resource(s) for the early triggering of the CSI measurement/reporting as specified/defined herein in the present disclosure. In this case, the UE could transmit or send to the network, in/via/by one or more third channels/signals, one or more third indicators to indicate their autonomous determination, identification or selection of the CSI-RS resource(s) for the early triggering of the CSI measurement/reporting as specified/defined herein. In the present disclosure, the UE could determine or identify the one or more third channels/signals based on or according to:
In one example, the one or more third channels/signals could correspond to or could be associated/specific to one or more PUSCH(s) or PUSCH resource(s) scheduled or activated by a DCI format(s), wherein the DCI format(s) could correspond to the one or more first triggering channels/signals as specified/defined in Option-1 in the present disclosure.
In another example, the third channel(s)/signal(s) could correspond to the UL channel(s)/signal(s) including PUCCH(s)/PUSCH(s)/PRACH(s)/CSI-RS(s) and/or etc. corresponding/associated/specific to the higher layer message(s) as specified/defined in Option-2 in the present disclosure. For instance, the UL channel(s)/signal(s) herein could be associated with or after a PRACH preamble transmission as indicated or configured or provided by the higher layer message(s) as specified/defined in Option-2 in the present disclosure. Optionally, the UL channel(s)/signal(s) herein could be associated with or after a RACH scheduled transmission or a Msg3 as indicated or configured or provided by the higher layer message(s) as specified/defined in Option-2 in the present disclosure. Furthermore, the UL channel(s)/signal(s) herein could be associated with or after a MsgA as indicated or configured or provided by the higher layer message(s) as specified/defined in Option-2 in the present disclosure.
In another example, the third channel(s)/signal(s) could correspond to the UL channel(s)/signal(s) including PUCCH(s)/PUSCH(s)/PRACH(s)/CSI-RS(s) and/or etc. corresponding/associated/specific to the PEI(s) or paging message(s), e.g., corresponding to/for one or more POs, as specified/defined in Option-3 in the present disclosure. For instance, the UL channel(s)/signal(s) herein could be associated with or after a PRACH preamble transmission as indicated or configured or provided by the PEI(s)/paging message(s) as specified/defined in Option-3 in the present disclosure. Optionally, the UL channel(s)/signal(s) herein could be associated with or after a RACH scheduled transmission or a Msg3 as indicated or configured or provided by the PEI(s)/paging message(s) as specified/defined in Option-3 in the present disclosure. Furthermore, the UL channel(s)/signal(s) herein could be associated with or after a MsgA as indicated or configured or provided by the PEI(s)/paging message(s) as specified/defined in Option-3 in the present disclosure.
In another example, the third channel(s)/signal(s) could correspond to or could be associated/specific to a PRACH transmission—e.g., Msg1; in this case, a PRACH preamble of Msg1 could also indicate the one or more third indicators as specified/defined herein in the present disclosure. Alternatively, the third channel(s)/signal(s) could correspond to or could be associated/specific to a RACH scheduled transmission—e.g., Msg3; in this case, the PUSCH transmission providing Msg3 could also include, comprise, carry or convey the one or more third indicators as specified/defined herein in the present disclosure. Optionally, the third channel(s)/signal(s) could correspond to or could be associated/specific to a MsgA of Type-2 random access procedure; in this case, the PRACH or PUSCH transmission providing MsgA could also include, comprise, carry or convey the one or more third indicators as specified/defined herein in the present disclosure. In addition, the third channel(s)/signal(s) could correspond to the UL channel(s)/signal(s) including PUCCH(s)/PUSCH(s)/PRACH(s)/CSI-RS(s) and/or etc. associated with or after a RACH scheduled transmission or a Msg3 as indicated or configured or provided by the RAR as specified/defined in Option-4 in the present disclosure.

In one example, the higher layer parameter(s)/signaling(s) including SIB1, SIB2, RRCRelease-IEs as specified/defined herein could provide or indicate or comprise multiple or more than one (K_early>1) CSI-RS resource configurations for the early triggering of the CSI measurement/reporting, wherein each of the CSI-RS resource configurations could be provided by EarlyCSI-ResourceConfig or EarlyCSI-ReportConfig, and could comprise or provide or include or configure, and/or could be linked/associated/specific to one or more CSI resource sets each provided by EarlyCSI-ResourceSet such as EarlyCSI-SSB-CSI-ResourceSet or EarlyNZP-CSI-RS-ResourceSet and comprising, providing or configuring one or more CSI-RS resources each provided by EarlySSB-Index or EarlyNZP-CSI-RS-Resource. For this design example, the one or more third indicators could correspond to or comprise, or could be in form/terms of one or more of:
A bitmap of length K_early with each entry/bit position of the bitmap associated/corresponding/specific to a CSI-RS resource configuration provided by EarlyCSI-ResourceConfig or EarlyCSI-ReportConfig for the early triggering of the CSI measurement/reporting. In this case, when/if an entry/bit position of the bitmap is set to ‘1’ (or ‘0’), the UE could indicate to the network that the CSI-RS resource configuration associated/corresponding/specific to the entry/bit position could be used/applied (by the UE) for determining or identifying the CSI-RS resource(s) and the corresponding parameter(s)/setting(s) to receive and measure the (early) triggered CSI-RS(s).
One or more one-bit flag indicators each associated/corresponding/specific to a CSI-RS resource configuration provided by EarlyCSI-ResourceConfig or EarlyCSI-ReportConfig for the early triggering of the CSI measurement/reporting. In this case, when/if a one-bit flag indicator is set to ‘1’ (or ‘0’), the UE could indicate to the network that the CSI-RS resource configuration associated/corresponding/specific to the one-bit flag indicator could be used/applied (by the UE) for determining or identifying the CSI-RS resource(s) and the corresponding parameter(s)/setting(s) to receive and measure the (early) triggered CSI-RS(s).
A y0-bit indicator with y0=┌log₂(K_early)┐: each codepoint/state of the y0-bit indicator could be associated/corresponding/specific to a CSI-RS resource configuration provided by EarlyCSI-ResourceConfig or EarlyCSI-ReportConfig for the early triggering of the CSI measurement/reporting. In this case, when a codepoint/state of the y0-bit indicator is indicated, the UE could indicate to the network that the CSI-RS resource configuration associated/corresponding/specific to the codepoint/state of the y0-bit indicator could be used/applied (by the UE) for determining or identifying the CSI-RS resource(s) and the corresponding parameter(s)/setting(s) to receive and measure the (early) triggered CSI-RS(s). For instance, the higher layer parameter(s)/signaling(s) including SIB1, SIB2, RRCRelease-IEs as specified/defined herein could provide or indicate or comprise K_early=4 CSI-RS resource configurations for the early triggering of the CSI measurement/reporting, wherein each of the CSI-RS resource configurations could be provided by EarlyCSI-ResourceConfig or EarlyCSI-ReportConfig; for this design example, y0=2 with codepoint/state ‘00’ indicating the first CSI-RS resource configuration or the CSI-RS resource configuration with the lowest configuration ID/index value, codepoint/state ‘01’ indicating the second CSI-RS resource configuration or the CSI-RS resource configuration with the second lowest configuration ID/index value, codepoint/state ‘10’ indicating the third CSI-RS resource configuration or the CSI-RS resource configuration with the second highest configuration ID/index value, and codepoint/state ‘11’ indicating the fourth CSI-RS resource configuration or the CSI-RS resource configuration with the highest configuration ID/index value.
One or more CSI-RS resource configuration IDs/ID values. In this case, the UE could indicate to the network (e.g., the network 130) that the CSI-RS resource configuration(s) with or having the one or more CSI-RS resource configuration IDs/ID values could be used/applied (by the UE) for determining or identifying the CSI-RS resource(s) and the corresponding parameter(s)/setting(s) to receive and measure the (early) triggered CSI-RS(s).
One or more indexes or index values denoted by k_1, . . . , k_y with each index or index value belonging to {1, . . . , K_early} or {0, . . . , K_early−1}, i.e., k_1, . . . , k_y∈{1, . . . , K_early} or {0, . . . , K_early−1}. In this case, the UE could indicate to the network that the k_1-th, . . . , k_y-th CSI-RS resource configuration(s) among the configured/provided K_early CSI-RS resource configurations (e.g., with their resource configuration IDs/ID values ordered from low to high or from high to low) could be used/applied (by the UE) for determining or identifying the CSI-RS resource(s) and the corresponding parameter(s)/setting(s) to receive and measure the (early) triggered CSI-RS(s).
One or more trigger states each pointing/corresponding to an entry in a list of aperiodic CSI trigger states provided by CSI-AperiodicTriggerStateList. In this case, the UE could indicate to the network that the CSI-RS resource configuration(s) corresponding/associated/specific to the one or more trigger states could be used/applied (by the UE) for determining or identifying the CSI-RS resource(s) and the corresponding parameter(s)/setting(s) to receive and measure the (early) triggered CSI-RS(s).
One or more PRACH preambles. In this case, the higher layer parameter(s)/signaling(s) including SIB1, SIB2, RRCRelease-IEs as specified/defined herein could also provide or indicate or comprise K_early>1 groups of PRACH preambles with each group corresponding/specific to a CSI-RS resource configuration provided by EarlyCSI-ResourceConfig or EarlyCSI-ReportConfig according to or based on: (1) fixed rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). When/if the one or more PRACH preambles are from the y-th group of PRACH preambles (y∈{1, . . . , K_early} or {0, . . . , K_early−1}), the UE could indicate to the network that the y-th CSI-RS resource configuration among the configured/provided K_early CSI-RS resource configurations (e.g., with their resource configuration IDs/ID values ordered from low to high or from high to low) could be used/applied (by the UE) for determining or identifying the CSI-RS resource(s) and the corresponding parameter(s)/setting(s) to receive and measure the (early) triggered CSI-RS(s).
One or more subgroup indexes of a PO. In this case, the higher layer parameter(s)/signaling(s) including SIB1, SIB2, RRCRelease-IEs as specified/defined herein could also provide or indicate or comprise the K_early>1 subgroups of a PO such that each subgroup of the PO could be associated/corresponding/specific to a CSI-RS resource configuration provided by EarlyCSI-ResourceConfig or EarlyCSI-ReportConfig according to or based on: (1) fixed rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). For instance, when/if the one or more subgroup indexes of the PO comprises the y-th subgroup of the PO (y∈{1, . . . , K_early} or {0, . . . , K_early−1}), the UE could indicate to the network that the y-th CSI-RS resource configuration among the configured/provided K_early CSI-RS resource configurations (e.g., with their resource configuration IDs/ID values ordered from low to high or from high to low) could be used/applied (by the UE) for determining or identifying the CSI-RS resource(s) and the corresponding parameter(s)/setting(s) to receive and measure the (early) triggered CSI-RS(s).
Information related to one or more CSI-RS resource configurations. The UE could determine or identify the association(s)/mapping(s) between the information and the one or more CSI-RS resource configurations according to or based on: (1) fixed rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). In this case, the UE could indicate to the network that the one or more CSI-RS resource configurations corresponding/associated/specific to the information could be used/applied (by the UE) for determining or identifying the CSI-RS resource(s) and the corresponding parameter(s)/setting(s) to receive and measure the (early) triggered CSI-RS(s). The information could comprise one or more of: one or more UE IDs, time (including number(s) of slot(s)/symbol(s)/etc., starting slot/symbol/etc., and/or ending slot/symbol/etc.) and/or frequency (including number(s) of PRB(s)/etc., starting PRB/etc., and/or ending PRB/etc.) domain resource(s), a mapping between the one or more UE IDs and the K_early CSI-RS resource configurations, a mapping between the resources used for the PDCCH providing the DCI format (e.g., time and/or frequency resources, e.g., (e.g., starting) channel control elements (CCEs) or (e.g., starting) resource element groups (REGs) or (e.g., starting) resource blocks (RBs) or (e.g., starting) symbols or slots or subframes or frames etc.) and the K_early CSI-RS resource configurations, a mapping between the one or more UE IDs and resources used for reception of the PDCCH providing the DCI format as mentioned herein, and the K_early CSI-RS resource configurations and/or etc.

In one example, the higher layer parameter(s)/signaling(s) including SIB1, SIB2, RRCRelease-IEs as specified/defined herein could provide or indicate or comprise one (K_early=1) CSI-RS resource configuration for the early triggering of the CSI measurement/reporting, wherein the CSI-RS resource configuration could be provided by EarlyCSI-ResourceConfig or EarlyCSI-ReportConfig, and could comprise, provide or configure, and/or could be associated/linked/specific to multiple or more than one (L_early>1) CSI resource sets each provided by EarlyCSI-ResourceSet such as EarlyCSI-SSB-CSI-ResourceSet or EarlyNZP-CSI-RS-ResourceSet and comprising, providing or configuring one or more CSI-RS resources each provided by EarlySSB-Index or EarlyNZP-CSI-RS-Resource. For this design example, the one or more third indicators could correspond to or comprise, or could be in form/terms of one or more of:
A bitmap of length L_early with each entry/bit position of the bitmap associated/corresponding/specific to a CSI resource set provided by EarlyCSI-ResourceSet such as EarlyCSI-SSB-CSI-ResourceSet or EarlyNZP-CSI-RS-ResourceSet for the early triggering of the CSI measurement/reporting. In this case, when/if an entry/bit position of the bitmap is set to ‘1’ (or ‘0’), the UE could indicate to the network that the CSI resource set associated/corresponding/specific to the entry/bit position could be used/applied (by the UE) for determining or identifying the CSI-RS resource(s) and the corresponding parameter(s)/setting(s) to receive and measure the (early) triggered CSI-RS(s).
One or more one-bit flag indicators each associated/corresponding/specific to a CSI resource set provided by EarlyCSI-ResourceSet such as EarlyCSI-SSB-CSI-ResourceSet or EarlyNZP-CSI-RS-ResourceSet for the early triggering of the CSI measurement/reporting. In this case, when/if a one-bit flag indicator is set to ‘1’ (or ‘0’), the UE could indicate to the network that the CSI resource set associated/corresponding/specific to the one-bit flag indicator could be used/applied (by the UE) for determining or identifying the CSI-RS resource(s) and the corresponding parameter(s)/setting(s) to receive and measure the (early) triggered CSI-RS(s).
A y1-bit indicator with y1=┌log₂(L_early)┐: each codepoint/state of the y1-bit indicator could be associated/corresponding/specific to a CSI resource set provided by EarlyCSI-ResourceSet such as EarlyCSI-SSB-CSI-ResourceSet or EarlyNZP-CSI-RS-ResourceSet for the early triggering of the CSI measurement/reporting. In this case, when a codepoint/state of the y1-bit indicator is indicated, the UE could indicate to the network that the CSI resource set associated/corresponding/specific to the codepoint/state of the y1-bit indicator could be used/applied (by the UE) for determining or identifying the CSI-RS resource(s) and the corresponding parameter(s)/setting(s) to receive and measure the (early) triggered CSI-RS(s). For instance, the higher layer parameter(s)/signaling(s) including SIB1, SIB2, RRCRelease-IEs as specified/defined herein could provide or indicate or comprise K_early=1 CSI-RS resource configuration comprising or providing or configuring or linked/associated/specific to L_early=4 CSI resource sets for the early triggering of the CSI measurement/reporting, wherein each of the CSI resource sets could be provided by EarlyCSI-ResourceSet such as EarlyCSI-SSB-CSI-ResourceSet or EarlyNZP-CSI-RS-ResourceSet; for this design example, y1=2 with codepoint/state ‘00’ indicating the first CSI resource set or the CSI resource set with the lowest set ID/index value, codepoint/state ‘01’ indicating the second CSI resource set or the CSI resource set with the second lowest set ID/index value, codepoint/state ‘10’ indicating the third CSI resource set or the CSI resource set with the second highest set ID/index value, and codepoint/state ‘11’ indicating the fourth CSI resource set or the CSI resource set with the highest set ID/index value.
One or more CSI resource set IDs/ID values. In this case, the UE could indicate to the network that the CSI resource set(s) with or having the one or more CSI resource set IDs/ID values could be used/applied (by the UE) for determining or identifying the CSI-RS resource(s) and the corresponding parameter(s)/setting(s) to receive and measure the (early) triggered CSI-RS(s).
One or more indexes or index values denoted by l_1, . . . , l_y with each index or index value belonging to {1, . . . , L_early} or {0, . . . , L_early−1}, i.e., l_1, . . . , l_y∈{1, . . . , L_early} or {0, . . . , L_early−1}. In this case, the UE could indicate to the network that the l_1-th, . . . , l_y-th CSI resource set(s) among the configured/provided L_early CSI resource sets (e.g., with their resource set IDs/ID values ordered from low to high or from high to low) in the CSI-RS resource configuration could be used/applied (by the UE) for determining or identifying the CSI-RS resource(s) and the corresponding parameter(s)/setting(s) to receive and measure the (early) triggered CSI-RS(s).
One or more trigger states each pointing/corresponding to an entry in a list of aperiodic CSI-RS resource trigger states provided by aperiodicCSI-RS-ResourceTrigger or aperiodicCSI-RS-ResourceTriggerList. In this case, the UE could indicate to the network that the CSI resource set(s) corresponding/associated/specific to the one or more trigger states could be used/applied (by the UE) for determining or identifying the CSI-RS resource(s) and the corresponding parameter(s)/setting(s) to receive and measure the (early) triggered CSI-RS(s).
One or more PRACH preambles. In this case, the higher layer parameter(s)/signaling(s) including SIB1, SIB2, RRCRelease-IEs as specified/defined herein could also provide or indicate or comprise L_early>1 groups of PRACH preambles with each group corresponding/specific to a CSI resource set provided by EarlyCSI-ResourceSet such as EarlyCSI-SSB-CSI-ResourceSet or EarlyNZP-CSI-RS-ResourceSet according to or based on: (1) fixed rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). When/if the one or more PRACH preambles are from the y-th group of PRACH preambles (y∈{1, . . . , L_early} or {0, . . . , L_early−1}), the UE could indicate to the network that the y-th CSI resource set among the configured/provided L_early CSI resource sets (e.g., with their resource set IDs/ID values ordered from low to high or from high to low) could be used/applied (by the UE) for determining or identifying the CSI-RS resource(s) and the corresponding parameter(s)/setting(s) to receive and measure the (early) triggered CSI-RS(s).
One or more subgroup indexes of a PO. In this case, the higher layer parameter(s)/signaling(s) including SIB1, SIB2, RRCRelease-IEs as specified/defined herein could also provide or indicate or comprise the L_early>1 subgroups of a PO such that each subgroup of the PO could be associated/corresponding/specific to a CSI resource set provided by EarlyCSI-ResourceSet such as EarlyCSI-SSB-CSI-ResourceSet or EarlyNZP-CSI-RS-ResourceSet according to or based on: (1) fixed rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). For instance, when/if the one or more subgroup indexes of the PO comprises the y-th subgroup of the PO (y∈{1, . . . , L_early} or {0, . . . , L_early−1}), the UE could indicate to the network that the y-th CSI resource set among the configured/provided L_early CSI resource sets (e.g., with their resource set IDs/ID values ordered from low to high or from high to low) could be used/applied (by the UE) for determining or identifying the CSI-RS resource(s) and the corresponding parameter(s)/setting(s) to receive and measure the (early) triggered CSI-RS(s).
Information related to one or more CSI resource sets. The UE could determine or identify the association(s)/mapping(s) between the information and the one or more CSI resource sets according to or based on: (1) fixed rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). In this case, the UE could indicate to the network that the one or more CSI resource sets corresponding/associated/specific to the information could be used/applied (by the UE) for determining or identifying the CSI-RS resource(s) and the corresponding parameter(s)/setting(s) to receive and measure the (early) triggered CSI-RS(s). The information could comprise one or more of: one or more UE IDs, time (including number(s) of slot(s)/symbol(s)/etc., starting slot/symbol/etc., and/or ending slot/symbol/etc.) and/or frequency (including number(s) of PRB(s)/etc., starting PRB/etc., and/or ending PRB/etc.) domain resource(s), a mapping between the one or more UE IDs and the L_early CSI resource sets, a mapping between the resources used for the PDCCH providing the DCI format (e.g., time and/or frequency resources, e.g., (e.g., starting) channel control elements (CCEs) or (e.g., starting) resource element groups (REGs) or (e.g., starting) resource blocks (RBs) or (e.g., starting) symbols or slots or subframes or frames etc.) and the L_early CSI resource sets, a mapping between the one or more UE IDs and resources used for reception of the PDCCH providing the DCI format as mentioned herein, and the L_early CSI resource sets and/or etc.

In one example, the higher layer parameter(s)/signaling(s) including SIB1, SIB2, RRCRelease-IEs as specified/defined herein could provide or indicate or comprise one (K_early=1) CSI-RS resource configuration for the early triggering of the CSI measurement/reporting, wherein the CSI-RS resource configuration could be provided by EarlyCSI-ResourceConfig or EarlyCSI-ReportConfig, and could comprise, provide or configure, and/or could be linked/associated/specific to one (L_early=1) CSI resource set provided by EarlyCSI-ResourceSet such as EarlyCSI-SSB-CSI-ResourceSet or EarlyNZP-CSI-RS-ResourceSet and comprising, providing or configuring multiple or more than one (N_early>1) CSI-RS resources each provided by EarlySSB-Index or EarlyNZP-CSI-RS-Resource. For this design example, the one or more third indicators could correspond to or comprise, or could be in form/terms of one or more of:
A bitmap of length N_early with each entry/bit position of the bitmap associated/corresponding/specific to a CSI-RS resource provided by EarlySSB-Index or EarlyNZP-CSI-RS-Resource for the early triggering of the CSI measurement/reporting. In this case, when/if an entry/bit position of the bitmap is set to ‘1’ (or ‘0’), the UE (e.g., the UE 116) could indicate to the network that the CSI-RS resource associated/corresponding/specific to the entry/bit position could be used/applied (by the UE) for determining or identifying the CSI-RS resource(s) and the corresponding parameter(s)/setting(s) to receive and measure the (early) triggered CSI-RS(s).
One or more one-bit flag indicators each associated/corresponding/specific to a CSI-RS resource provided by EarlySSB-Index or EarlyNZP-CSI-RS-Resource for the early triggering of the CSI measurement/reporting. In this case, when/if a one-bit flag indicator is set to ‘1’ (or ‘0’), the UE could indicate to the network that the CSI-RS resource associated/corresponding/specific to the one-bit flag indicator could be used/applied (by the UE) for determining or identifying the CSI-RS resource(s) and the corresponding parameter(s)/setting(s) to receive and measure the (early) triggered CSI-RS(s).
A y2-bit indicator with y2=┌log₂(N_early)┐: each codepoint/state of the y2-bit indicator could be associated/corresponding/specific to a CSI-RS resource provided by EarlySSB-Index or EarlyNZP-CSI-RS-Resource for the early triggering of the CSI measurement/reporting. In this case, when a codepoint/state of the y2-bit indicator is indicated, the UE could indicate to the network that the CSI-RS resource associated/corresponding/specific to the codepoint/state of the y2-bit indicator could be used/applied (by the UE) for determining or identifying the CSI-RS resource(s) and the corresponding parameter(s)/setting(s) to receive and measure the (early) triggered CSI-RS(s). For instance, the higher layer parameter(s)/signaling(s) including SIB1, SIB2, RRCRelease-IEs as specified/defined herein could provide or indicate or comprise K_early=1 CSI-RS resource configuration comprising or providing or configuring or linked/associated/specific to L_early=1 CSI resource set comprising or providing or configuring N_early>1 CSI-RS resources for the early triggering of the CSI measurement/reporting, wherein each of the CSI-RS resources could be provided by EarlySSB-Index or EarlyNZP-CSI-RS-Resource; for this design example, y2=2 with codepoint/state ‘00’ indicating the first CSI-RS resource or the CSI-RS resource with the lowest resource ID/index value, codepoint/state ‘01’ indicating the second CSI-RS resource or the CSI-RS resource with the second lowest resource ID/index value, codepoint/state ‘10’ indicating the third CSI-RS resource or the CSI-RS resource with the second highest resource ID/index value, and codepoint/state ‘11’ indicating the fourth CSI-RS resource or the CSI-RS resource with the highest resource ID/index value.
One or more CSI-RS resource IDs/ID values. In this case, the UE could indicate to the network that the CSI-RS resource(s) with or having the one or more CSI-RS resource IDs/ID values could be used/applied (by the UE) for determining or identifying the CSI-RS resource(s) and the corresponding parameter(s)/setting(s) to receive and measure the (early) triggered CSI-RS(s).
One or more indexes or index values denoted by n_1, . . . , n_y with each index or index value belonging to {1, . . . , N_early} or {0, . . . , N_early−1}, i.e., n_1, . . . , n_y∈{1, . . . , N_early} or {0, . . . , N_early−1}. In this case, the UE could indicate to the network that the n_1-th, . . . , n_y-th CSI-RS resource(s) among the configured/provided N_early CSI-RS resources (e.g., with their resource IDs/ID values ordered from low to high or from high to low) in the CSI resource set/configuration could be used/applied (by the UE) for determining or identifying the CSI-RS resource(s) and the corresponding parameter(s)/setting(s) to receive and measure the (early) triggered CSI-RS(s).
One or more trigger states each pointing/corresponding to an entry in a list of aperiodic CSI trigger states provided by CSI-AperiodicTriggerStateList. In this case, the UE could indicate to the network that the CSI-RS resource(s) corresponding/associated/specific to the one or more trigger states could be used/applied (by the UE) for determining or identifying the CSI-RS resource(s) and the corresponding parameter(s)/setting(s) to receive and measure the (early) triggered CSI-RS(s).
One or more PRACH preambles. In this case, the higher layer parameter(s)/signaling(s) including SIB1, SIB2, RRCRelease-IEs as specified/defined herein could also provide or indicate or comprise N_early>1 groups of PRACH preambles with each group corresponding/specific to a CSI-RS resource provided by EarlySSB-Index or EarlyNZP-CSI-RS-Resource according to or based on: (1) fixed rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). When/if the one or more PRACH preambles are from the y-th group of PRACH preambles (y∈{1, . . . , N_early} or {0, . . . , N_early−1}), the UE could indicate to the network that the y-th CSI-RS resource among the configured/provided N_early CSI-RS resources (e.g., with their resource IDs/ID values ordered from low to high or from high to low) could be used/applied (by the UE) for determining or identifying the CSI-RS resource(s) and the corresponding parameter(s)/setting(s) to receive and measure the (early) triggered CSI-RS(s).
One or more subgroup indexes of a PO. In this case, the higher layer parameter(s)/signaling(s) including SIB1, SIB2, RRCRelease-IEs as specified/defined herein could also provide or indicate or comprise the N_early>1 subgroups of a PO such that each subgroup of the PO could be associated/corresponding/specific to a CSI-RS resource provided by EarlySSB-Index or EarlyNZP-CSI-RS-Resource according to or based on: (1) fixed rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). For instance, when/if the one or more subgroup indexes of the PO comprises the y-th subgroup of the PO (y∈{1, . . . , N_early} or {0, . . . , N_early−1}), the UE could indicate to the network that the y-th CSI-RS resource among the configured/provided N_early CSI-RS resources (e.g., with their resource IDs/ID values ordered from low to high or from high to low) could be used/applied (by the UE) for determining or identifying the CSI-RS resource(s) and the corresponding parameter(s)/setting(s) to receive and measure the (early) triggered CSI-RS(s).
Information related to one or more CSI-RS resources. The UE could determine or identify the association(s)/mapping(s) between the information and the one or more CSI-RS resources according to or based on: (1) fixed rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). In this case, the UE could indicate to the network (e.g., the network 130) that the one or more CSI-RS resources corresponding/associated/specific to the information could be used/applied (by the UE) for determining or identifying the CSI-RS resource(s) and the corresponding parameter(s)/setting(s) to receive and measure the (early) triggered CSI-RS(s). The information could comprise one or more of: one or more UE IDs, time (including number(s) of slot(s)/symbol(s)/etc., starting slot/symbol/etc., and/or ending slot/symbol/etc.) and/or frequency (including number(s) of PRB(s)/etc., starting PRB/etc., and/or ending PRB/etc.) domain resource(s), a mapping between the one or more UE IDs and the N_early CSI-RS resources, a mapping between the resources used for the PDCCH providing the DCI format (e.g., time and/or frequency resources, e.g., (e.g., starting) channel control elements (CCEs) or (e.g., starting) resource element groups (REGs) or (e.g., starting) resource blocks (RBs) or (e.g., starting) symbols or slots or subframes or frames etc.) and the N_early CSI-RS resources, a mapping between the one or more UE IDs and resources used for reception of the PDCCH providing the DCI format as mentioned herein, and the N_early CSI-RS resources and/or etc.

In one example, the UE could determine or identify or select which one or more of the configured/provided CSI-RS resource configurations (and therefore, the corresponding/linked/associated CSI resource set(s)/CSI-RS resource(s), e.g., provided/configured therein) for the early triggering of the CSI measurement/reporting as specified/defined herein in the present disclosure, which one or more of the configured/provided CSI resource sets (and therefore, the corresponding CSI-RS resource(s) provided/configured therein) for the early triggering of the CSI measurement/reporting as specified/defined herein in the present disclosure, and/or which one or more of the configured/provided CSI-RS resources for the early triggering of the CSI measurement/reporting as specified/defined herein in the present disclosure, to use/apply for determining or identifying the CSI-RS resource(s) and the corresponding parameter(s)/setting(s) to receive and measure the (early) triggered CSI-RS(s) according to or based on fixed mapping rule(s) in system specification(s) and/or per RRC (re-)configuration/setup.
In one example, when/if the higher layer parameter(s)/signaling(s) including SIB1, SIB2, RRCRelease-IEs as specified/defined herein provides or indicates or comprises multiple or more than one (K_early>1) CSI-RS resource configurations for the early triggering of the CSI measurement/reporting, wherein each of the CSI-RS resource configurations could be provided by EarlyCSI-ResourceConfig or EarlyCSI-ReportConfig, and could comprise or provide or include or configure, and/or could be linked/associated/specific to one or more CSI resource sets each provided by EarlyCSI-ResourceSet such as EarlyCSI-SSB-CSI-ResourceSet or EarlyNZP-CSI-RS-ResourceSet and comprising, providing or configuring one or more CSI-RS resources each provided by EarlySSB-Index or EarlyNZP-CSI-RS-Resource, the fixed mapping rule(s) could correspond to or could comprise a mapping between the one or more UE IDs and the K_early CSI-RS resource configurations, a mapping between the resources used for the PDCCH providing the DCI format (e.g., time and/or frequency resources, e.g., (e.g., starting) channel control elements (CCEs) or (e.g., starting) resource element groups (REGs) or (e.g., starting) resource blocks (RBs) or (e.g., starting) symbols or slots or subframes or frames etc.) and the K_early CSI-RS resource configurations, a mapping between the one or more UE IDs and resources used for reception of the PDCCH providing the DCI format as mentioned herein, and the K_early CSI-RS resource configurations and/or etc.
In another example, when/if the higher layer parameter(s)/signaling(s) including SIB1, SIB2, RRCRelease-IEs as specified/defined herein provides or indicates or comprises one (K_early=1) CSI-RS resource configuration for the early triggering of the CSI measurement/reporting, wherein the CSI-RS resource configuration could be provided by EarlyCSI-ResourceConfig or EarlyCSI-ReportConfig, and could comprise, provide or configure, and/or could be linked/associated/specific to multiple or more than one (L_early>1) CSI resource sets each provided by EarlyCSI-ResourceSet such as EarlyCSI-SSB-CSI-ResourceSet or EarlyNZP-CSI-RS-ResourceSet and comprising, providing or configuring one or more CSI-RS resources each provided by EarlySSB-Index or EarlyNZP-CSI-RS-Resource, the fixed mapping rule(s) could correspond to or could comprise a mapping between the one or more UE IDs and the L_early CSI resource sets, a mapping between the resources used for the PDCCH providing the DCI format (e.g., time and/or frequency resources, e.g., (e.g., starting) channel control elements (CCEs) or (e.g., starting) resource element groups (REGs) or (e.g., starting) resource blocks (RBs) or (e.g., starting) symbols or slots or subframes or frames etc.) and the L_early CSI resource sets, a mapping between the one or more UE IDs and resources used for reception of the PDCCH providing the DCI format as mentioned herein, and the L_early CSI resource sets and/or etc.
In another example, when/if the higher layer parameter(s)/signaling(s) including SIB1, SIB2, RRCRelease-IEs as specified/defined herein provides or indicates or comprises one (K_early=1) CSI-RS resource configuration for the early triggering of the CSI measurement/reporting, wherein the CSI-RS resource configuration could be provided by EarlyCSI-ResourceConfig or EarlyCSI-ReportConfig, and could comprise, provide or configure, and/or could be linked/associated/specific to one (L_early=1) CSI resource set provided by EarlyCSI-ResourceSet such as EarlyCSI-SSB-CSI-ResourceSet or EarlyNZP-CSI-RS-ResourceSet and comprising, providing or configuring multiple or more than one (N_early>1) CSI-RS resources each provided by EarlySSB-Index or EarlyNZP-CSI-RS-Resource, the fixed mapping rule(s) could correspond to or could comprise a mapping between the one or more UE IDs and the N_early CSI-RS resources, a mapping between the resources used for the PDCCH providing the DCI format (e.g., time and/or frequency resources, e.g., (e.g., starting) channel control elements (CCEs) or (e.g., starting) resource element groups (REGs) or (e.g., starting) resource blocks (RBs) or (e.g., starting) symbols or slots or subframes or frames etc.) and the N_early CSI-RS resources, a mapping between the one or more UE IDs and resources used for reception of the PDCCH providing the DCI format as mentioned herein, and the N_early CSI-RS resources, and/or etc.

According to those specified herein in the present disclosure, the UE could determine or identify the one or more second channels/signals to transmit or send the beam/CSI measurement result(s) based on or according to:
In one example, the one or more second channels/signals could correspond to or could be associated/specific to one or more PUSCH(s) or PUSCH resource(s) scheduled or activated by a DCI format(s), wherein the DCI format(s) could correspond to the one or more first triggering channels/signals as specified/defined in Option-1 in the present disclosure.
In another example, the second channel(s)/signal(s) could correspond to the UL channel(s)/signal(s) including PUCCH(s)/PUSCH(s)/PRACH(s)/CSI-RS(s) and/or etc. corresponding/associated/specific to the higher layer message(s) as specified/defined in Option-2 in the present disclosure. For instance, the UL channel(s)/signal(s) herein could be associated with or after a PRACH preamble transmission as indicated or configured or provided by the higher layer message(s) as specified/defined in Option-2 in the present disclosure. Optionally, the UL channel(s)/signal(s) herein could be associated with or after a RACH scheduled transmission or a Msg3 as indicated or configured or provided by the higher layer message(s) as specified/defined in Option-2 in the present disclosure. Furthermore, the UL channel(s)/signal(s) herein could be associated with or after a MsgA as indicated or configured or provided by the higher layer message(s) as specified/defined in Option-2 in the present disclosure.
In another example, the second channel(s)/signal(s) could correspond to the UL channel(s)/signal(s) including PUCCH(s)/PUSCH(s)/PRACH(s)/CSI-RS(s) and/or etc. corresponding/associated/specific to the PEI(s) or paging message(s), e.g., corresponding to/for one or more POs, as specified/defined in Option-3 in the present disclosure. For instance, the UL channel(s)/signal(s) herein could be associated with or after a PRACH preamble transmission as indicated or configured or provided by the PEI(s)/paging message(s) as specified/defined in Option-3 in the present disclosure. Optionally, the UL channel(s)/signal(s) herein could be associated with or after a RACH scheduled transmission or a Msg3 as indicated or configured or provided by the PEI(s)/paging message(s) as specified/defined in Option-3 in the present disclosure. Furthermore, the UL channel(s)/signal(s) herein could be associated with or after a MsgA as indicated or configured or provided by the PEI(s)/paging message(s) as specified/defined in Option-3 in the present disclosure.
In another example, the second channel(s)/signal(s) could correspond to or could be associated/specific to a PRACH transmission—e.g., Msg1; in this case, a PRACH preamble of Msg1 could also indicate the measurement result(s) as specified/defined herein in the present disclosure. Alternatively, the second channel(s)/signal(s) could correspond to or could be associated/specific to a RACH scheduled transmission—e.g., Msg3; in this case, the PUSCH transmission providing Msg3 could also include, comprise, carry or convey the beam/CSI measurement result(s) as specified/defined herein in the present disclosure. Optionally, the second channel(s)/signal(s) could correspond to or could be associated/specific to a MsgA of Type-2 random access procedure; in this case, the PRACH or PUSCH transmission providing MsgA could also include, comprise, carry or convey the beam/CSI measurement result(s) as specified/defined herein in the present disclosure. In addition, the second channel(s)/signal(s) could correspond to the UL channel(s)/signal(s) including PUCCH(s)/PUSCH(s)/PRACH(s)/CSI-RS(s) and/or etc. associated with or after a RACH scheduled transmission or a Msg3 as indicated or configured or provided by the RAR as specified/defined in Option-4 in the present disclosure.

Furthermore,
Scheme-X.1: a UE could transmit or send to the network, in a/the (same) second channel(s)/signal(s), the third indicator(s) to indicate their autonomous determination, identification or selection of the CSI-RS resource(s) for the early triggering of the CSI measurement/reporting and the beam/CSI measurement result(s) according to or following those specified herein in the present disclosure; or equivalently, a UE could transmit or send to the network, in a/the (same) third channel(s)/signal(s), the third indicator(s) to indicate their autonomous determination, identification or selection of the CSI-RS resource(s) for the early triggering of the CSI measurement/reporting and the beam/CSI measurement result(s) according to or following those specified herein in the present disclosure.
Scheme-X.2: a UE could transmit or send to the network, in the third channel(s)/signal(s), the third indicator(s) to indicate their autonomous determination, identification or selection of the CSI-RS resource(s) for the early triggering of the CSI measurement/reporting according to or following those specified herein in the present disclosure; furthermore, the UE could transmit or send to the network, in the second channel(s)/signal(s) separate/different from the third channel(s)/signal(s), the beam/CSI measurement result(s) according to or following those specified herein in the present disclosure.

The UE could determine or identify which of Scheme-X.1 and Scheme-X.2 to follow for transmitting, sending or indicating to the network their autonomous determination, identification or selection of the CSI-RS resource(s) for the early triggering of the CSI measurement/reporting and/or the corresponding beam/CSI measurement result(s) according to or following those specified herein in the present disclosure based on or according to: (1) fixed rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s).

The UE could transmit or send or indicate to the network, in/by/via the second channel(s)/signal(s), the CSI/beam measurement result(s) according to or based on one or more of the followings.
In one example, the UE could transmit or send or indicate to the network the second channel(s)/signal(s) carrying or conveying the CSI/beam measurement result(s) a minimum time T from the end (or start) of the first triggering channel(s)/signal(s). For instance, for Option-1, the first triggering channel(s)/signal(s) as mentioned herein could correspond to a PDCCH reception providing the DCI format(s) triggering the CSI measurement/reporting.
In another example, the symbol or slot or subframe or frame used by a UE to receive and measure the (early) triggered CSI-RS(s) could be at or after a time T from the end (or start) of the first triggering channel(s)/signal(s). For instance, for Option-1, the first triggering channel(s)/signal(s) as mentioned herein could correspond to a PDCCH reception providing the DCI format(s) triggering the CSI measurement/reporting.
In another example, the symbol or slot or subframe or frame used by a UE to receive and measure the (early) triggered CSI-RS(s) could be that first symbol or slot or subframe or frame that starts at or after a time T from the end (or start) of the first triggering channel(s)/signal(s) and optionally based on a time offset/gap. For instance, for Option-1, the first triggering channel(s)/signal(s) as mentioned herein could correspond to a PDCCH reception providing the DCI format(s) triggering the CSI measurement/reporting.

The time T and/or the time offset/gap could be in number of symbol(s), slot(s), subframe(s), frame(s) and/or etc. Furthermore, the UE could determine or identify the value(s) of the time T and/or the time offset/gap according to or based on: (1) fixed value(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). For instance, the value(s) of the time T and/or the time offset/gap could be indicated or provided by/in the DCI format(s) that trigger(s) the CSI measurement/reporting—as in Option-1 in the present disclosure.
For example, one or more new DCI fields in the DCI format(s) could indicate or provide the value(s) of the time T and/or the time offset/gap.
For another example, one or more existing DCI fields in the DCI format(s) could be repurposed to indicate or provide the value(s) of the time T and/or the time offset/gap.

The value(s) of the time T and/or the time offset/gap could be present or absent in their corresponding first triggering channel(s)/signal(s) according to network's configuration or indication (e.g., via RRC signaling(s)/configuration(s)). For instance, the UE could be provided or indicated or configured by the network a higher layer parameter/signaling denoted by timeIndicationCSI_PresentInDCI. In this case, when/if the higher layer parameter/signaling timeIndicationCSI_PresentInDCI is provided/configured and/or set to ‘enabled’ or ‘on’, the value(s) of the time T and/or the time offset/gap as specified/defined herein in the present disclosure could be present in the corresponding DCI format(s) as specified/defined in Option-1 following those specified herein in the present disclosure; otherwise, i.e., when/if the higher layer parameter/signaling timeIndicationCSI_PresentInDCI is not provided/configured and/or set to ‘disabled’ or ‘off’, the value(s) of the time T and/or the time offset/gap as specified/defined herein in the present disclosure may not be present or could be absent in the corresponding DCI format(s) as specified/defined in Option-1 according to those specified herein in the present disclosure.

In addition to the CSI-RS resource configuration(s) mentioned herein for the early triggering of the CSI measurement/reporting, the UE could also be provided or indicated or configured by the network, e.g., via higher layer RRC signaling(s)/parameter(s) and/or MAC CE command(s) and/or dynamic DCI based L1 signaling(s) based on or according to a corresponding UE's capability or capability signaling, SRS resource configuration(s) for early triggering of SRS transmission(s). For instance, the UE could receive from the network, via/in higher layer RRC signaling(s)/parameter(s) including SIB1, SIB2, RRCRelease-IEs, and/or etc. according to or following those specified herein in the present disclosure, the SRS resource configuration(s) for the early triggering of the SRS transmission(s). Here, a SRS resource configuration could be provided by EarlySRS-Config providing or configuring or indicating
At least one or more of parameters/settings/components provided or configured by/in higher layer parameter(s) including at least SRS-Config, SRS-ResourceSet, SRS-Resource, and/or etc. for the corresponding SRS resource(s) defined/specified in [REF 6] for 5G NR.
At least one or more of the following parameters/settings/components for the configuration(s) of the corresponding SRS resource(s)
   SRS resource ID/index, SRS resource set ID/index, SRS resource configuration/setting ID/index.
   Resource type and corresponding parameter(s) for the corresponding SRS resource(s) including ‘aperiodic’, ‘periodic’, and/or ‘semi-persistent’; the parameter(s) corresponding to the resource type of ‘aperiodic’ could also comprise or include or contain an aperiodic SRS resource trigger state list provided by aperiodicSRS-ResourceTrigger or aperiodicSRS-ResourceTriggerList.
   Usage for the corresponding SRS resource(s) including ‘beamManagement’, ‘codebook’, ‘nonCodebook’ and/or ‘antennaSwitching’.
   Time and frequency resources (e.g., symbols within a slot for SRS, starting symbol for SRS, time slot for SRS, periodicity and offset of SRS (e.g., in case of periodic or semi-persistent SRS), starting PRB for SRS, number of PRBs for SRS, whether frequency hopping is enabled and if enabled frequency hopping pattern, etc.).
   Number of instances, K, of SRS transmitted when SRS is triggered.
   Comb size, comb offset and cycle shift.
   Sequence for generating the corresponding reference signal.
   Transmit power control parameter(s)/setting(s) for the corresponding reference signal.
   TCI state(s) and/or reference signal(s) used for determining the spatial filter(s) for transmitting the corresponding SRS(s).

FIG. 11 illustrates a signal flow of an example procedure 1100 for early triggering of SRS transmission(s) for CSI acquisition according to embodiments of the present disclosure. For example, procedure 1100 can be performed by the UE 116 and the gNB 103 and/or network 130 in the wireless network 100 of FIG. 1. This example is for illustration only and other embodiments can be used without departing from the scope of the present disclosure.

The procedure begins in 1110, a NW/gNB transmits configuration(s) of SRS resource(s) for early triggering to a UE, e.g., via SIB, RRC, release message, etc. In 1120, the NW/gNB transmits triggering of SRS transmission(s) to the UE via an indicator sent in fourth channel(s)/signal(s). In 1130, the UE transmits SRS transmission(s) to the NW/gNB in fifth channel(s)/signal(s).

An example signaling flow characterizing early triggering of SRS transmission procedure(s) is provided in FIG. 11. As illustrated in FIG. 11, after the UE (e.g., the UE 116) has received from the network the SRS resource configuration(s) for the early triggering of the SRS transmission(s) according to or following those specified herein in the present disclosure, the UE could expect to receive from the network, in/via/by one or more fourth triggering channels/signals, one or more fourth indicators to indicate and/or trigger and/or enable the (early) SRS transmission(s). Upon detection and/or reception of the one or more fourth indicators, the UE could determine or identify, based on or according to the SRS resource configuration(s), the SRS(s) along with the corresponding parameter(s)/setting(s) to transmit. In this case, the UE could then send or transmit to the network, in/via/by one or more fifth channels/signals, the (early) triggered SRS(s). The UE could determine or identify the fifth channel(s)/signal(s)—e.g., in form/terms of time and/or frequency resource(s)—to transmit the (early) triggered SRS(s) according to or based on association(s)/mapping(s) between (resource(s) of) the fifth channel(s)/signal(s) and (resource(s) of) the fourth triggering channel(s)/signal(s), wherein the association(s)/mapping(s) could be in form/terms of timing relationship(s) or timeline(s), configuration(s), time-frequency resource allocation(s) and/or etc. according to or based on: (1) fixed rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). In the present disclosure, the UE could determine or identify the one or more fourth triggering channels/signals based on or according to the one or more first triggering channels/signals as defined/specified herein in the present disclosure, or, the one or more fourth triggering channels/signals could have similar or same form(s), format(s), signaling medium(s)/container(s) and/or etc. to or as the one or more first triggering channels/signals. For instance, the four design options Option-1, Option-2, Option-3 and Option-4 for the early triggering of the CSI measurement/reporting can be modified or replaced by the following four options Option-A, Option-B, Option-C and Option-D for the early triggering of the SRS transmission(s), and similar design methods can be applied throughout the present disclosure.
Option-A: the fourth triggering channel(s)/signal(s) could correspond to or could be associated/specific to a DCI format (e.g., a DL DCI format of 1_0/1_1/1_2/1_3 or a UL DCI format of 0_0/0_1/0_2/0_3 or a DCI format of 2_3 or a new DL/UL DCI format, e.g., dedicated for the early triggering of the SRS transmission(s)), wherein the one or more fourth indicators could correspond to or could be provided/indicated in/by one or more new DCI fields in the DCI format(s), or one or more existing DCI fields (e.g., SRS request field in DCI format 0_1/1_1/2_3) in the DCI format(s) repurposed for the early triggering of the SRS transmission(s). Furthermore, the CRC of the DCI format(s) could be scrambled with a RNTI, wherein the RNTI could be associated with the early triggered SRS(s).
Option-B: the fourth triggering channel(s)/signal(s) could correspond to or could be associated/specific to a higher layer message carried by/in a PDSCH, wherein the higher layer message could be a SIB message (e.g., SIB1, SIB2 or other SIB message(s)), a RRC message (e.g., a RRC reconfiguration message, a RRC setup message, a RRC release message, and/or etc.), a MAC CE message/signaling, and/or etc.; furthermore, the PDSCH could be scheduled/activated by a corresponding DCI format. The CRC of the higher layer message and/or the corresponding DCI format could be scrambled with a RNTI, wherein the RNTI could be associated with the early triggered SRS(s). In this case, the higher layer message could carry, convey, include or comprise the one or more fourth indicators as specified/defined herein in the present disclosure.
Option-C: the fourth triggering channel(s)/signal(s) could correspond to or could be associated/specific to one or more paging occasions (POs) or a paging early indication (PEI) associated with a PO, wherein the PEI could include an indication for each subgroup of a PO whether there is a corresponding paging message for the UEs of that subgroup. In this case, the PO(s)/PEI could comprise, contain, include, convey or carry the one or more fourth indicators as specified/defined herein in the present disclosure. In addition, the PEI could be carried or conveyed using a DCI format (e.g., DCI format 2_7).
Option-D: the fourth triggering channel(s)/signal(s) could correspond to or could be associated/specific to a random access response (RAR)—e.g., Msg2—to a preamble transmission for a contention based or a contention free random access procedure; in this case, the RAR (e.g., Msg2) could also include, comprise, carry or convey the one or more fourth indicators as specified/defined herein in the present disclosure. Optionally, the fourth triggering channel(s)/signal(s) could correspond to or could be associated/specific to a contention resolution message (e.g., a MAC CE) providing a C-RNTI for the UE, or in Msg4, of a contention based random access procedure; in this case, the contention resolution message (e.g., Msg4) could also include, comprise, carry or convey the one or more fourth indicators as specified/defined herein in the present disclosure. Alternatively, the fourth triggering channel(s)/signal(s) could correspond to or could be associated/specific to a MsgB of a Type-2 random access procedure, wherein the MsgB could be for success RAR (e.g., of a contention based random access procedure) or a fall back RAR (e.g., of a contention free random access procedure); in this case, the MsgB (or the success RAR or fall back RAR) could also include, comprise, carry or convey the one or more fourth indicators as specified/defined herein in the present disclosure.

The UE could determine or identify which one or more of the Option-A, Option-B, Option-C and Option-D to use or follow or apply to determine or identify the fourth triggering channel(s)/signal(s) according to: (1) fixed rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). The one or more fourth indicators could correspond to or comprise, or could be in form/terms of one or more of:
A one-bit flag indicator (e.g., a new one-bit DCI field in the DCI format(s) as specified/defined in Option-A) with ‘1’ (or ‘0’) indicating or enabling or triggering (early) SRS transmission(s)
A (higher layer) parameter set to ‘enabled’ or ‘on’ indicating or enabling or triggering (early) SRS transmission(s)

The one or more fourth indicators could be present or absent in their corresponding fourth triggering channel(s)/signal(s) according to network's configuration or indication (e.g., via RRC signaling(s)/configuration(s)). For instance, the UE could be provided or indicated or configured by the network (e.g., the network 130) a higher layer parameter/signaling denoted by earlySRSTrigger_PresentInDCI. In this case, when/if the higher layer parameter/signaling earlySRSTrigger_PresentInDCI is provided/configured and/or set to ‘enabled’ or ‘on’, the fourth indicator(s) as specified/defined herein in the present disclosure could be present in the corresponding DCI format(s) as specified/defined in Option-A following those specified herein in the present disclosure; otherwise, i.e., when/if the higher layer parameter/signaling earlySRSTrigger_PresentInDCI is not provided/configured and/or set to ‘disabled’ or ‘off’, the fourth indicator(s) as specified/defined herein in the present disclosure may not be present or could be absent in the corresponding DCI format(s) as specified/defined in Option-A according to those specified herein in the present disclosure. Furthermore,
Scheme-1.1: a UE could be indicated or provided or configured by the network, in a/the (same) first triggering channel(s)/signal(s), the first indicator(s) to indicate and/or trigger and/or enable the (early) CSI measurement/reporting and the fourth indicator(s) to indicate and/or trigger and/or enable the (early) SRS transmission(s) according to or following those specified herein in the present disclosure; or equivalently, a UE could be indicated or provided or configured by the network, in a/the (same) fourth triggering channel(s)/signal(s), the first indicator(s) to indicate and/or trigger and/or enable the (early) CSI measurement/reporting and the fourth indicator(s) to indicate and/or trigger and/or enable the (early) SRS transmission(s) according to or following those specified herein in the present disclosure.
Scheme-1.2: a UE could be indicated or provided or configured by the network, in the first triggering channel(s)/signal(s), the first indicator(s) to indicate and/or trigger and/or enable the (early) CSI transmission/reporting according to or following those specified herein in the present disclosure; furthermore, the UE could be indicated or provided or configured by the network, in the fourth triggering channel(s)/signal(s) separate/different from the first triggering channel(s)/signal(s), the fourth indicator(s) to indicate and/or trigger and/or enable the (early) SRS transmission(s) according to or following those specified herein in the present disclosure.

The UE could determine or identify which of Scheme-1.1 and Scheme-1.2 to follow for early triggering of SRS transmission(s) and/or CSI measurement/reporting based on or according to: (1) fixed rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s).

As specified/defined herein in the present disclosure, the one or more fourth indicators could have similar or same form(s), format(s), function(s) and/or etc. to or as the one or more first indicators as defined/specified herein in the present disclosure. Furthermore,
Scheme-1.3: a UE could be indicated or provided or configured by the network, a/the (same) first indicator(s), to jointly indicate and/or trigger and/or enable the (early) SRS transmission(s) and the (early) CSI measurement/reporting according to or following those specified herein in the present disclosure; or equivalently, a UE could be indicated or provided or configured by the network, a/the (same) fourth indicator(s), to jointly indicate and/or trigger and/or enable the (early) SRS transmission(s) and the (early) CSI measurement/reporting according to or following those specified herein in the present disclosure.
Scheme-1.4: a UE could be indicated or provided or configured by the network, the first indicator(s), to indicate and/or trigger and/or enable the (early) CSI measurement/reporting according to or following those specified herein in the present disclosure; the UE could be separately indicated or provided or configured by the network, the fourth indicator(s), to indicate and/or trigger and/or enable the (early) SRS transmission(s) according to or following those specified herein in the present disclosure.

The UE could determine or identify which of Scheme-1.3 and Scheme-1.4 to follow for early triggering of SRS transmission(s) and/or CSI measurement/reporting based on or according to: (1) fixed rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s).

The UE could additionally receive from the network, in/via/by the one or more fourth triggering channels/signals, one or more fifth indicators to indicate or provide resource allocation(s) for the (early) triggered SRS(s).
For Option-A specified/defined herein in the present disclosure, the one or more fifth indicators could correspond to or could be provided/indicated in/by one or more new DCI fields in the DCI format(s), or one or more existing DCI fields (e.g., SRS request field in DCI format 0_1/1_1/2_3) in the DCI format(s) repurposed for indicating or providing resource allocation(s) for the (early) triggered SRS transmission(s).
For Option-B specified/defined herein in the present disclosure, the higher layer message could carry, convey, include or comprise the one or more fifth indicators as specified/defined herein in the present disclosure.
For Option-C specified/defined herein in the present disclosure, the PO(s)/PEI could comprise, contain, include, convey or carry the one or more fifth indicators as specified/defined herein in the present disclosure.
For Option-D specified/defined herein in the present disclosure, the RAR (e.g., Msg2) could also include, comprise, carry or convey the one or more fifth indicators as specified/defined herein in the present disclosure. Optionally, the contention resolution message (e.g., Msg4) could also include, comprise, carry or convey the one or more fifth indicators as specified/defined herein in the present disclosure. Alternatively, the MsgB (or the success RAR or fall back RAR) could include, comprise, carry or convey the one or more fifth indicators as specified/defined herein in the present disclosure.

The one or more fifth indicators could be present or absent in their corresponding fourth triggering channel(s)/signal(s) according to network's configuration or indication (e.g., via RRC signaling(s)/configuration(s)). For instance, the UE could be provided or indicated or configured by the network a higher layer parameter/signaling denoted by earlySRSRa_PresentInDCI. In this case, when/if the higher layer parameter/signaling earlySRSRa_PresentInDCI is provided/configured and/or set to ‘enabled’ or ‘on’, the fifth indicator(s) as specified/defined herein in the present disclosure could be present in the corresponding DCI format(s) as specified/defined in Option-A following those specified herein in the present disclosure; otherwise, i.e., when/if the higher layer parameter/signaling earlySRSRa_PresentInDCI is not provided/configured and/or set to ‘disabled’ or ‘off’, the fifth indicator(s) as specified/defined herein in the present disclosure may not be present or could be absent in the corresponding DCI format(s) as specified/defined in Option-A according to those specified herein in the present disclosure. Furthermore,
Scheme-I.1: a UE could be indicated or provided or configured by the network, in a/the (same) first triggering channel(s)/signal(s), the second indicator(s) to indicate or provide resource allocation(s) for the (early) triggered CSI-RS(s) and the fifth indicator(s) to indicate or provide resource allocation(s) for the (early) triggered SRS(s) according to or following those specified herein in the present disclosure; or equivalently, a UE could be indicated or provided or configured by the network, in a/the (same) fourth triggering channel(s)/signal(s), the second indicator(s) to indicate or provide resource allocation(s) for the (early) triggered CSI-RS(s) and the fifth indicator(s) to indicate or provide resource allocation(s) for the (early) triggered SRS(s) according to or following those specified herein in the present disclosure.
Scheme-I.2: a UE could be indicated or provided or configured by the network, in the first triggering channel(s)/signal(s), the second indicator(s) to indicate or provide resource allocation(s) for the (early) triggered CSI-RS(s) according to or following those specified herein in the present disclosure; furthermore, the UE could be indicated or provided or configured by the network, in the fourth triggering channel(s)/signal(s) separate/different from the first triggering channel(s)/signal(s), the fifth indicator(s) to indicate or provide resource allocation(s) for the (early) triggered SRS(s) according to or following those specified herein in the present disclosure.

The UE could determine or identify which of Scheme-I.1 and Scheme-I.2 to follow for determining or identifying resource allocation(s) for the (early) triggered SRS(s) and/or CSI-RS(s) based on or according to: (1) fixed rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s).

In one example, the higher layer parameter(s)/signaling(s) including SIB1, SIB2, RRCRelease-IEs as specified/defined herein could provide or indicate or comprise multiple or more than one (H_early>1) SRS resource configurations for the early triggering of the SRS transmission(s), wherein each of the SRS resource configurations could be provided by EarlySRS-Config, and could comprise or provide or include or configure or link to one or more SRS resource sets each provided by EarlySRS-ResourceSet and comprising, providing or configuring one or more SRS resources each provided by EarlySRS-Resource. For this design example, the one or more fifth indicators could have similar or same form(s), format(s), function(s) and/or etc. to or as the one or more second indicators as defined/specified herein in the present disclosure by replacing a CSI-RS resource configuration provided by EarlyCSI-ResourceConfig/EarlyCSI-ReportConfig with a SRS resource configuration provided by EarlySRS-Config, a CSI-RS resource configuration ID/ID value with a SRS resource configuration ID/ID value, a list of aperiodic CSI trigger states with a list of aperiodic SRS resource trigger states, a CSI request field with a SRS request field, (early) triggered CSI-RS(s) with (early) triggered SRS(s), early triggering of CSI measurement/reporting with early triggering of SRS transmission(s), and/or etc. When/if the fifth indicator(s) is absent or not present in the corresponding fourth triggering channel(s)/signal(s) according to or following those specified herein in the present disclosure, the UE could determine the SRS resource configuration(s), and therefore the corresponding SRS resource(s) along with its associated parameter(s)/setting(s), to use/apply for transmitting the (early) triggered SRS(s) according to or based on fixed rule(s) in system specification(s) and/or per RRC (re-)configuration/setup. In this case, for example, the H_early SRS resource configurations provided/configured for the early triggering of the SRS transmission(s) could be used/applied (by the UE) for determining or identifying the SRS resource(s) and the corresponding parameter(s)/setting(s) to transmit the (early) triggered SRS(s); for another example, the first (or last) SRS resource configuration or the SRS resource configuration with the lowest (or highest) configuration ID/index value, e.g., among the H_early SRS resource configurations provided/configured for the early triggering of the SRS transmission(s), could be used/applied (by the UE) for determining or identifying the SRS resource(s) and the corresponding parameter(s)/setting(s) to transmit the (early) triggered SRS(s).

In one example, the higher layer parameter(s)/signaling(s) including SIB1, SIB2, RRCRelease-IEs as specified/defined herein could provide or indicate or comprise one (H_early=1) SRS resource configuration for the early triggering of the SRS transmission(s), wherein the SRS resource configuration could be provided by EarlySRS-Config, and could comprise, provide or configure multiple or more than one (I_early>1) SRS resource sets each provided by EarlySRS-ResourceSet and comprising, providing or configuring one or more SRS resources each provided by EarlySRS-Resource. For this design example, the one or more fifth indicators could have similar or same form(s), format(s), function(s) and/or etc. to or as the one or more second indicators as defined/specified herein in the present disclosure by replacing a CSI resource set provided by EarlyCSI-ResourceSet with a SRS resource set provided by EarlySRS-ResourceSet, a CSI resource set ID/ID value with a SRS resource set ID/ID value, a list of aperiodic CSI trigger states with a list of aperiodic SRS resource trigger states, a CSI request field with a SRS request field, (early) triggered CSI-RS(s) with (early) triggered SRS(s), early triggering of CSI measurement/reporting with early triggering of SRS transmission(s), and/or etc. When/if the fifth indicator(s) is absent or not present in the corresponding fourth triggering channel(s)/signal(s) according to or following those specified herein in the present disclosure, the UE could determine the SRS resource set(s), and therefore the corresponding SRS resource(s) along with its associated parameter(s)/setting(s), to use/apply for transmitting the (early) triggered SRS(s) according to or based on fixed rule(s) in system specification(s) and/or per RRC (re-)configuration/setup. In this case, for example, the I_early SRS resource sets provided/configured for the early triggering of the SRS transmission(s) could be used/applied (by the UE) for determining or identifying the SRS resource(s) and the corresponding parameter(s)/setting(s) to transmit the (early) triggered SRS(s); for another example, the first (or last) SRS resource set or the SRS resource set with the lowest (or highest) set ID/index value, e.g., among the I_early SRS resource sets provided/configured for the early triggering of the SRS transmission(s), could be used/applied (by the UE) for determining or identifying the SRS resource(s) and the corresponding parameter(s)/setting(s) to transmit the (early) triggered SRS(s).

In one example, the higher layer parameter(s)/signaling(s) including SIB1, SIB2, RRCRelease-IEs as specified/defined herein could provide or indicate or comprise one (H_early=1) SRS resource configuration for the early triggering of the SRS transmission(s), wherein the SRS resource configuration could be provided by EarlySRS-Config, and could comprise, provide or configure one (I_early=1) SRS resource set provided by EarlySRS-ResourceSet and comprising, providing or configuring multiple or more than one (J_early>1) SRS resources each provided by EarlySRS-Resource. For this design example, the one or more fifth indicators could have similar or same form(s), format(s), function(s) and/or etc. to or as the one or more second indicators as defined/specified herein in the present disclosure by replacing a CSI-RS resource provided by EarlySSB-Index/EarlyNZP-CSI-RS-Resource with a SRS resource provided by EarlySRS-Resource, a CSI-RS resource ID/ID value with a SRS resource ID/ID value, a list of aperiodic CSI trigger states with a list of aperiodic SRS resource trigger states, a CSI request field with a SRS request field, (early) triggered CSI-RS(s) with (early) triggered SRS(s), early triggering of CSI measurement/reporting with early triggering of SRS transmission(s), and/or etc. When/if the fifth indicator(s) is absent or not present in the corresponding fourth triggering channel(s)/signal(s) according to or following those specified herein in the present disclosure, the UE could determine the SRS resource(s) along with its associated parameter(s)/setting(s) to use/apply for transmitting the (early) triggered SRS(s) according to or based on fixed rule(s) in system specification(s) and/or per RRC (re-)configuration/setup. In this case, for example, the J_early SRS resources provided/configured for the early triggering of the SRS transmission(s) could be used/applied (by the UE) for determining or identifying the SRS resource(s) and the corresponding parameter(s)/setting(s) to transmit the (early) triggered SRS(s); for another example, the first (or last) SRS resource or the SRS resource with the lowest (or highest) resource ID/index value, e.g., among the J_early SRS resources provided/configured for the early triggering of the SRS transmission(s), could be used/applied (by the UE) for determining or identifying the SRS resource(s) and the corresponding parameter(s)/setting(s) to transmit the (early) triggered SRS(s).

As specified/defined herein in the present disclosure, the one or more fifth indicators could have similar or same form(s), format(s), function(s) and/or etc. to or as the one or more second indicators as defined/specified herein in the present disclosure. Furthermore,
Scheme-I.3: a UE could be indicated or provided or configured by the network, a/the (same) second indicator(s), to jointly indicate or provide resource allocation(s) for the (early) triggered SRS(s) and the (early) triggered CSI-RS(s) according to or following those specified herein in the present disclosure; or equivalently, a UE could be indicated or provided or configured by the network, a/the (same) fifth indicator(s), to jointly indicate or provide resource allocation(s) for the (early) triggered SRS(s) and the (early) triggered CSI-RS(s) according to or following those specified herein in the present disclosure.
Scheme-I.4: a UE could be indicated or provided or configured by the network, the second indicator(s), to indicate or provide resource allocation(s) for the (early) triggered CSI-RS(s) according to or following those specified herein in the present disclosure; the UE could be separately indicated or provided or configured by the network, the fifth indicator(s), to indicate or provide resource allocation(s) for the (early) triggered SRS(s).

The UE could determine or identify which of Scheme-I.3 and Scheme-I.4 to follow for determining or identifying resource allocation(s) for the early triggering of the SRS transmission(s) and/or the early triggering of the CSI measurement/reporting based on or according to: (1) fixed rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s).

Optionally, the UE could autonomously determine or identify or select which one or more of the configured/provided SRS resource configurations (and therefore, the corresponding SRS resource set(s)/SRS resource(s) provided/configured therein) for the early triggering of the SRS transmission(s) as specified/defined herein in the present disclosure, which one or more of the configured/provided SRS resource sets (and therefore, the corresponding SRS resource(s) provided/configured therein) for the early triggering of the SRS transmission(s) as specified/defined herein in the present disclosure, and/or which one or more of the configured/provided SRS resources for the early triggering of the SRS transmission(s) as specified/defined herein in the present disclosure, to use/apply for determining or identifying the SRS resource(s) and the corresponding parameter(s)/setting(s) to transmit the (early) triggered SRS(s). The UE (e.g., the UE 116) could be indicated or provided or configured by the network, e.g., via higher layer RRC signaling(s)/parameter(s) and/or MAC CE command(s) and/or dynamic DCI based L1 signaling(s) based on or according to a corresponding UE's capability or capability signaling, whether or not the UE could autonomously determine, identify or select the SRS resource(s)—and therefore the corresponding parameter(s)/setting(s)—to transmit the (early) triggered SRS(s); for instance, when/if the UE is provided or configured by the network a higher layer parameter ueSelectSRSResource and/or set to ‘enabled’ based on or according to a corresponding UE's capability/capability signaling, the UE could autonomously determine or identify or select the SRS resource(s) for the early triggering of the SRS transmission(s) as specified/defined herein in the present disclosure. Optionally, when/if the fifth indicator(s) as specified/defined herein in the present disclosure is absent or not present in the corresponding fourth triggering channel(s)/signal(s) according to or following those specified herein in the present disclosure, the UE could autonomously determine or identify or select the SRS resource(s) for the early triggering of the SRS transmission(s) as specified/defined herein in the present disclosure. In this case, the UE could transmit or send to the network, in/via/by one or more sixth channels/signals, one or more sixth indicators to indicate their autonomous determination, identification or selection of the SRS resource(s) for the early triggering of the SRS transmission(s) as specified/defined herein. In the present disclosure, the UE could determine or identify the one or more sixth channels/signals based on or according to:
In one example, the one or more sixth channels/signals could correspond to or could be associated/specific to one or more PUSCH(s) or PUSCH resource(s) scheduled or activated by a DCI format(s), wherein the DCI format(s) could correspond to the one or more fourth triggering channels/signals as specified/defined in Option-A in the present disclosure.
In another example, the sixth channel(s)/signal(s) could correspond to the UL channel(s)/signal(s) including PUCCH(s)/PUSCH(s)/PRACH(s)/SRS(s) and/or etc. corresponding/associated/specific to the higher layer message(s) as specified/defined in Option-B in the present disclosure. For instance, the UL channel(s)/signal(s) herein could be associated with or after a PRACH preamble transmission as indicated or configured or provided by the higher layer message(s) as specified/defined in Option-B in the present disclosure. Optionally, the UL channel(s)/signal(s) herein could be associated with or after a RACH scheduled transmission or a Msg3 as indicated or configured or provided by the higher layer message(s) as specified/defined in Option-B in the present disclosure. Furthermore, the UL channel(s)/signal(s) herein could be associated with or after a MsgA as indicated or configured or provided by the higher layer message(s) as specified/defined in Option-B in the present disclosure.
In another example, the sixth channel(s)/signal(s) could correspond to the UL channel(s)/signal(s) including PUCCH(s)/PUSCH(s)/PRACH(s)/SRS(s) and/or etc. corresponding/associated/specific to the PEI(s) or paging message(s), e.g., corresponding to/for one or more POs, as specified/defined in Option-C in the present disclosure. For instance, the UL channel(s)/signal(s) herein could be associated with or after a PRACH preamble transmission as indicated or configured or provided by the PEI(s)/paging message(s) as specified/defined in Option-C in the present disclosure. Optionally, the UL channel(s)/signal(s) herein could be associated with or after a RACH scheduled transmission or a Msg3 as indicated or configured or provided by the PEI(s)/paging message(s) as specified/defined in Option-C in the present disclosure. Furthermore, the UL channel(s)/signal(s) herein could be associated with or after a MsgA as indicated or configured or provided by the PEI(s)/paging message(s) as specified/defined in Option-C in the present disclosure.
In another example, the sixth channel(s)/signal(s) could correspond to or could be associated/specific to a PRACH transmission—e.g., Msg1; in this case, a PRACH preamble of Msg1 could also indicate the one or more sixth indicators as specified/defined herein in the present disclosure. Alternatively, the sixth channel(s)/signal(s) could correspond to or could be associated/specific to a RACH scheduled transmission—e.g., Msg3; in this case, the PUSCH transmission providing Msg3 could also include, comprise, carry or convey the one or more sixth indicators as specified/defined herein in the present disclosure. Optionally, the sixth channel(s)/signal(s) could correspond to or could be associated/specific to a MsgA of Type-2 random access procedure; in this case, the PRACH or PUSCH transmission providing MsgA could also include, comprise, carry or convey the one or more sixth indicators as specified/defined herein in the present disclosure. In addition, the sixth channel(s)/signal(s) could correspond to the UL channel(s)/signal(s) including PUCCH(s)/PUSCH(s)/PRACH(s)/SRS(s) and/or etc. associated with or after a RACH scheduled transmission or a Msg3 as indicated or configured or provided by the RAR as specified/defined in Option-D in the present disclosure.

Furthermore,
Scheme-A.1: a UE could send or transmit to the network, in a/the (same) third channel(s)/signal(s), the third indicator(s) to indicate or provide resource allocation(s) for the (early) triggered CSI-RS(s) and the sixth indicator(s) to indicate or provide resource allocation(s) for the (early) triggered SRS(s) according to or following those specified herein in the present disclosure; or equivalently, a UE could send or transmit the network, in a/the (same) sixth channel(s)/signal(s), the third indicator(s) to indicate or provide resource allocation(s) for the (early) triggered CSI-RS(s) and the sixth indicator(s) to indicate or provide resource allocation(s) for the (early) triggered SRS(s) according to or following those specified herein in the present disclosure.
Scheme-A.2: a UE could send or transmit to the network, in the third channel(s)/signal(s), the third indicator(s) to indicate or provide resource allocation(s) for the (early) triggered CSI-RS(s) according to or following those specified herein in the present disclosure; furthermore, the UE send or transmit to the network, in the sixth channel(s)/signal(s) separate/different from the third channel(s)/signal(s), the sixth indicator(s) to indicate or provide resource allocation(s) for the (early) triggered SRS(s) according to or following those specified herein in the present disclosure.

The UE could determine or identify which of Scheme-A.1 and Scheme-A.2 to follow for determining or identifying or indicating resource allocation(s) for the (early) triggered SRS(s) and/or CSI-RS(s) based on or according to: (1) fixed rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s).

In one example, the higher layer parameter(s)/signaling(s) including SIB1, SIB2, RRCRelease-IEs as specified/defined herein could provide or indicate or comprise multiple or more than one (H_early>1) SRS resource configurations for the early triggering of the SRS transmission(s), wherein each of the SRS resource configurations could be provided by EarlySRS-Config, and could comprise or provide or include or configure or link to one or more SRS resource sets each provided by EarlySRS-ResourceSet and comprising, providing or configuring one or more SRS resources each provided by EarlySRS-Resource. For this design example, the one or more sixth indicators could have similar or same form(s), format(s), function(s) and/or etc. to or as the one or more third indicators as defined/specified herein in the present disclosure by replacing a CSI-RS resource configuration provided by EarlyCSI-ReportConfig/EarlyCSI-ResourceConfig with a SRS resource configuration provided by EarlySRS-Config, a CSI-RS resource configuration ID/ID value with a SRS resource configuration ID/ID value, a list of aperiodic CSI trigger states with a list of aperiodic SRS resource trigger states, a CSI request field with a SRS request field, (early) triggered CSI-RS(s) with (early) triggered SRS(s), early triggering of CSI measurement/reporting with early triggering of SRS transmission(s), and/or etc.

In one example, the higher layer parameter(s)/signaling(s) including SIB1, SIB2, RRCRelease-IEs as specified/defined herein could provide or indicate or comprise one (H_early=1) SRS resource configuration for the early triggering of the SRS transmission(s), wherein the SRS resource configuration could be provided by EarlySRS-Config, and could comprise, provide or configure multiple or more than one (I_early>1) SRS resource sets each provided by EarlySRS-ResourceSet and comprising, providing or configuring one or more SRS resources each provided by EarlySRS-Resource. For this design example, the one or more sixth indicators could have similar or same form(s), format(s), function(s) and/or etc. to or as the one or more third indicators as defined/specified herein in the present disclosure by replacing a CSI resource set provided by EarlyCSI-ResourceSet with a SRS resource set provided by EarlySRS-ResourceSet, a CSI resource set ID/ID value with a SRS resource set ID/ID value, a list of aperiodic CSI trigger states with a list of aperiodic SRS resource trigger states, a CSI request field with a SRS request field, (early) triggered CSI-RS(s) with (early) triggered SRS(s), early triggering of CSI measurement/reporting with early triggering of SRS transmission(s), and/or etc.

In one example, the higher layer parameter(s)/signaling(s) including SIB1, SIB2, RRCRelease-IEs as specified/defined herein could provide or indicate or comprise one (H_early=1) SRS resource configuration for the early triggering of the SRS transmission(s), wherein the SRS resource configuration could be provided by EarlySRS-Config, and could comprise, provide or configure one (I_early=1) SRS resource set provided by EarlySRS-ResourceSet and comprising, providing or configuring multiple or more than one (J_early>1) SRS resources each provided by EarlySRS-Resource. For this design example, the one or more sixth indicators could have similar or same form(s), format(s), function(s) and/or etc. to or as the one or more third indicators as defined/specified herein in the present disclosure by replacing a CSI-RS resource provided by EarlySSB-Index/EarlyNZP-CSI-RS-Resource with a SRS resource provided by EarlySRS-Resource, a CSI-RS resource ID/ID value with a SRS resource ID/ID value, a list of aperiodic CSI trigger states with a list of aperiodic SRS resource trigger states, a CSI request field with a SRS request field, (early) triggered CSI-RS(s) with (early) triggered SRS(s), early triggering of CSI measurement/reporting with early triggering of SRS transmission(s), and/or etc.

As specified/defined herein in the present disclosure, the one or more sixth indicators could have similar or same form(s), format(s), function(s) and/or etc. to or as the one or more third indicators as defined/specified herein in the present disclosure. Furthermore,
Scheme-A.3: a UE could send or transmit to the network, a/the (same) third indicator(s), to jointly indicate or provide resource allocation(s) for the (early) triggered SRS(s) and the (early) triggered CSI-RS(s) according to or following those specified herein in the present disclosure; or equivalently, a UE could send or transmit to the network, a/the (same) sixth indicator(s), to jointly indicate or provide resource allocation(s) for the (early) triggered SRS(s) and the (early) triggered CSI-RS(s) according to or following those specified herein in the present disclosure.
Scheme-A.4: a UE could send or transmit to the network, the third indicator(s), to indicate or provide resource allocation(s) for the (early) triggered CSI-RS(s) according to or following those specified herein in the present disclosure; the UE could separately send or transmit to the network, the sixth indicator(s), to indicate or provide resource allocation(s) for the (early) triggered SRS(s).

The UE could determine or identify which of Scheme-A.3 and Scheme-A.4 to follow for determining or identifying resource allocation(s) for the early triggering of the SRS transmission(s) and/or the early triggering of the CSI measurement/reporting based on or according to: (1) fixed rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network (e.g., the network 130) via various UL channels/signals e.g. via/in part of beam/CSI report(s) and/or UE's capability signaling(s).

In one example, the UE could determine or identify or select which one or more of the configured/provided SRS resource configurations (and therefore, the corresponding SRS resource set(s)/SRS resource(s) provided/configured therein) for the early triggering of the SRS transmission(s) as specified/defined herein in the present disclosure, which one or more of the configured/provided SRS resource sets (and therefore, the corresponding SRS resource(s) provided/configured therein) for the early triggering of the SRS transmission(s) as specified/defined herein in the present disclosure, and/or which one or more of the configured/provided SRS resources for the early triggering of the SRS transmission(s) as specified/defined herein in the present disclosure, to use/apply for determining or identifying the SRS resource(s) and the corresponding parameter(s)/setting(s) to transmit the (early) triggered SRS(s) according to or based on fixed mapping rule(s) in system specification(s) and/or per RRC (re-)configuration/setup.
In one example, when/if the higher layer parameter(s)/signaling(s) including SIB1, SIB2, RRCRelease-IEs as specified/defined herein provides or indicates or comprises multiple or more than one (H_early>1) SRS resource configurations for the early triggering of the SRS transmission(s), wherein each of the SRS resource configurations could be provided by EarlySRS-Config, and could comprise or provide or include or configure or link to one or more SRS resource sets each provided by EarlySRS-ResourceSet and comprising, providing or configuring one or more SRS resources each provided by EarlySRS-Resource, the fixed mapping rule(s) could correspond to or could comprise a mapping between the one or more UE IDs and the H_early SRS resource configurations, a mapping between the resources used for the PDCCH providing the DCI format (e.g., time and/or frequency resources, e.g., (e.g., starting) channel control elements (CCEs) or (e.g., starting) resource element groups (REGs) or (e.g., starting) resource blocks (RBs) or (e.g., starting) symbols or slots or subframes or frames etc.) and the H_early SRS resource configurations, a mapping between the one or more UE IDs and resources used for reception of the PDCCH providing the DCI format as mentioned herein, and the H_early SRS resource configurations and/or etc.
In another example, when/if the higher layer parameter(s)/signaling(s) including SIB1, SIB2, RRCRelease-IEs as specified/defined herein provides or indicates or comprises one (H_early=1) SRS resource configuration for the early triggering of the SRS transmission(s), wherein the SRS resource configuration could be provided by EarlySRS-Config, and could comprise, provide or configure multiple or more than one (I_early>1) SRS resource sets each provided by EarlySRS-ResourceSet and comprising, providing or configuring one or more SRS resources each provided by EarlySRS-Resource, the fixed mapping rule(s) could correspond to or could comprise a mapping between the one or more UE IDs and the I_early SRS resource sets, a mapping between the resources used for the PDCCH providing the DCI format (e.g., time and/or frequency resources, e.g., (e.g., starting) channel control elements (CCEs) or (e.g., starting) resource element groups (REGs) or (e.g., starting) resource blocks (RBs) or (e.g., starting) symbols or slots or subframes or frames etc.) and the I_early SRS resource sets, a mapping between the one or more UE IDs and resources used for reception of the PDCCH providing the DCI format as mentioned herein, and the I_early SRS resource sets and/or etc.
In another example, when/if the higher layer parameter(s)/signaling(s) including SIB1, SIB2, RRCRelease-IEs as specified/defined herein provides or indicates or comprises one (H_early=1) SRS resource configuration for the early triggering of the SRS transmission(s), wherein the SRS resource configuration could be provided by EarlySRS-Config, and could comprise, provide or configure one (I_early=1) SRS resource set provided by EarlySRS-ResourceSet and comprising, providing or configuring multiple or more than one (J_early>1) SRS resources each provided by EarlySRS-Resource, the fixed mapping rule(s) could correspond to or could comprise a mapping between the one or more UE IDs and the J_early SRS resources, a mapping between the resources used for the PDCCH providing the DCI format (e.g., time and/or frequency resources, e.g., (e.g., starting) channel control elements (CCEs) or (e.g., starting) resource element groups (REGs) or (e.g., starting) resource blocks (RBs) or (e.g., starting) symbols or slots or subframes or frames etc.) and the J_early SRS resources, a mapping between the one or more UE IDs and resources used for reception of the PDCCH providing the DCI format as mentioned herein, and the J_early SRS resources, and/or etc.

According to those specified herein in the present disclosure, the UE could determine or identify the one or more fifth channels/signals to transmit or send the (early) triggered SRS(s) based on or according to:
In one example, the one or more fifth channels/signals could correspond to or could be associated/specific to one or more PUSCH(s) or PUSCH resource(s) scheduled or activated by a DCI format(s), wherein the DCI format(s) could correspond to the one or more fourth triggering channels/signals as specified/defined in Option-A in the present disclosure.
In another example, the fifth channel(s)/signal(s) could correspond to the UL channel(s)/signal(s) including PUCCH(s)/PUSCH(s)/PRACH(s)/SRS(s) and/or etc. corresponding/associated/specific to the higher layer message(s) as specified/defined in Option-B in the present disclosure. For instance, the UL channel(s)/signal(s) herein could be associated with or after a PRACH preamble transmission as indicated or configured or provided by the higher layer message(s) as specified/defined in Option-B in the present disclosure. Optionally, the UL channel(s)/signal(s) herein could be associated with or after a RACH scheduled transmission or a Msg3 as indicated or configured or provided by the higher layer message(s) as specified/defined in Option-B in the present disclosure. Furthermore, the UL channel(s)/signal(s) herein could be associated with or after a MsgA as indicated or configured or provided by the higher layer message(s) as specified/defined in Option-B in the present disclosure.
In another example, the fifth channel(s)/signal(s) could correspond to the UL channel(s)/signal(s) including PUCCH(s)/PUSCH(s)/PRACH(s)/SRS(s) and/or etc. corresponding/associated/specific to the PEI(s) or paging message(s), e.g., corresponding to/for one or more POs, as specified/defined in Option-C in the present disclosure. For instance, the UL channel(s)/signal(s) herein could be associated with or after a PRACH preamble transmission as indicated or configured or provided by the PEI(s)/paging message(s) as specified/defined in Option-C in the present disclosure. Optionally, the UL channel(s)/signal(s) herein could be associated with or after a RACH scheduled transmission or a Msg3 as indicated or configured or provided by the PEI(s)/paging message(s) as specified/defined in Option-C in the present disclosure. Furthermore, the UL channel(s)/signal(s) herein could be associated with or after a MsgA as indicated or configured or provided by the PEI(s)/paging message(s) as specified/defined in Option-C in the present disclosure.
In another example, the fifth channel(s)/signal(s) could correspond to or could be associated/specific to a PRACH transmission—e.g., Msg1; in this case, a PRACH preamble of Msg1 could also indicate the (early) triggered SRS(s) as specified/defined herein in the present disclosure. Alternatively, the fifth channel(s)/signal(s) could correspond to or could be associated/specific to a RACH scheduled transmission—e.g., Msg3; in this case, the PUSCH transmission providing Msg3 could also include, comprise, carry or convey the (early) triggered SRS(s) as specified/defined herein in the present disclosure. Optionally, the fifth channel(s)/signal(s) could correspond to or could be associated/specific to a MsgA of Type-2 random access procedure; in this case, the PRACH or PUSCH transmission providing MsgA could also include, comprise, carry or convey the (early) triggered SRS(s) as specified/defined herein in the present disclosure. In addition, the fifth channel(s)/signal(s) could correspond to the UL channel(s)/signal(s) including PUCCH(s)/PUSCH(s)/PRACH(s)/SRS(s) and/or etc. associated with or after a RACH scheduled transmission or a Msg3 as indicated or configured or provided by the RAR as specified/defined in Option-D in the present disclosure.

Furthermore,
Scheme-Y.1: a UE could transmit or send to the network, in a/the (same) fifth channel(s)/signal(s), the sixth indicator(s) to indicate their autonomous determination, identification or selection of the SRS resource(s) for the early triggering of the SRS transmission(s) and the (early) triggered SRS(s) according to or following those specified herein in the present disclosure; or equivalently, a UE could transmit or send to the network, in a/the (same) sixth channel(s)/signal(s), the sixth indicator(s) to indicate their autonomous determination, identification or selection of the SRS resource(s) for the early triggering of the SRS transmission(s) and the (early) triggered SRS(s) according to or following those specified herein in the present disclosure.
Scheme-Y.2: a UE could transmit or send to the network, in the sixth channel(s)/signal(s), the sixth indicator(s) to indicate their autonomous determination, identification or selection of the SRS resource(s) for the early triggering of the SRS transmission(s) according to or following those specified herein in the present disclosure; furthermore, the UE could transmit or send to the network, in the fifth channel(s)/signal(s) separate/different from the sixth channel(s)/signal(s), the (early) triggered SRS(s) according to or following those specified herein in the present disclosure.

The UE could determine or identify which of Scheme-Y.1 and Scheme-Y.2 to follow for transmitting, sending or indicating to the network their autonomous determination, identification or selection of the SRS resource(s) for the early triggering of the SRS transmission(s) and/or the (early) triggered SRS(s) according to or following those specified herein in the present disclosure based on or according to: (1) fixed rule(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s).

The UE could transmit or send or indicate to the network, in/by/via the fifth channel(s)/signal(s), the (early) triggered SRS(s) according to or based on one or more of the followings.
In one example, the UE could transmit or send or indicate to the network the fifth channel(s)/signal(s) carrying or conveying the (early) triggered SRS(s) a minimum time T from the end (or start) of the fourth triggering channel(s)/signal(s). For instance, for Option-A, the fourth triggering channel(s)/signal(s) as mentioned herein could correspond to a PDCCH reception providing the DCI format(s) triggering the SRS transmission(s).
In another example, the symbol or slot or subframe or frame used by a UE to transmit the (early) triggered SRS(s) could be at or after a time T from the end (or start) of the fourth triggering channel(s)/signal(s). For instance, for Option-A, the fourth triggering channel(s)/signal(s) as mentioned herein could correspond to a PDCCH reception providing the DCI format(s) triggering the SRS transmission(s).
In another example, the symbol or slot or subframe or frame used by a UE to transmit the (early) triggered SRS(s) could be that first symbol or slot or subframe or frame that starts at or after a time T from the end (or start) of the fourth triggering channel(s)/signal(s) and optionally based on a time offset/gap. For instance, for Option-A, the fourth triggering channel(s)/signal(s) as mentioned herein could correspond to a PDCCH reception providing the DCI format(s) triggering the SRS transmission(s).

The time T and/or the time offset/gap could be in number of symbol(s), slot(s), subframe(s), frame(s) and/or etc. Furthermore, the UE could determine or identify the value(s) of the time T and/or the time offset/gap according to or based on: (1) fixed value(s) in system specification(s) and/or per RRC (re-)configuration/setup, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals e.g. via/in part of beam/CSI report(s) and/or UE's capability signaling(s). For instance, the value(s) of the time T and/or the time offset/gap could be indicated or provided by/in the DCI format(s) that trigger(s) the SRS transmission(s)—as in Option-A in the present disclosure.
For example, one or more new DCI fields in the DCI format(s) could indicate or provide the value(s) of the time T and/or the time offset/gap.
For another example, one or more existing DCI fields in the DCI format(s) could be repurposed to indicate or provide the value(s) of the time T and/or the time offset/gap.

The value(s) of the time T and/or the time offset/gap could be present or absent in their corresponding fourth triggering channel(s)/signal(s) according to network's configuration or indication (e.g., via RRC signaling(s)/configuration(s)). For instance, the UE could be provided or indicated or configured by the network a higher layer parameter/signaling denoted by timeIndicationSRS_PresentInDCI. In this case, when/if the higher layer parameter/signaling timeIndicationSRS_PresentInDCI is provided/configured and/or set to ‘enabled’ or ‘on’, the value(s) of the time T and/or the time offset/gap as specified/defined herein in the present disclosure could be present in the corresponding DCI format(s) as specified/defined in Option-A following those specified herein in the present disclosure; otherwise, i.e., when/if the higher layer parameter/signaling timeIndicationSRS_PresentInDCI is not provided/configured and/or set to ‘disabled’ or ‘off’, the value(s) of the time T and/or the time offset/gap as specified/defined herein in the present disclosure may not be present or could be absent in the corresponding DCI format(s) as specified/defined in Option-A according to those specified herein in the present disclosure.

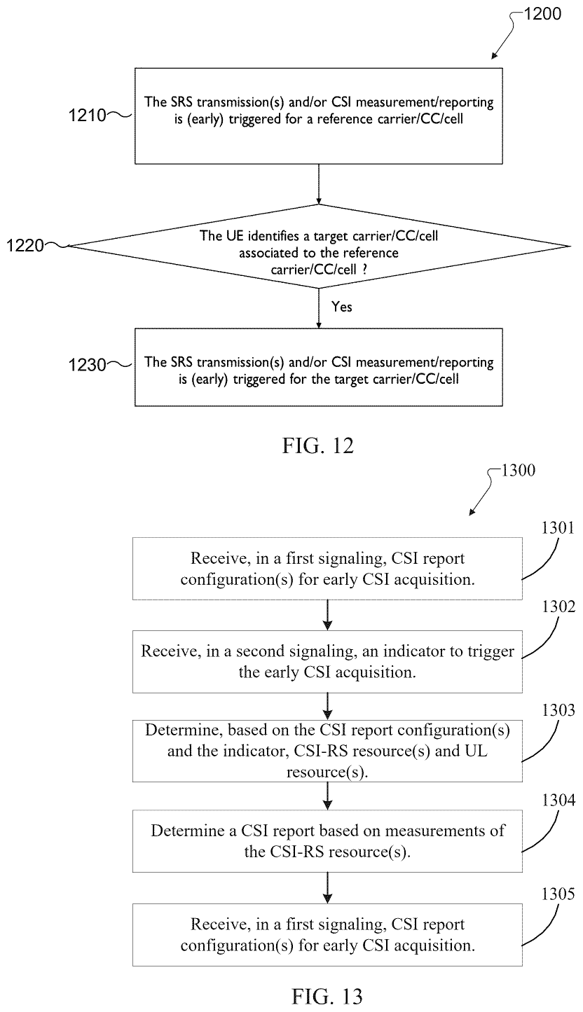

FIG. 12 illustrates a flowchart of an example procedure 1200 for early triggering of SRS transmission(s) for CSI acquisition and/or CSI measurement/reporting according to embodiments of the present disclosure. For example, procedure 1200 can be performed by the UE 116 and the gNB 102 and/or network 130 in the wireless network 100 of FIG. 1. This example is for illustration only and other embodiments can be used without departing from the scope of the present disclosure.

The procedure begins in 1210, the SRS transmission(s) and/or CSI-RS measurement/reporting is (early) triggered for a reference carrier/CC/cell. In 1220 the UE identifies a target carrier/CC/cell associated to the reference carrier/CC/cell. In 1230, the SRS transmission(s) and/or CSI measurement/reporting is (early) triggered for the target carrier/CC/cell.

Throughout the present disclosure, a SRS resource configuration is equivalent to a SRS resource setting, a CSI reporting configuration is equivalent to a CSI reporting setting, and a CSI resource configuration is equivalent to a CSI resource setting; furthermore, a CSI-RS resource configuration is equivalent to or could correspond to a CSI reporting configuration/setting provided by EarlyCSI-ReportConfig, or a CSI resource configuration/setting provided by EarlyCSI-ResourceConfig as specified/defined herein in the present disclosure. Furthermore, the design examples/procedures and the corresponding signalling methods, UE behaviors/assumptions and/or etc. specified/defined herein in the present disclosure for a given carrier or component carrier (CC) or a cell could be extended/applied to multiple carriers/CCs/cells when/if a multi-carrier or multi-CC or multi-cell system or setting is configured or enabled. For instance, a UE (e.g., the UE 116) could be provided or configured or indicated by the network, e.g., via higher layer RRC signaling(s)/parameter(s) and/or MAC CE command(s) and/or dynamic DCI based L1 signaling(s) based on or according to a corresponding UE's capability or capability signaling, one or more lists/sets/pools of carriers/CCs/cells (e.g., in form/terms of carrier/CC/cell IDs/indexes). In this case, when/if the SRS transmission(s) and/or CSI measurement/reporting is (early) triggered in/on/for one or more reference carriers/CCs/cells in a list/set/pool according to or following those specified herein in the present disclosure, the SRS transmission(s) and/or CSI measurement/reporting could be (early) triggered in/on/for one or more target carriers/CCs/cells in a list/set/pool according to or following those specified herein in the present disclosure (one conceptual example is presented in FIG. 12):
In one example, the one or more reference carriers/CCs/cells and the one or more target carriers/CCs/cells could be provided, configured or enabled (e.g., by the network via higher layer RRC signaling(s)/parameter(s)) in a/the same list/set/pool of carriers/CCs/cells (e.g., in terms/form of their carrier/CC/cell IDs/indexes). For this design example, the UE could determine or identify the one or more reference carriers/CCs/cells, e.g., in terms/form of their carrier/CC/cell IDs/indexes out of the carriers/CCs/cells in a/the same list/set/pool of carriers/CCs/cells, according to or based on or following one or more of:
   For example, the one or more reference carriers/CCs/cells could correspond to any of the carriers/CCs/cells (e.g., in form/terms of their carrier/CC/cell IDs/indexes) in a/the same list/set/pool of carriers/CCs/cells (e.g., in form/terms of their carrier/CC/cell IDs/indexes); when/if (or as long as) the SRS transmission(s) and/or CSI measurement/reporting is (early) triggered according to or following those specified herein in the present disclosure for one or more (reference) carriers/CCs/cells in a list/set/pool of carriers/CCs/cells, the UE could also expect that the SRS transmission(s) and/or CSI measurement/reporting is (early) triggered for one or more of the rest/remaining carrier(s)/CC(s)/cell(s) in the same list/set/pool of carriers/CCs/cells, wherein the one or more of the rest/remaining carrier(s)/CC(s)/cell(s) in the same list/set/pool of carriers/CCs/cells could be treated or denoted as the target carrier(s)/CC(s)/cell(s) in this case.
   For another example, the UE could determine or identify the one or more reference carriers/CCs/cells, e.g., in terms/form of their carrier/CC/cell IDs/indexes out of the carriers/CCs/cells in a/the same list/set/pool of carriers/CCs/cells, according to or based on: (1) fixed rule(s)/setting(s) in system specification(s) and/or per RRC (re) configuration, e.g., the first/last carrier/CC/cell or the carrier/CC/cell with the lowest/highest ID/index in the list/set/pool of carriers/CCs/cells (or equivalently, in the list/set/pool of carrier/CC/cell IDs/indexes), (2) network's configuration(s)/indication(s)—e.g., in terms/form of bitmap(s), one-bit flag indicator(s), carrier/CC/cell ID(s)/index(es) and/or etc., e.g., via higher layer RRC signaling(s)/parameter(s) and/or MAC CE command(s) and/or dynamic DCI based L1 signaling(s), based on or according to a corresponding UE's capability or capability signaling, and/or (3) UE's autonomous determination or selection, which could be further sent to the network via various UL channels/signals including CSI/beam report(s) and/or UE's capability signaling. In this case, when/if (or as long as) the SRS transmission(s) and/or CSI measurement/reporting is (early) triggered according to or following those specified herein in the present disclosure for the one or more reference carriers/CCs/cells in a list/set/pool of carriers/CCs/cells, the UE could also expect that the SRS transmission(s) and/or CSI measurement/reporting is (early) triggered for one or more of the rest/remaining carrier(s)/CC(s)/cell(s) in the same list/set/pool of carriers/CCs/cells, wherein the one or more of the rest/remaining carrier(s)/CC(s)/cell(s) in the same list/set/pool of carriers/CCs/cells could be treated or denoted as the target carrier(s)/CC(s)/cell(s) in this case.

Furthermore, the UE could determine or identify the one or more target carriers/CCs/cells, e.g., in terms/form of their carrier/CC/cell IDs/indexes out of the carriers/CCs/cells in a/the same list/set/pool of carriers/CCs/cells, according to or based on or following one or more of:
For example, the one or more target carriers/CCs/cells could correspond to (all) the carriers/CCs/cells (e.g., in terms/form of their carrier/CC/cell IDs/indexes) in the list/set/pool of carriers/CCs/cells (or equivalently, in the list/set/pool of carrier/CC/cell IDs/indexes) other than the reference carrier(s)/CC(s)/cell(s) in the (same) list/set/pool of carriers/CCs/cells (or equivalently, in the (same) list/set/pool of carrier/CC/cell IDs/indexes).
For another example, the one or more target carriers/CCs/cells could correspond to (all) the remaining/rest of the carriers/CCs/cells (e.g., in terms/form of their carrier/CC/cell IDs/indexes)—i.e., without/not account for the reference carrier(s)/CC(s)/cell(s) in the (same) list/set/pool of carriers/CCs/cells (or equivalently, in the (same) list/set/pool of carrier/CC/cell IDs/indexes)—in the list/set/pool of carriers/CCs/cells (or equivalently, in the list/set/pool of carrier/CC/cell IDs/indexes).
For another example, the UE could determine or identify the one or more target carriers/CCs/cells, e.g., in terms/form of their carrier/CC/cell IDs/indexes out of (i) the carriers/CCs/cells in a/the same list/set/pool of carriers/CCs/cells and/or (ii) the rest/remaining carriers/CCs/cells in a/the same list/set/pool of carriers/CCs/cells other than or without accounting for the reference carrier(s)/CC(s)/cell(s), according to or based on: (1) fixed rule(s)/setting(s) in system specification(s) and/or per RRC (re) configuration, e.g., the first/last carrier/CC/cell or the carrier/CC/cell with the lowest/highest ID/index in the list/set/pool of carriers/CCs/cells (or equivalently, in the list/set/pool of carrier/CC/cell IDs/indexes) with or without accounting for the reference carrier(s)/CC(s)/cell(s), (2) network's configuration(s)/indication(s)—e.g., in terms/form of bitmap(s), one-bit flag indicator(s), carrier/CC/cell ID(s)/index(es) and/or etc., e.g., via higher layer RRC signaling(s)/parameter(s) and/or MAC CE command(s) and/or dynamic DCI based L1 signaling(s), based on or according to a corresponding UE's capability or capability signaling, and/or (3) UE's autonomous determination or selection, which could be further sent to the network via various UL channels/signals including CSI/beam report(s) and/or UE's capability signaling.
In another example, the UE could first determine or identify the one or more reference carriers/CCs/cells, e.g., in terms/form of their carrier/CC/cell IDs/indexes out of (i) the carriers/CCs/cells in a list/set/pool of carriers/CCs/cells or a list/set/pool of carrier/CC/cell IDs/indexes higher layer configured/provided by the network to the UE, according to or based on: (1) fixed rule(s)/setting(s) in system specification(s) and/or per RRC (re) configuration, e.g., the first/last carrier/CC/cell or the carrier/CC/cell with the lowest/highest ID/index in the list/set/pool of carriers/CCs/cells (or equivalently, in the list/set/pool of carrier/CC/cell IDs/indexes), (2) network's configuration(s)/indication(s)—e.g., in terms/form of bitmap(s), one-bit flag indicator(s), carrier/CC/cell ID(s)/index(es) and/or etc., e.g., via higher layer RRC signaling(s)/parameter(s) and/or MAC CE command(s) and/or dynamic DCI based L1 signaling(s), based on or according to a corresponding UE's capability or capability signaling, and/or (3) UE's autonomous determination or selection, which could be further sent to the network via various UL channels/signals including CSI/beam report(s) and/or UE's capability signaling. Optionally, the UE could then determine or identify the one or more target carriers/CCs/cells, e.g., in terms/form of their carrier/CC/cell IDs/indexes out of (i) the carriers/CCs/cells in a list/set/pool of carriers/CCs/cells or a list/set/pool of carrier/CC/cell IDs/indexes higher layer configured/provided by the network to the UE, according to or based on: (1) fixed rule(s)/setting(s) in system specification(s) and/or per RRC (re) configuration, e.g., the first/last carrier/CC/cell or the carrier/CC/cell with the lowest/highest ID/index in the list/set/pool of carriers/CCs/cells (or equivalently, in the list/set/pool of carrier/CC/cell IDs/indexes), (2) network's configuration(s)/indication(s)—e.g., in terms/form of bitmap(s), one-bit flag indicator(s), carrier/CC/cell ID(s)/index(es) and/or etc., e.g., via higher layer RRC signaling(s)/parameter(s) and/or MAC CE command(s) and/or dynamic DCI based L1 signaling(s), based on or according to a corresponding UE's capability or capability signaling, and/or (3) UE's autonomous determination or selection, which could be further sent to the network via various UL channels/signals including CSI/beam report(s) and/or UE's capability signaling. In this case, the UE could further determine or identify association/mapping between the one or more reference carriers/CCs/cells and the one or more target carriers/CCs/cells according to or based on: (1) fixed rule(s)/setting(s) in system specification(s) and/or per RRC (re) configuration, (2) network's configuration(s)/indication(s), e.g., via higher layer RRC signaling(s)/parameter(s) and/or MAC CE command(s) and/or dynamic DCI based L1 signaling(s), based on or according to a corresponding UE's capability or capability signaling, and/or (3) UE's autonomous determination or selection, which could be further sent to the network via various UL channels/signals including CSI/beam report(s) and/or UE's capability signaling.
For example, the UE could be higher layer configured/provided by the network (e.g., the network 130) and/or could receive in the first and/or fourth triggering channel(s)/signal(s) a first list/set/pool of carriers/CCs/cells (or carrier/CC/cell IDs/indexes) for reference carrier(s)/CC(s)/cell(s), and/or a second list/set/pool of carriers/CCs/cells (or carrier/CC/cell IDs/indexes) for target carrier(s)/CC(s)/cell(s). For this design example, when/if the SRS transmission(s) and/or CSI measurement/reporting is (early) triggered according to or following those specified herein in the present disclosure for one or more reference carriers/CCs/cells in/from the first list/set/pool, the UE could also expect that the SRS transmission(s) and/or CSI measurement/reporting is (early) triggered for the one or more target carriers/CCs/cells in/from the second list/set/pool, wherein the one or more reference carriers/CCs/cells in/from the first list/set/pool and the one or more target carriers/CCs/cells from/in the second list/set/pool could be associated/mapped to each other(s), and the UE could determine or identify the association(s)/mapping(s) according to or based on: (1) fixed rule(s)/setting(s) in system specification(s) and/or per RRC (re) configuration, e.g., one-to-one, one-to-many or many-to-one mappings (e.g., according to their IDs/indexes from low to high or high to low), (2) network's configuration(s)/indication(s), e.g., via higher layer RRC signaling(s)/parameter(s) and/or MAC CE command(s) and/or dynamic DCI based L1 signaling(s), based on or according to a corresponding UE's capability or capability signaling, and/or (3) UE's autonomous determination or selection, which could be further sent to the network via various UL channels/signals including CSI/beam report(s) and/or UE's capability signaling. For this design example, the first list/set/pool of carriers/CCs/cells (or carrier/CC/cell IDs/indexes) and the second list/set/pool of carriers/CCs/cells (or carrier/CC/cell IDs/indexes) could be identical/the same, or different.
For another example, a/the UE could be configured or indicated or provided by the network, e.g., via/in higher layer RRC signaling(s)/parameter(s) and/or MAC CE command(s) and/or dynamic DCI based L1 signaling(s) for/specific to/associated to/corresponding to one or more reference carriers/CCs/cells—based on or according to a corresponding UE's capability or capability signaling, a set of one or more (target) carriers/CCs/cells (e.g., in form/terms of their carrier/CC/cell IDs/indexes). In this case, when/if the SRS transmission(s) and/or CSI measurement/reporting is (early) triggered according to or following those specified herein in the present disclosure for the one or more reference carriers/CCs/cells, the UE could also expect that the SRS transmission(s) and/or CSI measurement/reporting is (early) triggered for the set of one or more (target) carriers/CCs/cells. For instance, the UE could be provided or configured by the network, e.g., in higher layer parameter(s)/signaling(s) such as CSI-ReportConfig, CSI-ResourceConfig and/or etc. (dedicated) for a reference carrier/CC/cell #A, a set of (target) carrier/CC/cell IDs/indexes denoted by {#B, #C, #D}; in this case, when/if the SRS transmission(s) and/or CSI measurement/reporting is (early) triggered according to or following those specified herein in the present disclosure for the reference carrier/CC/cell #A, the UE could also expect that the SRS transmission(s) and/or CSI measurement/reporting is (early) triggered for the set of (target) carriers/CCs/cells #B, #C and #D.
For another example, a/the UE could be configured or indicated or provided by the network, e.g., via/in/by the first and/or fourth triggering channels/signals as specified/defined herein in the present disclosure for/specific to/associated to/corresponding to one or more reference carriers/CCs/cells—based on or according to a corresponding UE's capability or capability signaling, a set of one or more (target) carriers/CCs/cells (e.g., in form/terms of their carrier/CC/cell IDs/indexes). In this case, when/if the SRS transmission(s) and/or CSI measurement/reporting is (early) triggered according to or following those specified herein in the present disclosure for the one or more reference carriers/CCs/cells, the UE could also expect that the SRS transmission(s) and/or CSI measurement/reporting is (early) triggered for the set of one or more (target) carriers/CCs/cells. For instance, the UE could be provided or configured by the network, e.g., via/in/by the first and/or fourth triggering channels/signals (dedicated) for a reference carrier/CC/cell #A, a set of (target) carrier/CC/cell IDs/indexes denoted by {#B, #C, #D}; in this case, when/if the SRS transmission(s) and/or CSI measurement/reporting is (early) triggered according to or following those specified herein in the present disclosure for the reference carrier/CC/cell #A, the UE could also expect that the SRS transmission(s) and/or CSI measurement/reporting is (early) triggered for the set of (target) carriers/CCs/cells #B, #C and #D.
For another example, a/the UE could be configured or indicated or provided by the network, e.g., via/in higher layer RRC signaling(s)/parameter(s) and/or MAC CE command(s) and/or dynamic DCI based L1 signaling(s) based on or according to a corresponding UE's capability or capability signaling, an indication, configuration and/or information that indicates or provides or configures or includes or comprises or contains a first set of one or more (reference) carriers/CCs/cells (e.g., in form/terms of their carrier/CC/cell IDs/indexes) and a second set of one or more (target) carriers/CCs/cells (e.g., in form/terms of their carrier/CC/cell IDs/indexes). In this case, when/if the SRS transmission(s) and/or CSI measurement/reporting is (early) triggered according to or following those specified herein in the present disclosure for the first set of one or more (reference) carriers/CCs/cells, the UE could also expect that the SRS transmission(s) and/or CSI measurement/reporting is (early) triggered for the second set of one or more (target) carriers/CCs/cells, wherein as specified/described herein in the present disclosure, the first set and the second set could be provided, configured, indicated, comprised, included or contained in the same indication, configuration or information provided, indicated or configured to the UE. For instance, the UE could be provided or configured by the network, e.g., in higher layer parameter(s)/signaling(s) such as CSI-ReportConfig, CSI-ResourceConfig and/or etc., an indication or configuration or information providing, indicating, configuring, comprising, including or containing a first set of a reference carrier/CC/cell #A and a second set of (target) carrier/CC/cell IDs/indexes denoted by {#B, #C, #D}; in this case, when/if the SRS transmission(s) and/or CSI measurement/reporting is (early) triggered according to or following those specified herein in the present disclosure for the reference carrier/CC/cell #A in the first set, the UE could also expect that the SRS transmission(s) and/or CSI measurement/reporting is (early) triggered for the set of (target) carriers/CCs/cells #B, #C and #D in the second set.
For another example, a/the UE could be configured or indicated or provided by the network, e.g., via/in the first and/or fourth triggering channels/signals based on or according to a corresponding UE's capability or capability signaling, an indication, configuration and/or information that indicates or provides or configures or includes or comprises or contains a first set of one or more (reference) carriers/CCs/cells (e.g., in form/terms of their carrier/CC/cell IDs/indexes) and a second set of one or more (target) carriers/CCs/cells (e.g., in form/terms of their carrier/CC/cell IDs/indexes). In this case, when/if the SRS transmission(s) and/or CSI measurement/reporting is (early) triggered according to or following those specified herein in the present disclosure for the first set of one or more (reference) carriers/CCs/cells, the UE could also expect that the SRS transmission(s) and/or CSI measurement/reporting is (early) triggered for the second set of one or more (target) carriers/CCs/cells, wherein as specified/described herein in the present disclosure, the first set and the second set could be provided, configured, indicated, comprised, included or contained in the same indication, configuration or information provided, indicated or configured to the UE. For instance, the UE could be provided or configured by the network, e.g., by/in/via the first and/or fourth triggering channel(s)/signal(s) as specified/defined herein in the present disclosure, an indication or configuration or information providing, indicating, configuring, comprising, including or containing a first set of a reference carrier/CC/cell #A and a second set of (target) carrier/CC/cell IDs/indexes denoted by {#B, #C, #D}; in this case, when/if the SRS transmission(s) and/or CSI measurement/reporting is (early) triggered according to or following those specified herein in the present disclosure for the reference carrier/CC/cell #A in the first set, the UE could also expect that the SRS transmission(s) and/or CSI measurement/reporting is (early) triggered for the set of (target) carriers/CCs/cells #B, #C and #D in the second set.

According to or following those specified/defined herein in the present disclosure,
Step-1: a UE—in idle or inactive state—could transmit to network, e.g., via Msg1, one or more preambles
Step-2: the UE could be indicated by or could receive from the network, in Msg2 RAR, an indicator to trigger CSI-RS(s) measurement and/or CSI reporting, and/or UL grant for transmitting or conveying or carrying CSI report(s) if any, triggered or reported; the indicator could be in form of a one-bit indicator (e.g., the 1-bit CSI request field in the Msg2 RAR) with ‘1’ (or ‘0’) indicating that CSI-RS(s) measurement and/or CSI reporting is triggered for the UE; alternatively, the indicator could be associated, linked or mapped to trigger state(s) which could be further associated, linked or mapped to CSI reporting setting(s) provided by CSI-ReportConfig(s) and/or CSI resource setting(s) provided by CSI-ResourceConfig(s). Here, the Msg2 RAR could be associated with the one or more preambles and RACH occasion(s)—i.e., RO(s), and includes TC-RNTI
Step-3: the UE could transmit or send to the network Msg3 in response to the Msg2 RAR. The Msg3 could comprise CSI report(s) triggered by the Msg2 RAR
Step-4: the network could transmit or send to the UE Msg4, wherein the Msg4 could also comprise an indicator to trigger CSI-RS(s) measurement and/or CSI reporting, and/or UL grant for transmitting or conveying or carrying CSI report(s) if any, triggered or reported; the indicator could be in form of a one-bit indicator with ‘1’ (or ‘0’) indicating that CSI-RS(s) measurement and/or CSI reporting is triggered for the UE; alternatively, the indicator could be associated, linked or mapped to trigger state(s) which could also be associated, linked or mapped to CSI reporting setting(s) provided by CSI-ReportConfig and/or CSI resource setting(s) provided by CSI-ResourceConfig

When the UE is in RRC connected mode, the UE could perform or conduct the CSI-RS(s) measurement, and/or report the corresponding CSI(s)—over/by/on one or more PUCCH and/or PUSCH resources (or resource configurations) configured or provided to the UE via/in/by SIB1, SIB2 and/or etc. according to or following those specified/defined herein in the present disclosure-based on or according to the triggering information indicated in the RACH procedures mentioned herein (e.g., the indicator(s) in Msg2 RAR and/or Msg4).

FIG. 13 illustrates an example method 1300 performed by a UE in a wireless communication system according to embodiments of the present disclosure. The method 1300 of FIG. 13 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 1300 is for illustration only and other embodiments can be used without departing from the scope of the present disclosure.

The method 1300 begins with the UE receiving, in a first signaling, one or more CSI report configurations for early CSI acquisition (1301). For example, the first signaling is a SIB1 or a SIB2.

The UE then receives, in a second signaling, an indicator to trigger the early CSI acquisition (1302). For example, the second signaling is a DCI carried by a PDCCH, a RAR of Msg2 or MsgB for a random access procedure, or a contention resolution message of Msg4 for the random access procedure. For example, the indicator indicates a subset of the one or more CSI report configurations, and the indicator corresponds to a set of one or more CSI report configuration indexes or IDs or a bitmap with each entry of the bitmap corresponding to a CSI report configuration. In various embodiments, when the second signaling is a group common DCI carried by a PDCCH scheduling a PUSCH, the one or more UL resources correspond to resources of the PUSCH. In various embodiments, when the second signaling is a RAR of Msg2 scheduling a PUSCH of Msg3 for a random access procedure, the one or more UL resources correspond to resources of the PUSCH of Msg3, and when the second signaling is a contention resolution message of Msg4 for the random access procedure, the one or more UL resources correspond to resources of a first available PUSCH after transmission of a HARQ) ACK for the contention resolution message of Msg4.

The UE then determines, based on the one or more CSI report configurations and the indicator, one or more CSI-RS resources and one or more UL resources (1303). For example, the one or more CSI-RS resources are determined based on one or more CSI resource sets associated with the indicated subset and the one or more UL resources are determined based on the indicated subset.

The UE then determines a CSI report based on measurements of the one or more CSI-RS resources (1304). The UE then transmits the CSI report via the one or more UL resources (1305).

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE), comprising:
a transceiver configured to:
receive, in a first signaling, one or more channel state information (CSI) report configurations for early CSI acquisition; and
receive, in a second signaling, an indicator to trigger the early CSI acquisition; and
a processor operably coupled with the transceiver, the processor configured to:
determine, based on the one or more CSI report configurations and the indicator, (i) one or more CSI reference signal (CSI-RS) resources and (ii) one or more uplink (UL) resources; and
determine, based on measurements of the one or more CSI-RS resources, a CSI report,
wherein the transceiver is further configured to transmit, via the one or more UL resources, the CSI report.

2. The UE of claim 1, wherein the first signaling is a SIB Type 1 (SIB1) or a SIB Type 2 (SIB2).

3. The UE of claim 1, wherein the second signaling is:
a downlink control information (DCI) carried by a physical downlink control channel (PDCCH);
a random access response (RAR) of Message 2 (Msg2) or Message B (MsgB) for a random access procedure; or
a contention resolution message of Message 4 (Msg4) for the random access procedure.

4. The UE of claim 1, wherein:
the indicator indicates a subset of the one or more CSI report configurations, and
the indicator corresponds to:
a set of one or more CSI report configuration indexes or identities (IDs), or
a bitmap with each entry of the bitmap corresponding to a CSI report configuration.

5. The UE of claim 4, wherein:
the one or more CSI-RS resources are determined based one or more CSI resource sets associated with the indicated subset; and
the one or more UL resources are determined based on the indicated subset.

6. The UE of claim 1, wherein, when the second signaling is a group common downlink control information (DCI) carried by a physical downlink control channel (PDCCH) scheduling a physical uplink shared channel (PUSCH), the one or more UL resources correspond to resources of the PUSCH.

7. The UE of claim 1, wherein:
when the second signaling is a random access response (RAR) of Message 2 (Msg2) scheduling a physical uplink shared channel (PUSCH) of Message 3 (Msg3) for a random access procedure, the one or more UL resources correspond to resources of the PUSCH of Msg3; and
when the second signaling is a contention resolution message of Message 4 (Msg4) for the random access procedure, the one or more UL resources correspond to resources of a first available PUSCH after transmission of a hybrid automatic repeat request (HARQ) acknowledgement (ACK) for the contention resolution message of Msg4.

8. A base station (BS), comprising:
a processor; and
a transceiver operably coupled with the processor, the transceiver configured to:
transmit, in a first signaling, one or more channel state information (CSI) report configurations for early CSI acquisition;
transmit, in a second signaling, an indicator to trigger the early CSI acquisition, wherein the one or more CSI report configurations and the indicator indicate (i) one or more CSI reference signal (CSI-RS) resources and (ii) one or more uplink (UL) resources; and
receive, via the one or more UL resources, a CSI report that is based on measurements of the one or more CSI-RS resources.

9. The BS of claim 8, wherein the first signaling is a SIB Type 1 (SIB1) or a SIB Type 2 (SIB2).

10. The BS of claim 8, wherein the second signaling is:
a downlink control information (DCI) carried by a physical downlink control channel (PDCCH);
a random access response (RAR) of Message 2 (Msg2) or Message B (MsgB) for a random access procedure; or
a contention resolution message of Message 4 (Msg4) for the random access procedure.

11. The BS of claim 8, wherein:
the indicator indicates a subset of the one or more CSI report configurations, and
the indicator corresponds to:
a set of one or more CSI report configuration indexes or identities (IDs), or
a bitmap with each entry of the bitmap corresponding to a CSI report configuration.

12. The BS of claim 11, wherein:
the one or more CSI-RS resources are indicated based one or more CSI resource sets associated with the indicated subset; and
the one or more UL resources are indicated based on the indicated subset.

13. The BS of claim 8, wherein, when the second signaling is a group common downlink control information (DCI) carried by a physical downlink control channel (PDCCH) scheduling a physical uplink shared channel (PUSCH), the one or more UL resources correspond to resources of the PUSCH.

14. The BS of claim 8, wherein:
when the second signaling is a random access response (RAR) of Message 2 (Msg2) scheduling a physical uplink shared channel (PUSCH) of Message 3 (Msg3) for a random access procedure, the one or more UL resources correspond to resources of the PUSCH of Msg3; and
when the second signaling is a contention resolution message of Message 4 (Msg4) for the random access procedure, the one or more UL resources correspond to resources of a first available PUSCH after transmission of a hybrid automatic repeat request (HARQ) acknowledgement (ACK) for the contention resolution message of Msg4.

15. A method performed by a user equipment (UE), the method comprising:
receiving, in a first signaling, one or more channel state information (CSI) report configurations for early CSI acquisition;
receiving, in a second signaling, an indicator to trigger the early CSI acquisition;
determining, based on the one or more CSI report configurations and the indicator, (i) one or more CSI reference signal (CSI-RS) resources and (ii) one or more uplink (UL) resources;
determining, based on measurements of the one or more CSI-RS resources, a CSI report; and
transmitting, via the one or more UL resources, the CSI report.

16. The method of claim 15, wherein the first signaling is a SIB Type 1 (SIB1) or a SIB Type 2 (SIB2).

17. The method of claim 15, wherein the second signaling is:
a downlink control information (DCI) carried by a physical downlink control channel (PDCCH);
a random access response (RAR) of Message 2 (Msg2) or Message B (MsgB) for a random access procedure; or
a contention resolution message of Message 4 (Msg4) for the random access procedure.

18. The method of claim 15, wherein:
the indicator indicates a subset of the one or more CSI report configurations, and
the indicator corresponds to:
a set of one or more CSI report configuration indexes or identities (IDs), or
a bitmap with each entry of the bitmap corresponding to a CSI report configuration.

19. The method of claim 18, wherein:
the one or more CSI-RS resources are determined based one or more CSI resource sets associated with the indicated subset; and
the one or more UL resources are determined based on the indicated subset.

20. The method of claim 15, wherein, when the second signaling is a group common downlink control information (DCI) carried by a physical downlink control channel (PDCCH) scheduling a physical uplink shared channel (PUSCH), the one or more UL resources correspond to resources of the PUSCH.
